(19) United States
(12) Patent Application Publication
(10) Pub. No.: US 2011/0007102 A1
(43) Pub. Date: Jan. 13, 2011

(54) PIXEL DRIVE APPARATUS, LIGHT-EMITTING APPARATUS AND DRIVE CONTROL METHOD FOR LIGHT-EMITTING APPARATUS

(75) Inventors: Jun OGURA, Fussa-shi (JP); Yasushi Mizutani, Musashimurayama-shi (JP); Kenji Kobayashi, Hino-shi (JP)

Correspondence Address: HOLTZ, HOLTZ, GOODMAN & CHICK PC, 220 Fifth Avenue, 16TH Floor, NEW YORK, NY, 10001-7708, US

(73) Assignee: Casio Computer Co., Ltd., Tokyo (JP)

(21) Appl. No.: 12/832,093

(22) Filed: Jul. 8, 2010

(30) Foreign Application Priority Data
Jul. 10, 2009 (JP) 2009-163602
Jul. 10, 2009 (JP) 2009-163609
May 13, 2010 (JP) 2010-110932

(51) Int. Cl. G09G 5/10

(52) U.S. Cl. 345/690

(57) ABSTRACT

A pixel drive apparatus to drive a pixel has a function of compensating a change in characteristics of the pixel. The pixel includes a light-emitting element and a drive control element to drive the light-emitting element. The pixel drive apparatus acquires the electrical characteristic parameter that is used to compensate variation of electrical characteristics of the light-emitting drive circuit including the drive control element based on a voltage value of the detection voltage after applying a voltage having a voltage value exceeding a threshold voltage across the drive control element to elapse of at least one relaxation time, and acquires a light-emitting characteristic parameter that is used to compensate variation of characteristics of the light-emitting element based on light-emitting luminance of the light-emitting element that is operated to emit light in accordance with luminance measurement image data corrected based on the electrical characteristic parameter.

### CROSS-REFERENCE TO RELATED APPLICATIONS

This application is based upon and claims the benefit of priority from prior Japanese Patent Applications No. 2009-163602, filed Jul. 10, 2009; No. 2009-163609, filed Jul. 10, 2009; and No. 2010-110932, filed May 13, 2010, the entire contents of all of which are incorporated herein by reference.

### BACKGROUND OF THE INVENTION

1. Field of the Invention

The present invention relates to a pixel drive apparatus, a light-emitting apparatus including the pixel driving apparatus, a drive control method thereof, and an electronic device including the light-emitting apparatus.

2. Description of the Related Art

In recent years, attention has paid to a light-emitting element type display apparatus (a light-emitting apparatus) including a display panel (a pixel array) in which light-emitting elements are arranged in a matrix form as a next-generation display device following a liquid crystal display apparatus. As such a light-emitting element, a current drive type light-emitting element such as an organic electroluminescence element (an organic EL element), an inorganic electroluminescence element (an inorganic EL element) or a light-emitting diode has been known, for example.

In particular, the light-emitting element type display apparatus to which an active matrix type drive system is applied has good display characteristics, e.g., a high display response speed, almost no viewing angle dependency, realization of high luminance/high contrast, high definition of a display quality and others as compared with known liquid crystal display apparatuses. Further, since the light-emitting element type display apparatus does not require a backlight or a light guide plate as different from the liquid crystal display apparatus, it has quite superior characteristics, i.e., a thickness and a weight can be further reduced. Accordingly, application to various electronic devices in the future is expected.

As such a light-emitting type display apparatus, an organic EL display apparatus disclosed in JP-A 8-330600 (KOKAI) is known, for example. This organic EL display apparatus is an active matrix drive display apparatus subjected to current control by a voltage signal, and a circuit (which will be referred to as a “pixel circuit” for the convenience's sake) having a light-emitting element comprising an organic EL element, a current control thin film transistor having a gate to which a voltage signal associated with image data is applied to flow a current to the organic EL element and a switch thin film transistor to perform switching to supply the voltage signal associated with the image data to the gate of this current control thin film transistor is provided in accordance with each pixel.

In such an organic EL display apparatus that controls a luminance gradation of each light-emitting element by using the voltage signal, a current value of a current flowing through each organic EL element fluctuates due to an aged change in threshold voltage of, e.g., the current control thin film transistor.

Furthermore, even if the current control thin film transistors have the same threshold voltage, the pixel circuits for pixels arranged in a matrix form come under the influence of variations in gate insulating films and channel lengths, and also mobility, of the thin film transistors, and hence a variation in drive characteristics occurs. Here, it is known that the variation in mobility prominently occurs in an amorphous silicon thin film transistor in particular. Thus, the mobility can be uniformed by using the amorphous silicon thin film transistor, but the influence of the variation due to a manufacturing process cannot be avoided even in such a case.

Moreover, in the pixel circuit for each pixel, even if the thin film transistor has no variation in drive characteristics, a variation in luminescence characteristics occurs due to a variation in process in an organic EL element forming process.

### BRIEF SUMMARY OR THE INVENTION

The present invention has an advantage to provide a pixel drive apparatus, a light-emitting apparatus, and a drive control method capable of compensating a fluctuation in characteristics of the pixel circuit for each pixel to operate each pixel to emit light in a desired luminance gradation.

In order to achieve the above advantage, a pixel drive apparatus according to an aspect of the invention, which is an apparatus to drive a pixel, wherein the pixel includes a light-emitting element and a light-emitting drive circuit including a drive control element whose current path is connected with the light-emitting element, comprises a characteristic parameter acquisition circuit to acquire an electrical characteristic parameter that is used to compensate variation of electrical characteristics of the light-emitting drive circuit and a light-emitting characteristic parameter that is used to compensate variation of characteristics of the light-emitting element. The characteristic parameter acquisition circuit acquires a detection voltage in a data line connected with the pixel after applying a detection voltage to the data line and applying a voltage having a voltage value exceeding a threshold voltage of the drive control element between a control terminal of the drive control element and the one end of the current path and elapse of at least relaxation time, and acquiring the electrical characteristic parameter based on a voltage value of the detection voltage. The characteristic parameter acquisition circuit acquires the light-emitting characteristic parameter based on a value of light-emitting luminance of the light-emitting element of the pixel that is operated to emit light in accordance with luminance measurement image data corrected based on the electrical characteristic parameter.

In order to achieve the above advantage, a light-emitting apparatus according to another aspect of the invention includes a light-emitting panel including data lines arranged along a first direction, at least one scanning line arranged along a second direction crossing the first direction, and pixels connected with the respective data lines and the scanning line and arranged near intersecting points of the respective data lines and the scanning line, and a drive circuit to drive the light-emitting panel. Each of the pixels includes a light-emitting element and a light-emitting drive circuit including a drive control element whose current path is connected with the light-emitting element at one end thereof. The drive circuit includes a scanning drive circuit to apply a selection signal to the scanning line to set each of the pixels connected with the scanning line to a selective state, and a characteristic parameter acquisition circuit to acquire, on each the pixels set to the selective state by the scanning drive circuit, an electrical characteristic parameter that is used to compensate variation of electrical characteristics of the light-emitting drive circuit and a light-emitting characteristic parameter that is used to compensate variation of characteristics of the light-emitting element. The characteristic parameter acquisition circuit acquires a detection voltage in a data line connected with the pixel after applying a detection voltage to each of the data lines and applying a voltage having a voltage value exceeding a threshold voltage of the drive control element between a control terminal of the drive control element and the one end of the current path in each of the pixels and elapse of at least one relaxation time as a detection voltage, obtaining the electrical characteristic parameter based on a voltage value of the detection voltage. The characteristic parameter acquisition circuit acquires the light-emitting characteristic parameter based on a value of light-emitting luminance of the light-emitting element of each of the pixels that is operated to emit light in accordance with luminance measurement image data corrected based on the electrical characteristic parameter.

In order to achieve the above advantage, a drive control method according to still another aspect of the invention, which is a method for a light-emitting apparatus including a light-emitting panel including data lines and pixels connected to the respective data lines, each of the pixels including a light-emitting element and a light-emitting drive circuit having a drive control element whose current path is connected to the light-emitting element at one end thereof, includes: a voltage application step of applying a detection voltage to each of the data lines to apply a detection voltage exceeding a threshold voltage of the drive control element to a control terminal of the drive control element and the one end of the current path in each of the pixels; a voltage acquisition step of acquiring voltages in the respective data lines after applying the detection voltage and elapse of at least one relaxation time as detection voltages; an electrical characteristic parameter acquisition step of acquiring an electrical characteristic parameter that is used to compensate variation of electrical characteristics of the light-emitting drive circuit of each of the pixels based on voltage values of the acquired detection voltages; a light-emitting operation step of correcting the luminance measurement image data based on the electrical characteristic parameter and operating the light-emitting element of each of the pixels to emit light in accordance with the corrected luminance measurement image data; and a light-emitting characteristic parameter acquisition step of acquiring a value of light-emitting luminance of the light-emitting element of each of the pixels operated to emit light and acquiring alight-emitting characteristic parameter that is used to compensate variation of characteristics of the light-emitting element based on the acquired value of the light-emitting luminance.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram showing an example of a display apparatus to which a light-emitting apparatus according to the present invention is applied;

FIG. 2 is a schematic block diagram showing an example of a data driver applied to the display apparatus according to a first embodiment;

FIG. 3 is a schematic circuit block diagram showing a structural example of a primary part of the data driver applied to the display apparatus according to the first embodiment;

FIGS. 4A and 4B are views showing input and output characteristics of a digital-analog conversion circuit and an analog-digital conversion circuit applied to the data driver according to the first embodiment;

FIG. 5 is a functional block diagram showing functions of a controller applied to the display apparatus according to the first embodiment;

FIG. 6 is a circuit block diagram showing an embodiment of a pixel applied to a display panel according to the first embodiment;

FIG. 7 is an operating state diagram when writing image data in a pixel to which a light-emitting drive circuit according to the first embodiment is applied;

FIG. 8 is a view showing voltage-current characteristics at the time of a write operation in the pixel to which the light-emitting drive circuit according to the first embodiment is applied;

FIG. 9 is a view showing a change in data line voltage in a technique (an autozero method) applied to a characteristic parameter acquiring operation according to the first embodiment;

FIG. 10 is a timing chart (part 1) showing a characteristic parameter acquiring operation in the display apparatus according to the first embodiment;

FIG. 11 is an operation conceptual view showing a detection voltage applying operation in the display apparatus according to the first embodiment;

FIG. 12 is an operation conceptual view showing a natural alleviating operation in the display apparatus according to the first embodiment;

FIG. 13 is an operation conceptual view showing a data line voltage detecting operation in the display apparatus according to the first embodiment;

FIG. 14 is an operation conceptual view showing a detection data transmitting operation in the display apparatus according to the first embodiment;

FIG. 15 is a functional block diagram showing a correction data calculating operation in the display apparatus according to the first embodiment;

FIG. 16 is a timing chart (part 2) showing a characteristic parameter acquiring operation in the display apparatus according to the first embodiment;

FIG. 17 is a functional block diagram showing a luminance measurement image data generating operation in the display apparatus according to the first embodiment;

FIG. 18 is an operation conceptual view showing a luminance measurement image data write operation in the display apparatus according to the first embodiment;

FIG. 19 is an operation conceptual view showing a luminance measurement light-emitting operation in the display apparatus according to the first embodiment;

FIG. 20 is a functional block diagram (part 2) showing a correction data calculating operation according to the first embodiment;

FIG. 21 is a timing chart showing a light-emitting operation in the display apparatus according to the first embodiment;

FIG. 22 is a functional block diagram showing an image data correcting operation in the display apparatus according to the first embodiment;

FIG. 23 is an operation conceptual view showing a corrected image data write operation in the display apparatus according to the first embodiment;

FIG. 24 is an operation conceptual view showing a light-emitting operation in the display apparatus according to the first embodiment;

FIG. 25 is a functional block diagram showing functions of a controller applied to a display apparatus according to a second embodiment;

FIG. 26 is an operating state view at the time of light emission of an organic EL element in a pixel to which a light-emitting drive circuit according to the second embodiment is applied;

FIG. 27 is a characteristic view showing a relationship between a light-emitting voltage and a light-emitting drive current of the organic EL element at the time of a light-emitting operation in a pixel according to the second embodiment;

FIG. 28 is a view for explaining data conversion processing in a reference table applied to a controller according to the second embodiment;

FIG. 29 is a timing chart (part 1) showing a characteristic parameter acquiring operation in a display apparatus according to the second embodiment;

FIG. 30 is an operation conceptual view showing a detection voltage applying operation in the display apparatus according to the second embodiment;

FIG. 31 is an operation conceptual view showing a natural alleviating operation in the display apparatus according to the second embodiment;

FIG. 32 is an operation conceptual view showing a data line voltage detecting operation in the display apparatus according to the second embodiment;

FIG. 33 is an operation conceptual view showing a detection data transmitting operation in the display apparatus according to the second embodiment;

FIG. 34 is a functional block view (part 1) showing a correction data calculating operation in the display apparatus according to the second embodiment;

FIG. 35 is a timing chart (part 2) showing a characteristic parameter acquiring operation in the display apparatus according to the second embodiment;

FIG. 36 is a functional block diagram showing luminance measurement image data generating operation in the display apparatus according to the second embodiment;

FIG. 37 is an operation conceptual view showing a luminance measurement image data write operation in the display apparatus according to the second embodiment;

FIG. 38 is an operation conceptual view showing a luminance measurement light-emitting operation in the display apparatus according to the second embodiment;

FIG. 39 is a functional block diagram (part 2) showing a correction data calculating operation according to the second embodiment;

FIG. 40 is a timing chart showing a light-emitting operation in the display apparatus according to the second embodiment;

FIG. 41 is a functional block diagram snowing an image data correcting operation in the display apparatus according to the second embodiment;

FIG. 42 is an operation functional view showing a corrected image data write operation in the display apparatus according to the second embodiment;

FIG. 43 is an operation conceptual view showing a light-emitting operation of the display apparatus according to the second embodiment;

FIGS. 44A and 44B are perspective views showing a configuration of a digital camera according to a third embodiment;

FIG. 45 is a perspective view showing a configuration of a mobile type personal computer according to the third embodiment; and

FIG. 46 is a view showing a configuration of a mobile phone according to the third embodiment.

### DETAILED DESCRIPTION OF THE INVENTION

A pixel drive apparatus, a light-emitting apparatus, a drive control method thereof and an electronic device according to embodiments of the present invention will now be described hereinafter in detail with reference to the accompanying drawings. It is to be noted that a light-emitting apparatus is described as a display apparatus in this embodiment.

### First Embodiment

An outline configuration of a light-emitting apparatus including a pixel drive apparatus according to a first embodiment of the present invention will now be described.

(Display Apparatus)

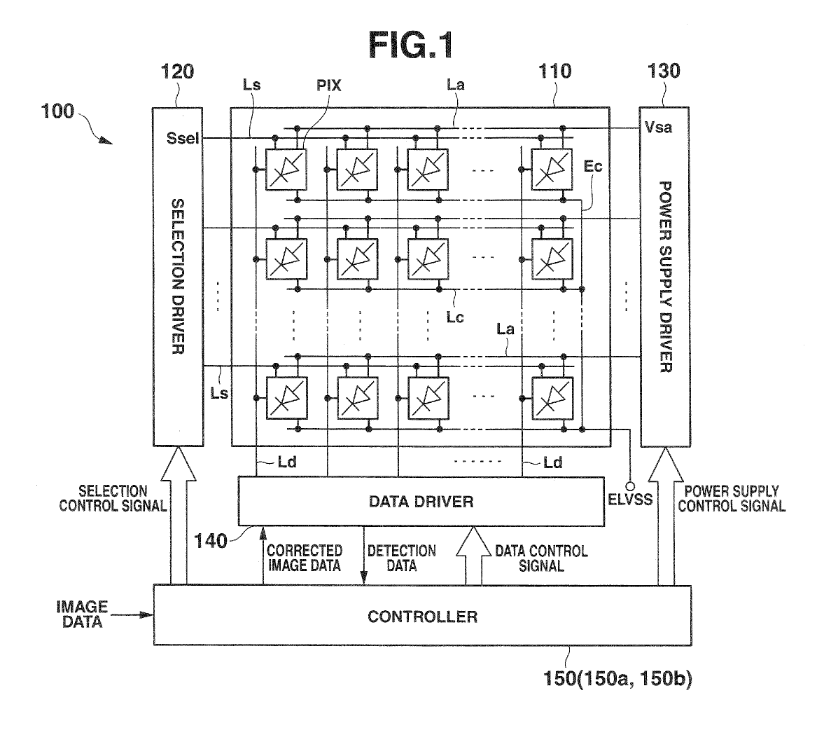

FIG. 1 is a schematic block diagram showing an example of a configuration of a display apparatus according to this embodiment.

As shown in FIG. 1, a display apparatus (a light-emitting apparatus) 100 according to this embodiment roughly includes a display panel (a light-emitting panel) 110, a selection driver (a scanning drive circuit) 120, a power supply driver 130, a data driver 140, and a controller 150 (150a, 150b).

Here, the selection driver 120, the power supply driver 130, the data driver 140, and the controller 150 correspond to a pixel drive apparatus or a drive circuit in the present invention.

As shown in FIG. 1, the display panel 110 has pixels PIX two-dimensionally arranged in a row direction (a left-and-right direction in the drawing) and a column direction (an up-and-down direction in the drawing) (e.g., p rows×q columns: p and q are positive integers), selective lines (scanning lines) Ls and power supply lines La arranged to be connected with the pixels PIX arranged in the row direction, a common electrode Ec provided to be shared by all the pixels PIX, and data lines Ld arranged to be connected with the pixels PIX arranged in the column direction. Here, as will be described later, each pixel PIX has a light-emitting drive circuit and a light-emitting element.

The selection driver 120 is connected with each selective line Ls arranged on the display panel 110. The selection driver 120 sequentially applies a selection signal Ssel on a predetermined voltage level (a selective level; Vgh or a nonselective level; Vgl) to the selective line Ls in each row at a predetermined timing based on a selection control signal (e.g., a scanning clock signal and a scanning start signal) supplied from the later-described controller 150.

It is to be noted that the selection driver 120 is configured to include a shift, register to sequentially output a shift signal associated with the selective line Ls in each row based on the selection control signal supplied from the controller 150 and an output buffer to convert the shift signal into a predetermined signal level (a selective level: e.g., a high level) to be sequentially output as a selection signal Ssel to the selective line Ls in each row, for example.

The power supply driver 130 is connected with each power supply line La arranged on the display panel 110. The power supply driver 130 applies a power supply voltage Vsa on a predetermined voltage level (a light-emitting level; ELVDD or a non-light-emitting level; DVSS) to the power supply line La in each row based on a power supply control signal (e.g., an output control signal) supplied from the later-described controller 150.

The data driver 140 is connected with each data line Ld on the display panel 110, generates a gradation signal (a gradation voltage Vdata) associated with image data in at least a display operation (a light-emitting operation) based on a data control signal supplied from the later-described controller 150 and supplies the generated signal to each pixel PIX through each data line Ld.

Further, the data driver 140 applies a detection voltage (a first voltage) Vdac having a specific voltage value to the pixel PIX as a characteristic parameter acquiring operation target, through each data line Ld at the time of the later-described characteristic parameter acquiring operation, fetches a voltage Vd in each data line Ld after elapse of a predetermine natural relaxation time t as a data line detection voltage Vmeas(t), and converts the fetched voltage into detection data nₘₑₐₛ(t) to be output.

Here, the data driver 140 has both a data driver function and a voltage detecting function and is configured to enable changeover between these functions based on the data control signal fed from the later-described controller 150.

The data driver function executes an operation of converting image data comprising digital data supplied via the controller 150 into an analog signal voltage and outputting the converted voltage to each data line Ld as a gradation signal (a gradation voltage Vdata).

The voltage detecting function executes an operation of fetching the analog signal voltage Vd in each data line Ld as the data line detection voltage Vmeas(t), converting the fetched voltage into digital data and outputting the converted data as the detection data nₘₑₐₛ(t) to the controller 150.

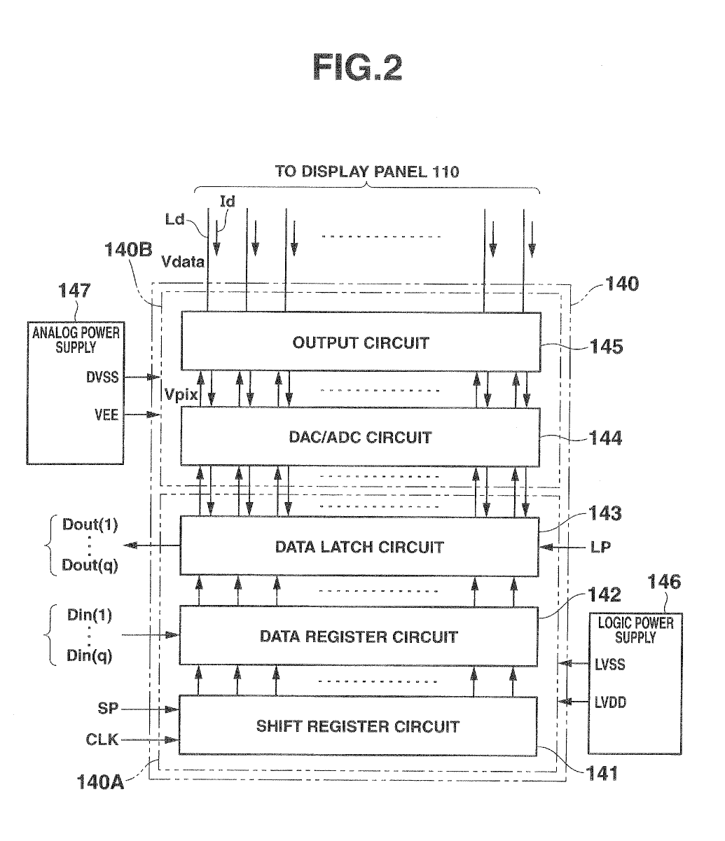

FIG. 2 is a schematic block diagram showing an example of a configuration of the data driver applied to the display apparatus according to this embodiment.

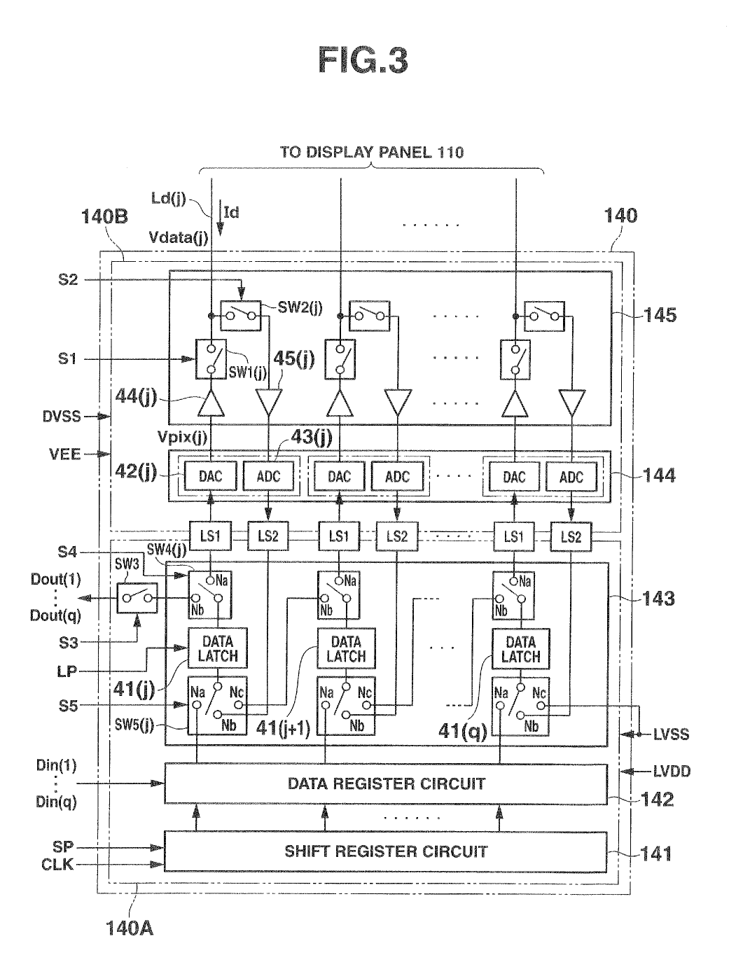

FIG. 3 is a schematic circuit block diagram showing a primary structural example of the data driver depicted in FIG. 2.

Here, the columns (q) of the pixels PIX arranged on the display panel 110 are only partially shown to simplify the drawing.

An internal configuration of the data driver 140 provided to the data lines Ld in a jth column (j is a positive integer satisfying l≦j≦q) will be described in detail hereinafter.

Furthermore, in FIG. 3, a shift register circuit and a data register circuit are simplified.

For example, as shown in FIG. 2, the data driver 140 roughly includes a shift register circuit 141, a data register circuit 142, a data latch circuit 143, a DAC/ADC circuit 144, and an output circuit 145. The data driver 140 is divided into an internal circuit 140A and an internal circuit 140B.

The internal circuit 140A includes the shift register circuit 141, the data register circuit 142, and the data latch circuit 143 and executes a later-described image data fetching operation and a detection data transmitting operation based on power supply voltages LVSS and LVDD supplied from a logic power supply 146.

The internal circuit 140B includes the DAC/ADC circuit 144 and the output circuit 145 and executes a later-described gradation signal generating and outputting operation and a data line voltage detecting operation based on power supply voltages DVSS and VEE supplied from an analog power supply 147.

The shift register circuit 141 generates a shift signal based on a data control signal (a clock signal CLK and a start pulse signal SP) fed from the controller 150 to be sequentially output to the data register circuit 142. The data register circuit 142 includes registers whose number is equal to the number of columns (q) of the pixels PIX arranged on the display panel 110. The data register circuit 142 sequentially fetches pieces of image data Din(1) to Din(q) corresponding to one row based on input timings of the shift signals supplied from the shift register circuit 141. Here, the pieces of image data Din(1) to Din(q) are serial data comprising digital signals.

The data latch circuit 143 holds the pieces of image data Din(1) to Din(q) corresponding to one row fetched to the data register circuit 142 in accordance with respective columns based on the data control signal (a data latch pulse signal LP) and supplies the pieces of image data Din(1) to Din(q) to the later-described DAC/ADC circuit 141 at predetermined timings at the time of a display operation (the image data fetching operation and the gradation signal generating and outputting operation).

Moreover, the data latch circuit 143 holds the detection data nₘₑₐₛ(t) associated with each data line voltage Vmeas (t) fetched through the later-described DAC/ADC circuit 144 and then outputs the detection data nₘₑₐₛ(t) at a predetermined timing as serial data at the time of the characteristic parameter acquiring operation (the detection data transmitting operation and the data line voltage detecting operation).

As shown in FIG. 3, the data latch circuit 143 specifically includes data latches 41(j) and connection changeover switches SW4(j) and SW5(j) that are provided in accordance with the respective columns, and a data output switch SW3. The data latch 41(j) holds (latches) digital data fed through the switch SW5(j) at, e.g., a rising timing of the data latch pulse signal LP.

The switch SW5(j) is subjected to changeover control to selectively connect one of the data register circuit 142 on a contact Na side, an ADC 43(j) of the PAC/ADC circuit 144 on a contact Nb side and the data latch 41(j+1) in an adjacent column (j+1) on a contact Nc side to the data latch 41(j) based on a data control signal (a changeover control signal S5) fed from the controller 150.

As a result, when the switch SW5(j) is set to be connected to the contact Na side, image data Din(j) supplied from the data register circuit 142 is held in the data latch 41(j).

Additionally, when the switch SW5(j) is set to be connected to the contact Nb side, the detection data nₘₑₐₛ(t) associated with the data line voltage Vd (the data line detection voltage Vmeas(t)) fetched to the ADC43(j) of the DAC/ADC circuit 144 from the data line Ld(j) is held in the data latch 41(j).

Further, when the switch SW5(j) is set to be connected to the contact Nc side, the detection data nₘₑₐₛ(t) held in the data latch 41(j+1) through the switch SW4(j+1) in the adjacent column (j+1) is held in the data latch 41(j).

It is to be noted that the power supply voltage LVSS of the logic power supply 146 is connected with the contact Nc of the switch SW5(q) provided in the last column (q).

The switch SW4(j) is subjected to changeover control to selectively connect one of the DAC 42(j) of the DAC/ADC circuit 144 on the contact Na side, the switch SW3 on the contact Nb side and the switch SW5(j−1) in the adjacent column (j−1) to the data latch 41(j) based on the data control signal (a changeover control signal S4) supplied from the controller 150.

As a result, when the switch SW4(j) is set to be connected to the Na side, image data Din(j) held in the data latch 41(j) is supplied to the DAC 42(j) of the DAC/ADC circuit 144. Furthermore, when the switch SW4(j) is set to be connected to the contact Nb side, the detection data nₘₑₐₛ(t) associated with the data line detection voltage Vmeas(t) held in the data latch 41(j) is output to the outside through the switch SW3.

When the switches SW4(j) and SW5(j) of the data latch circuit 143 are subjected to changeover control based on the data control signals (changeover control signals S4 and S5) fed from the controller 150 and the data latches 41(1) to 41(q) in the adjacent columns are connected to each other in series, the switch SW3 is controlled to enter a conductive state based on the data control signals (a changeover control signal S3 and the data latch pulse signal LP). As a result, the pieces of detection data nₘₑₐₛ(t) associated with the data line voltages Vmeas(t) held in the data latches 41(1) to 41(q) in the respective columns are sequentially fetched as serial data through the switch SW3 to be output to the outside.

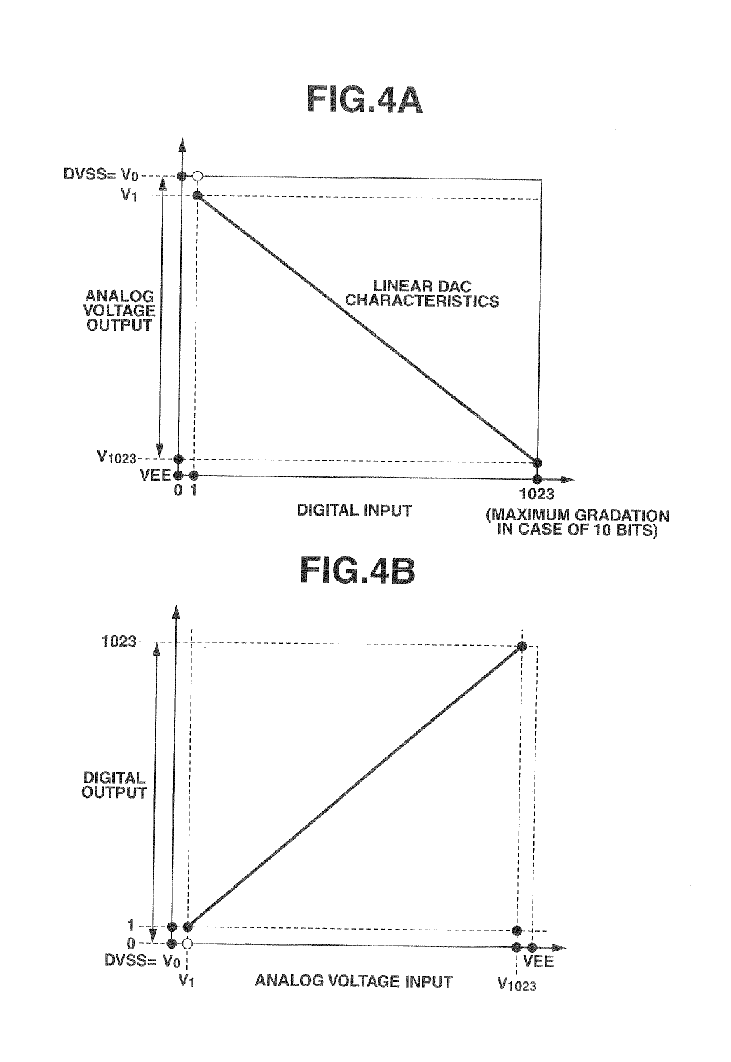

FIGS. 4A and 45 are views showing input and output characteristics of a digital-analog conversion circuit (DAC) and an analog-digital conversion circuit (ADC) applied to the data driver according to this embodiment. FIG. 4A is a view showing input and output characteristics of the DAC applied to this embodiment, and FIG. 4B is a view showing input and output characteristics of the ADC applied to this embodiment. Here, an example of the input and output characteristics of the digital-analog conversion circuit and the analog-digital conversion circuit when the number of input and output bits in a digital signal is 10 will be described.

As shown in FIG. 3, the DAC/ADC circuit 144 includes linear voltage digital-analog conversion circuits (DACs; voltage application circuits) 42(j) and analog-digital conversion circuits (ADCs; detection data acquisition circuits) 43j in accordance with the respective columns.

The DAC 42(j) converts image data Din(j) comprising digital data held in the data latch circuit 143 into an analog signal voltage Vpix(j) to be output to the output circuit 145.

Here, as shown in FIG. 4A, in the DAC 42(j) provided in each column, conversion characteristics (the input and output characteristics) of an analog signal voltage to be output with respect to input digital data has linearity. That is, as shown in, e.g., FIG. 4A, the DAC 42(j) converts digital data (0, 1, . . . , 1023) comprising 10 bits (i.e., 1024 gradations) into an analog signal voltage (V₀, V₁, . . . , V₁₀₂₃) set with the linearity.

This analog signal voltage (V₀ to V₁₀₂₃) is set within a range of the power supply voltages DVSS to VEE supplied from the later-described analog power supply 147, and an analog signal voltage value V₀ that is converted when a value of input digital data is “0” (0 gradation) is set to become the power supply voltage DVSS on a high-potential side, for example. Furthermore, an analog signal voltage value V₁₀₂₃ that is converted when a value of digital data is “1023” (a 1023-gradation level; a maximum gradation) is set to become higher than a power supply voltage VEE on a low-potential side and close to the power supply voltage VEE.

Moreover, the ADC 43(j) converts the data line voltage Vₘₑₐₛ(t) comprising an analog signal voltage fetched from the data line Ld(j) into detection data nₘₑₐₛ(t) comprising digital data to be transmitted to the data latch 41(j).

Here, as shown in FIG. 4B, in the ADC 43(j) provided in each column, conversion characteristics (input and output characteristics) of output digital data with respect to an input analog signal voltage have linearity.

Additionally, the ADC 43(j) is set in such a manner that a bit width of digital data at the time of voltage conversion becomes equal to that in the DAC 42(j). That is, a voltage width with respect to a least significant bit (1 LSB; an analog resolution) in the ADC 43(j) is set to be equal to a value in the DAC 42(j).

For example, as shown in FIG. 4B, the ADC 43(j) converts the analog signal voltage (V₀, V₁, . . . , V₁₀₂₃) set in a range of the power supply voltages DVSS to VEE into digital data (0, 1, . . . , 1023) each comprising 10 bits (the 1024 gradations) set with the linearity.

The ADC 43(j) is set in such a manner that a value of digital data is converted into “0” (the 0 gradation level) when a voltage value of an input analog signal voltage is V₀ (=DVSS). The ADC 43(j) is set in such a manner that a voltage value of an analog signal voltage is converted into a digital signal value “1023” (the 1023 gradation level; the maximum gradation) when it is higher than the power supply voltage VEE and equal to the analog signal voltage V₁₀₂₃ that is a voltage value near the power supply voltage VEE.

In this embodiment, the internal circuit 140A including the shift register circuit 141, the data register circuit 142 and the data latch circuit 143 is configured as a low-breakdown voltage circuit, and the internal circuit 140B including the DAC/ADC circuit 144 and the later-described output circuit 145 is configured as a high-breakdown voltage circuit.

Therefore, a level shifter LS1(j) is provided between the data latch circuit 143 (the switch SW4(j)) and the DAC 42(j) of the DAC/ADC circuit 144 as a voltage adjustment circuit from the low-breakdown voltage internal circuit 140A to the high-breakdown voltage internal circuit 140B.

Further, a level shifter LS2(j) is provided between the ADC 43(j) of the DAC/ADC circuit 144 and the data latch circuit 143 (the switch SW5(j)) as a voltage adjustment circuit from the high-breakdown voltage internal circuit 140B to the low-breakdown voltage internal circuit 140A.

As shown in FIG. 3, the output circuit 145 includes buffers 44(j) and switches SW1(j) (connection changeover circuits) that are configured to output gradation signal to the data lines Ld(j) corresponding to the respective columns and switches SW2(j) and buffers 45(j) that are configured to fetch a data line voltage Vd (the data line detection voltage Vmeas(t)).

The buffer 44(j) is a buffer circuit to apply an analog signal voltage Vpix(j) generated by using the DAC 42(j) to convert the image data Din(j) into analog data to the data line Ld(j) through the switch SW1(j) as a gradation voltage Vdata(j).

The switch SW1(j) controls application of the gradation voltage Vdata(j) to the data line Ld(j) based on the data control signal (a changeover control signal S1) supplied from the controller 150.

Furthermore, the switch SW2(j) controls fetch of a data line voltage Vd (the data line detection voltage Vmeas(t)) based on the data control signal (a changeover control signal S2) supplied from the controller 150.

The buffer 45(j) is a buffer circuit that is configured to apply the data line voltage Vmeas(t) fetched through the switch SW2(j) to the ADC 43(j).

The logic power supply 146 supplies the low-potential side power supply voltage LVSS and the high-potential side power supply voltage LVDD comprising logic voltages that are used to drive the internal circuit 140A including the shift register circuit 141, the data register circuit 142 and the data latch circuit 143 in the data driver 140.

The analog power supply 147 supplies the high-potential side power supply voltage DVSS and the low-potential side power supply voltage VEE comprising analog voltages that are used to drive the internal circuit 140B including the DAC 42(j) and the ADC 43(j) of the DAC/ADC circuit 144 and the buffers 44(j) and 45(j) of the output circuit 145.

It is to be noted that, in the data driver 140 depicted in FIG. 2 and FIG. 3, the control signals that are used to control operations of the respective units are input to the data latch 41 and the switches SW1 to SW5 provided in accordance with the data line Ld(j) in the jth column (corresponding to the first column in the drawing). In this embodiment, it is needless to say that these control signals are input, to a configuration associated with each column in common.

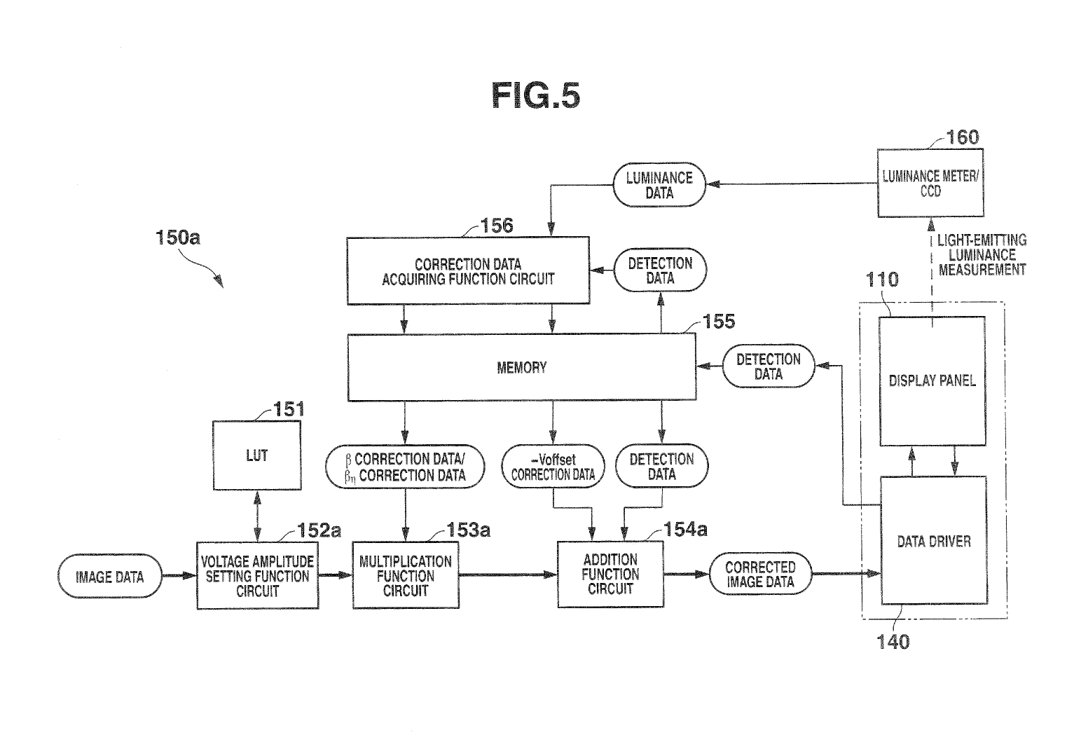

FIG. 5 is a functional block diagram showing functions of the controller applied to the display apparatus according to this embodiment.

It is to be noted that, in FIG. 5, flows of data between respective functional blocks are all indicated by solid arrows for the sake of graphic representation. Any one of these data flows is actually activated in accordance with an operating state of the controller as will be described later.

The controller 150a according to this embodiment controls operating states of at least the selection driver 120, the power supply driver 130 and the data driver 140 and generates and outputs a selection control signal, a power supply control signal and a data control signal that are used to execute predetermined drive control operations in the display panel 110.

The controller 150a operates the selection driver 120, the power supply driver 130 and the data driver 140 at predetermined timings by supplying the selection control signal, the power supply control signal and the data control signal, thereby controlling an operation of acquiring a characteristic parameter of each pixel PIX of the display panel 110 (a characteristic parameter acquiring operation) and an operation of displaying image information associated with image data corrected based on the characteristic parameter of each pixel PIX in the display panel 110 (a display operation).

Moreover, the controller 150a acquires various kinds of correction data based on detection data concerning a change in characteristics of each pixel PIX detected through the data driver 140 and luminance data detected in regard to each pixel PIX (which will be described later in detail) in the characteristic parameter acquiring operation.

Additionally, the controller 150a corrects image data supplied from the outside based on correction data acquired in the characteristic parameter acquiring operation and supplies the corrected data as corrected image data to the data driver 140 in the display operation.

Specifically, for example, as shown in FIG. 5, the controller (an image data correction circuit) 150a roughly has a voltage amplitude setting function circuit 152a including a reference table (LUT) 151, a multiplication function circuit (an image data correction circuit) 153a, an addition function circuit (an image data correction circuit) 154a, a memory (a storage circuit) 155 and a correction data acquiring function circuit (a characteristic parameter acquisition circuit) 156.

The voltage amplitude setting function circuit 152a converts voltage amplitudes associated with respective colors, i.e., red (R), green (G) and blue (B) by making reference to the reference table 151 for image data comprising digital data supplied from the outside. Here, a maximum value of the converted voltage amplitude of the image data is set to be equal to or below a value obtained by subtracting a correction amount based on the characteristic parameter of each pixel from a maximum value of the input range of the DAC 42.

The multiplication function circuit 153a multiplies correction data of a current gain β acquired based on detection data concerning a change in characteristics of each pixel PIX or luminance data (a light-emitting current efficiency η) detected in regard to each pixel PIX and the correction data of the current gains β by image data.

The addition function circuit 154a adds correction data of a threshold voltage Vth of a drive transistor acquired based on the detection data concerning a change in characteristics of each pixel PIX to image data and supplies the added data to the data driver 140 as corrected image data.

The correction data acquiring function circuit 156 acquires correction data of the current gain β, the light-emitting current efficiency η and the threshold voltage Vth based on the detection data concerning a change in characteristics of each pixel PIX and the luminance data detected in regard to each pixel PIX. Here, as to the luminance data of each pixel PIX, light-emitting luminance of each pixel PIX when the display panel 110 performs a light-emitting operation based on image data having a predetermined luminance gradation is measured by using a luminance meter or a CCD camera (a luminance measurement circuit) 160. It is to be noted that a specific measurement method for luminance data will be described later.

The memory 155 stores the detection data of each pixel PIX supplied from the data driver 140 in accordance with each pixel PIX.

Further, the memory 155 stores the correction data acquired in the correction data acquiring function circuit 156 in accordance with each pixel PIX.

At the time of the addition processing in the addition function circuit 154a and the correction data acquisition processing in the correction data acquiring function circuit 156, the addition function circuit 154a and the correction data acquiring function circuit 156 read the detection data from the memory 155.

It is to be noted that, in the controller 150a depicted in FIG. 5, the correction data acquiring function circuit 156 may be an arithmetic apparatus provided outside the controller 150a.

Furthermore, in the controller 150a depicted in FIG. 5, different memories may be provided as the memory 155 as long as they store the detection data and the correction data in association with each pixel PIX.

Moreover, these memories 155 may be a storage apparatuses provided outside the controller 150a.

Additionally, the image data supplied to the controller 150a is obtained by extracting a luminance gradation signal component from a video signal and forming the luminance gradation signal component as serial data comprising a digital signal in accordance with each row in the display panel 110.

(Pixel)

A configuration of each pixel arranged on the display panel according to this embodiment will now be specifically described.

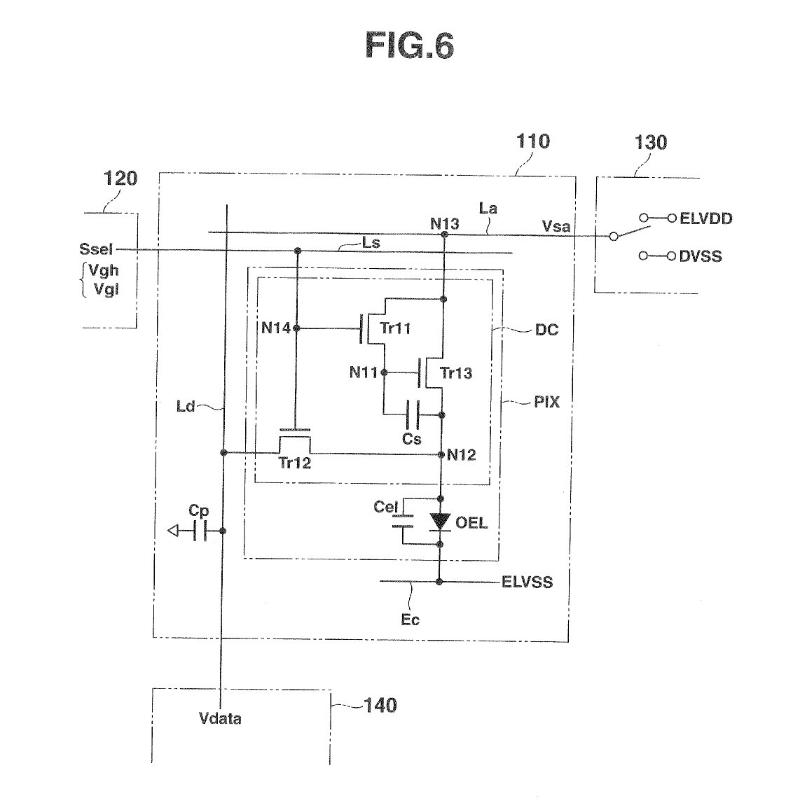

FIG. 6 is a circuit block diagram showing an embodiment of the pixel applied to the display panel according to this embodiment.

As shown in FIG. 6, each pixel PIX applied to the display panel 110 according to this embodiment is arranged near each intersecting point of the selective lines Ls connected with the selection driver 120 and the data lines Ld connected with the data driver 140. Each pixel PIX includes an organic EL element OEL as a current drive type light-emitting element and a light-emitting drive circuit DC that generates a current that is used to drive the organic EL element OEL for light emission.

The light-emitting drive circuit DC depicted in FIG. 6 roughly has a circuit configuration including transistors Tr11 to Tr13 and a capacitor (a storage capacitor) Cs.

The transistor (a second transistor) Tr11 has a gate terminal connected with the selective line Ls, a drain terminal connected with the power supply line La and a source terminal connected with a connection point N11.

The transistor (a third transistor) Tr12 has a gate terminal connected with the selective line Ls, a source terminal connected with the data line Ld and a drain terminal connected with a connection point N12.

The transistor (a drive control element, a first transistor) Tr13 has a gate terminal connected with the connection point N11, a drain terminal connected with the power supply line La and a source terminal connected with a connection point N12.

Further, the capacitor (a capacitance element) Cs is connected to between the gate terminal (the connection point N11) and the source terminal (the connection point N12) of the transistor Tr13. The capacitor Cs may be a parasitic capacitance formed between the source/gate terminals of the transistor Tr13 or may be a capacitance obtained by connecting different capacitance elements in series between the connection point N11 and the connection point N12 in addition to the parasitic capacitance.

Furthermore, the organic ad element OEL has an anode (an anode electrode) connected with the connection point N12 of the light-emitting drive circuit DC and a cathode (a cathode electrode) connected with the common electrode Ec. The common electrode Dc is connected with an external constant voltage source and receives a predetermined voltage ELVSS (e.g., a ground potential GND).

It is to be noted that, in the pixel PIX shown in FIG. 6, a pixel capacitance Cel is present in the organic EL element OEL besides the capacitor Cs. Moreover, a wiring parasitic capacitance Cp is present on the data line Ld.

Here, in the pixel PIX according to this embodiment, a relationship between a power supply voltage Vsa (ELVDD, DVSS) applied to the power supply line La from the power supply driver 130, the voltage ELVSS applied to the common electrode Ec and the power supply VEE supplied to the data driver 140 from the analog power supply 147 is set to satisfy, e.g., the following conditions.

$$\begin{matrix}DVSS < ELDD \\ DVSS = ELVSS ( = GND ) \\ VEE < ELVSS\end{matrix} \} \qquad ( 1 )$$

It is to be noted that, in the pixel PIX depicted in FIG. 6, thin film transistors (TFT) having the same channel type can be applied to the transistors Tr11 to Tr13, for example. Each of the transistors Tr11 to Tr13 may be an amorphous silicon thin film transistor or may be a polysilicon thin film transistor.

In particular, as shown in FIG. 6, when an n-channel type thin film transistor is applied as each of the transistors Tr11 to Tr13 and an amorphous silicon thin film transistor is applied as each of the transistor Tr11 to Tr13, an already established amorphous silicon manufacturing technology can be applied to realize each transistor having uniform and stable operation characteristics (e.g., electron mobility) in a manufacturing process simpler than that of a polycrystal type or single-crystal type silicon thin film transistor.

Additionally, in the pixel PIX, the circuit configuration in which the three transistors Tr11 to Tr13 are included as the light-emitting drive circuit DC and the organic EL element OEL is applied as the light-emitting element has been described. The present invention is not restricted to this embodiment, and any other circuit configuration including three or more transistors may be adopted. Further, as the light-emitting element that is driven to emit light by the light-emitting drive circuit DC, a current drive type light-emitting element can suffice, and any other light-emitting element such as a light-emitting diode may be used.

(Drive Control Method for Display Apparatus)

A drive control method in the display apparatus according to this embodiment will now be described.

A drive control operation of the display apparatus 100 according to this embodiment is roughly constituted of the characteristic parameter acquiring operation and the display operation.

In the characteristic parameter acquiring operation, a parameter that is used to compensate a fluctuation in light-emitting characteristics in each pixel PIX arranged on the display panel 110 is acquired.

More specifically, the characteristic parameter acquiring operation executes an operation of acquiring a parameter that is used to correct a fluctuation in the threshold voltage Vth of the transistor (the drive transistor) Tr13 provided in the light-emitting drive circuit DC of each pixel PIX, a parameter that is used to correct a variation of the current gain β in each pixel PIX with respect to a set value, and a parameter that is used to correct a variation of the light-emitting efficiency η of the organic EL element OEL in each pixel PIX with respect to a set value.

In the display operation, corrected image data obtained by correcting image data comprising digital data is generated based on the correction parameter acquired by the characteristic parameter acquiring operation in accordance with each pixel. PIX, a gradation voltage Vdata associated with the corrected image data is generated, and the data is written into each pixel PIX. As a result, each pixel PIX (the organic EL element OEL) emits light in an original luminance gradation associated with the image data obtained by compensating a fluctuation or a variation in electrical characteristics (the threshold voltage Vth or the current gain β of the transistor Tr13) and light-emitting characteristics (the light-emitting current efficiency η of the organic EL element OEL) in each pixel PIX.

Each operation will now be specifically explained hereinafter.

(Characteristics Parameter Acquiring Operation)

A description will be given as to a intrinsic technique that is applied to the characteristic parameter acquiring operation according to this embodiment. Moreover, an operation of acquiring characteristic parameters that are used to compensate the threshold voltage Vth and the current gain β in each pixel PIX by using this technique will be described. Subsequently, an operation of acquiring a characteristic parameter that is used to compensate the light-emitting current efficiency η will be explained.

A description will be first given as to voltage-current (V-I) characteristics of the light-emitting drive circuit DC when image data is written into the pixel PIX having the light-emitting drive circuit DC depicted in FIG. 6 from the data driver 140 via the data line Ld (the gradation voltage Vdata associated with the image data is applied).

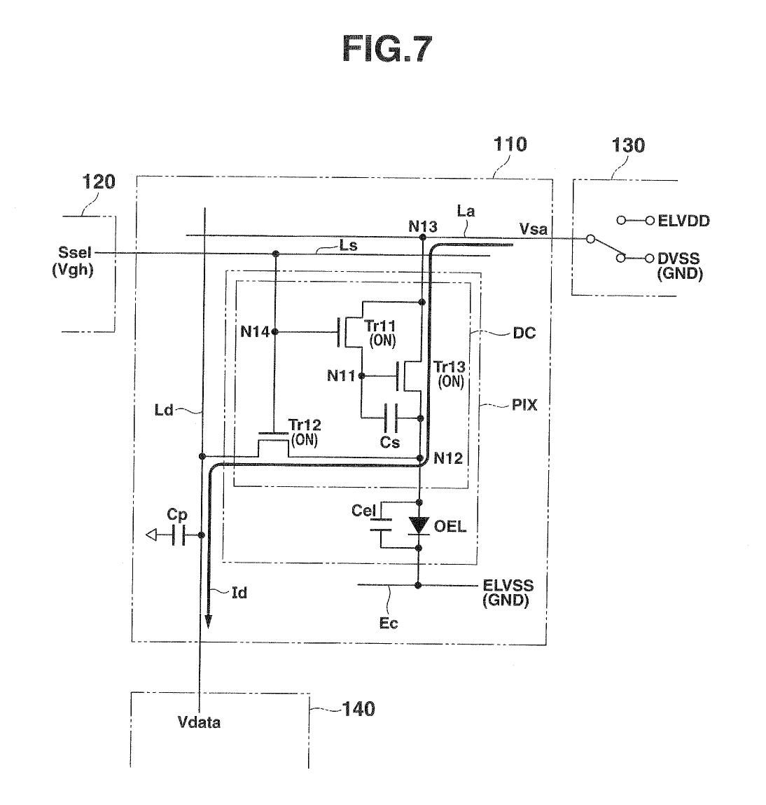

FIG. 7 is an operating state diagram when writing image data in the pixel to which the light-emitting drive circuit according to this embodiment is applied.

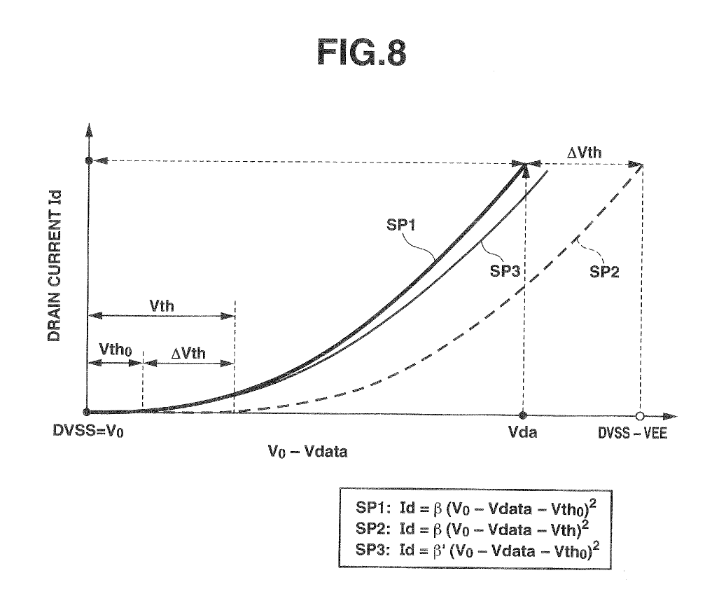

FIG. 8 is a view showing voltage-current characteristics at the time of a write operation in the pixel to which the light-emitting drive circuit according to this embodiment is applied.

In the operation of writing the image data into the pixel PIX according to this embodiment, as shown in FIG. 7, the pixel PIX is set to a selective state by applying a selection signal Ssel on a selective level (a high level; Vgh) from the selection driver 1250 via the selective line Ls.

At this time, the transistors Tr11 and Tr12 of the light-emitting drive circuit DC enter an ON state, whereby the gate and drain terminals of the transistor Tr13 are short-circuited to set to a diode connection state.

Further, in this selective state, a power supply voltage Vsa (=DVSS) on a non-light-emitting level is applied from the power supply driver 130 through the power supply line La.

Furthermore, a gradation voltage Vdata having a voltage value associated with the image data is applied to the data line Ld from the data driver 140. Here, the gradation voltage Vdata is set a voltage value lower than the power supply voltage DVSS that is applied from the power supply driver 130. Therefore, when the power supply voltage DVSS is set to 0 V (the ground potential GND), the gradation voltage Vdata is set to a negative voltage value.

As a result, as shown in FIG. 7, a drain current Id associated with the gradation voltage Vdata flows in a direction of the data line Ld from the power supply driver 130 through the power supply line La and the transistors Tr13 and Tr12 of the pixel PIX (the light-emitting drive circuit DC). Here, since the voltage ELVSS and the power supply voltage DVSS applied to the cathode (the cathode electrode) of the organic EL element OEL are set to the same voltage value like the conditions of (1) and they are both 0 V (the ground potential GND), a reverse bias is applied to the organic EL element OEL, and the light-emitting operation is not performed.

Circuit characteristics of the light-emitting drive circuit DC in this case will now be verified. Assuming that Vth₀ is a threshold voltage of the transistor Tr13 and β is a current gain in an initial state that the threshold voltage Vth of the transistor Tr13 as the drive transistor does not fluctuate in the light-emitting drive circuit DC and the current gain in the light-emitting drive circuit DC does not vary with respect to the set value, a current value of the drain current Id depicted in FIG. 7 can be represented by the following Expression (2).

Id=β(V₀−Vdata−Vth₀)² (2)

In this expression, both the current gain β of a design value or typical value in the light-emitting drive circuit DC and the initial threshold voltage Vth₀ of the transistor Tr13 are constant values. Furthermore, V₀ is a power supply voltage Vsa (=DVSS) on anon-light-emitting level applied from the power supply driver 130, and a voltage (V₀−Vdata) corresponds to a potential difference that is applied to a circuit configuration in which current paths of the drive transistors Tr13 and Tr12 are connected in series. A relationship (V-I characteristics) between a value of the voltage (V₀−Vdata) applied to the light-emitting drive circuit DC at this moment and a current value of the drain current Id flowing through the light-emitting drive circuit DC is represented as a characteristic line SP1 in FIG. 8.

Moreover, assuming that Vth (=Vth₀+ΔVth) is a threshold voltage after a fluctuation (threshold voltage shift; a fluctuation amount is ΔVth) occurs in element characteristics of the transistor Tr13 due to a change with time, circuit characteristics of the light-emitting drive circuit DC vary as represented by the following Expression (3). Here, Vth is a constant. The voltage-current (V-I) characteristics of the light-emitting drive circuit DC in this example are represented as a characteristic line SP2 in FIG. 8.

Id=β(V₀−Vdata−Vth)² (3)

Additionally, assuming that β′ is a current gain when the current gain β varies from the set value in the initial state represented by Expression (2), circuit characteristics of the light-emitting drive circuit DC can be represented by the following Expression (4).

Id=β′(V₀−Vdata−Vth₀)² (4)

In this expression, β′ is a constant. The voltage-current (V-I) characteristics of the light-emitting drive circuit DC at this moment are represented as a characteristic line SP3 in FIG. 8. It is to be noted that the characteristic line SP3 in FIG. 8 is indicative of the voltage-current (V-I) characteristics of the light-emitting drive circuit DC when the current gain β′ in Expression (4) is smaller than the current gain β depicted in FIG. 2.

In Expressions (2) and (4), when βtyp is a current gain of the design value or the typical value, Δβ is a parameter (correction data) used to correct the current gain β′ to this value. At this time, correction data Δβ is given to each light-emitting drive circuit DC in such a manner that a multiplied value of the current gain β′ and the correction data Δβ becomes the current gain βtyp of the design value (i.e., in such a manner that β′×Δβ→βtyp is achieved).

Further, in this embodiment, based on the voltage-current characteristics (Expressions (2) to (4) and FIG. 8) of the light-emitting drive circuit DC, the threshold voltage Vth of the transistor Tr13 and a characteristic parameter required to correct the current gain β′ are acquired by using the following intrinsic technique. It is to be noted that, in this specification, the following technique is called an “autozero method” for the convenience's sake.

According to the technique (the autozero method) applied to the characteristic parameter acquiring operation in this embodiment, in the pixel PIX having the light-emitting drive circuit DC depicted in FIG. 6, a predetermined detection voltage Vdac is applied to the data line Ld by using a data driver function of the data driver 140 in the selective state.

Thereafter, the data line Ld is set to a high-impedance (HZ) state to naturally alleviate a potential in the data line Ld.

Furthermore, a voltage Vd (the data line detection voltage Vmeas(t)) in the data line Ld after effecting this natural relaxation for a fixed time (relaxation time t) is fetched by using a voltage detecting function of the data driver 140.

Moreover, the fetched data line detection voltage Vmeas(t) is converted into the detection data nₘₑₐₛ(t) comprising digital data.

Here, in this embodiment, this relaxation time t is set to different times (timings; t₀, t₁, t₂, t₃) to execute fetch of the data line detection voltage Vmeas(t) and conversion into the detection data nₘₑₐₛ(t) more than once.

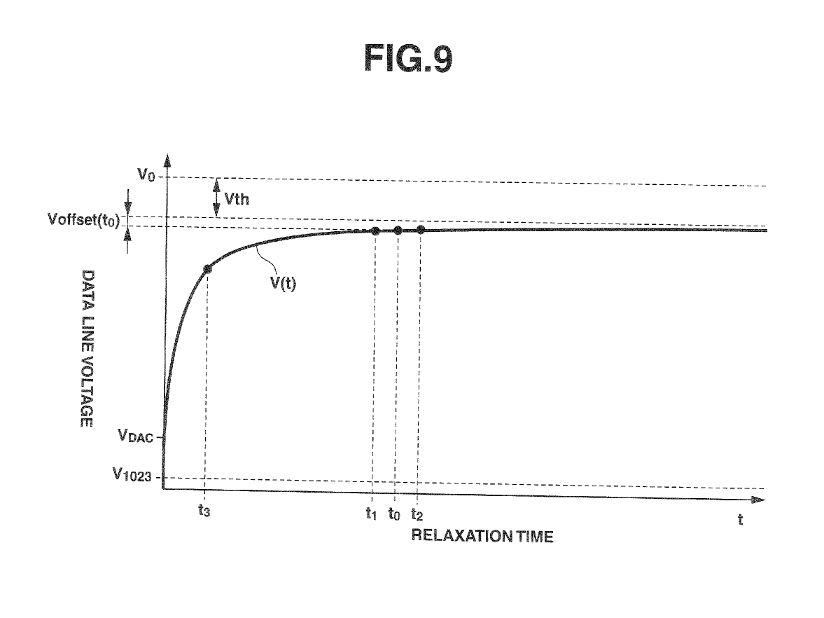

FIG. 9 is a view (a transient curve) showing a change in data line voltage in the technique (the autozero method) applied to the characteristic parameter acquiring operation according to this embodiment.

Specifically, in the characteristic parameter acquiring operation using the autozero method, the pixel PIX is first set to the selective state, and the detection voltage Vdac is applied to the data line Ld from the data driver 140 in such a manner that a voltage exceeding the threshold voltage of the transistor Tr13 of the light-emitting drive circuit DC is applied between the gate and source terminals (between the connection points N11 and N12) of the transistor Tr13 in this state.

At this moment, in a write operation with respect to the pixel PIX, since the power supply voltage DVSS (=V₀; the ground potential GND) on the non-light-emitting level is applied to the power supply line La from the power supply driver 130, a potential difference (V₀−Vdac) Is applied to the part between the gate and source terminals of the transistor Tr13. Therefore, the detection voltage Vdac is set to a voltage satisfying the condition V₀−Vdac>Vth. Further, the detection voltage Vdac is set to a voltage value that is lower than the power supply voltage DVSS and has a negative polarity with respect to the power supply voltage ELVSS (the ground potential GND) applied to the common electrode Ec connected to the cathode of the organic EL element OEL.

As a result, the drain current Id associated with the detection voltage Vdac flows in the data line id direction from the power supply driver 130 via the power supply line La and the transistors Tr13 and Tr12. At time this, the capacitor Cs connected to the part between the gate and the source (between the connection points N11 and N12) of the transistor Tr13 is charged with a voltage associated with the detection voltage Vdac.

Subsequently, the data input side (the data driver 140 side) of the data line id is set to the high-impedance (HZ) state. Here, the voltage with which the capacitor Cs is charged is maintained at a voltage associated with the detection voltage Vdac immediately after the data line Ld is set to the high-impedance state. Therefore, a voltage Vgs between the gate and the source of the transistor Tr13 is maintained at a voltage with which the capacitor Cs is charged.

As a result, the transistor Tr 13 maintains the ON state immediately after the data line Ld is set to the high-impedance state, whereby the drain current Id flows through the part between the drain and the source of the transistor Tr13. Here, a potential at the source terminal (the connection point N12) of the transistor Tr13 gradually increases to approximate a potential on the drain terminal side with elapse of time, and a current value of the drain current Id flowing between the drain and the source of the transistor Tr13 is reduced.

With this reduction, a part of the electric charge stored in the capacitor Cs is discharged, whereby a voltage between both ends of the capacitor Cs (the voltage Vgs between the gate and the source of the transistor Tr13) is gradually decreased. As a result, the voltage Vd in the data line Ld gradually increases from the detection voltage Vdac with elapse of time to converge on a voltage (V₀−Vth) obtained by subtracting the threshold voltage Vth of the transistor Tr13 from the voltage on the drain terminal side of the transistor Tr13 (the power supply voltage DVSS of the power supply line La (=V₀)) (natural relaxation).

Furthermore, in such natural relaxation, when the drain current Id finally does not flow between the drain and the source of the transistor Tr13, the discharge of the electric charge stored in the capacitor Cs is stopped. A gate voltage of the transistor Tr13 (the voltage Vgs between the gate and the source) becomes the threshold voltage Vth of the transistor Tr13.

Here, in a state that the drain current Id does not flow between the drain and the source of the transistor Tr13 of the light-emitting drive circuit DC, the voltage between the drain and the source of the transistor Tr12 becomes substantially zero, and hence the data line voltage Vd becomes substantially equal to the threshold voltage Vth of the transistor Tr13 at the end of the natural relaxation.

It is to be noted that, in the transient curve depicted in FIG. 9, the data line voltage Vd converges on the threshold voltage Vth (=|V₀−Vth|; V₀=0 V) of the transistor Tr13 with elapse of time (the relaxation time t). However, the data line voltage Vd unboundedly gradually approximates the threshold voltage Vth, but it does not become perfectly equal to the threshold voltage Vth in theory even though the relaxation time t is set to a sufficiently long time.

Such a transient curve (a behavior of the data line voltage Vd caused due to the natural relaxation) can be represented by the following Expression (11).

$$\begin{matrix}Vd = {V}_{meas} ( t ) \\ = {V}_{0} - Vth - \frac{{V}_{0} - Vdac - Vth}{( β / C ) t ( {V}_{0} - Vdac - Vth ) + 1}\end{matrix} \qquad ( 11 )$$

In Expression (11), C is a sum total of capacitance components added to the data line Ld in the circuit configuration of the pixel PIX depicted in FIG. 6, and it is expressed as C=Cel+Cs+Cp (Cel; a pixel capacitance, Cs; a capacitor capacitance, Cp; a wiring parasitic capacitance). It is to be noted that the detection voltage Vdac is defined as a voltage value satisfying conditions in the following Expression (12).

$$\begin{matrix}Vdac := V 1 - Δ V \times ( {n}_{d} - 1 ) \\ {V}_{0} - Vdac - Vth\_max > 0\end{matrix} \} \qquad ( 12 )$$

In Expression (12), Vth_max represents a compensation limit value of the threshold voltage Vth of the transistor Tr13. Here, n_{d} is defined as initial digital data (digital data required to specify the detection voltage Vdac) input to the DAC 42 in the DAC/ADC circuit 144 of the data driver 140, and an arbitrary value satisfying the conditions in Expression (12) is selected from 1 to 1023 as d when the digital data n_{d} consists of 10 bits. Moreover, ΔV is defined as a bit width (a voltage width corresponding to 1 bit) of the digital data, and it is represented like the following Expression (13) when the digital data n_{d} consists of 10 bits.

$$Δ V := \frac{{V}_{1} - {V}_{1023}}{1022} \qquad ( 13 )$$

Further, in Expression (11), the data line voltage Vd (the data line detection voltage Vmeas(t)), a convergence value V₀−Vth of the data line voltage Vd and a parameter β/C comprising the current gain β and a sum total C of the capacitance components are defined as represented by the following Expressions (14) and (15).

Here, a digital output (detection data) from the ADC 43 with respect to the data line voltage Vd (the data line detection voltage Vmeas(t)) at the relaxation time t is defined as nₘₑₐₛ(t), and digital data of the threshold voltage Vth is defined as nₜₕ.

$$\begin{matrix}\begin{matrix}{V}_{meas} := V 1 - Δ V \times ( {n}_{meas} - 1 ) \\ {V}_{0} - Vth := V 1 - Δ V \times ( {n}_{th} - 1 )\end{matrix} \} & ( 14 ) \\ ξ := ( β / C ) \cdot Δ V & ( 15 )\end{matrix}$$

Furthermore, based on the definitions represented by Expressions (14) and (15), when Expression (11) is substituted by a relationship between actual digital data (image data) n_{d} input to the DAC 42 and digital data (detection data) nₘₑₐₛ(t) subjected to analog-digital conversion by the ADC 43 to be actually output in the DAC/ADC circuit 144 of the data driver 140, the following Expression (16) can be obtained.

$${n}_{meas} ( t ) = {n}_{th} + \frac{{n}_{d} - {n}_{th}}{ξ \cdot t \cdot ( {n}_{d} - {n}_{th} ) + 1} \qquad ( 16 )$$

In Expressions (15) and (16), ξ is a digital representation of the parameter β/C in an analog value, and ξ·t is nondimensional. Here, it is determined that a threshold voltage Vth₀ on an initial stage that a fluctuation (Vth shift) does not occur in the threshold voltage Vth of the transistor Tr13 is approximately 1 V. At this time, when two different relaxation times t=t₁ and t₂ are set to satisfy the condition ξ·t (n_{d}−nₜₕ)>>1, a compensation voltage component (an offset voltage) Voffset(t₀) associated with a fluctuation in threshold voltage of the transistor Tr13 can be expressed by the following Expression (17).

$${V}_{offset} ( {t}_{0} ) = \frac{Δ V}{ξ \cdot {t}_{0}} = Δ V \cdot ( {n}_{1} - {n}_{2} ) \cdot \frac{{t}_{2} \cdot {t}_{1}}{{t}_{2} - {t}_{1}} \cdot \frac{1}{{t}_{0}} \qquad ( 17 )$$

In Expression (17), each of n₁ and n₂ is digital data (detection data) nₘₑₐₛ(t) output from the ADC 43 when the relaxation time t is set to t₁ or t₂ in Expression (16). Moreover, based on Expressions (16) and (17), the digital data nₜₕ of the threshold voltage Vth of the transistor Vth can be represented like the following Expression (18) by using digital data nₘₑₐₛ(t₀) output from the ADC 43 at the relaxation time t=t₀. Additionally, digital data digital Voffset of the offset voltage Voffset can be presented like the following Expression (19). In Expressions 8) and (19), <ξ> is an average value of all pixels of ξ that is a digital value of the parameter β/C. Here, in regard to <ξ>, a fractional part is not taken into consideration.

$$\begin{matrix}{n}_{th} = {n}_{meas} ( {t}_{0} ) - \frac{1}{〈 ξ 〉 \cdot {t}_{0}} & ( 18 ) \\ \frac{1}{〈 ξ 〉 \cdot {t}_{0}} = digital {V}_{offset} & ( 19 )\end{matrix}$$

Therefore, according to Expression (18), nₜₕ that, is digital data (correction data) used to correct the threshold voltage Vth can be obtained for all pixels.

Further, a variation in the current gain β can be represented like the following Expression (20) by solving Expression (16) in regard to ξ based on digital data (detection data) nₘₑₐₛ(t₃) output from the ADC 43 when the relaxation t is set to t₃. Here, t₃ is set to a time that is sufficiently shorter than t₀, t₁ and t₂ used in Expressions (17) and (18).

$$ξ \cdot {t}_{3} = \frac{{n}_{d} - {n}_{meas} ( {t}_{3} )}{[ {n}_{meas} ( {t}_{3} ) - {n}_{th} ] \cdot [ {n}_{d} - {n}_{th} ]} \qquad ( 20 )$$

When attention is paid to ξ in Expression (20) to design the display panel (a light-emitting panel) in such a manner that sum totals C of capacitance components of the respective data lines Ld become equal and a bit width ΔV of the digital data is previously determined as represented by Expression (13), ΔV and C in Expression (15) that determines ξ become constants.

Furthermore, assuming that desired set values of ξ and β are ξtyp and βtyp, a multiplication correction value Δξ that is used to correct a variation in ξ of the light-emitting drive circuit DC of each pixel in the display panel 110, i.e., digital data (correction data) Δβ that is used to correct a variation in the current gain β can be defined like the following Expression (21) if a square term of the variation is ignored.

$$\begin{matrix}Δξ := 1 - \frac{ξ - {ξ}_{typ}}{2 ξ} \\ = 1 - \frac{β - {β}_{typ}}{2 β} = Δβ\end{matrix} \qquad ( 21 )$$

Therefore, the correction data nₜₕ (a first characteristic parameter) that is used to correct a fluctuation in the threshold voltage Vth and the correction data Δβ (a second characteristic parameter) that is used to correct a variation in the current gain β in the light-emitting drive circuit DC can be obtained by detecting the data line voltage Vd (the data line detection voltage Vmeas(t)) more than once while changing the relaxation time t in the series of autozero method based on Expressions (18) and (21).

It is to be noted that the processing for acquiring the correction data nₜₕ and Δβ is executed by the correction data acquiring function circuit 156 of such a controller 150a as depicted in FIG. 5.

Subsequently, in such a controller 150a as depicted in FIG. 5, based on the correction data nth and Δβ calculated by Expressions (18) and (21), a series of arithmetic processing described below are executed with respect to specific image data supplied from the outside (which will be referred to as “luminance measurement digital data” for convenience's at image data) n_{d} to generate luminance measurement image data n_{d}_{_{—}}_{brt}, and the generated data is input to the data driver 140 to subject the display panel 110 (the pixel PIX) to voltage drive.

As a generation method for the luminance measurement image data n_{d}_{_{—}}_{brt}, specifically, variation correction for the current gain β (Δβ multiplication correction) and fluctuation correction for the threshold voltage Vth (nₜₕ addition correction) are executed with respect to the luminance measurement digital data n_{d}.

First, the multiplication function circuit 153a of the controller 150 multiplies the digital data n_{d} by the correction data Δβ required to correct a variation in the current gain β (n_{d}×Δβ).

Then, the addition function circuit 154a adds the correction data nₜₕ required to correct a fluctuation in the threshold voltage Vth to the multiplied digital data (n_{d}×Δβ) ((n_{d}×Δβ)+nₜₕ).

Further, the digital data ((n_{d}×Δβ)+nₜₕ) subjected to the correction processing is supplied as the luminance measurement image data n_{d}_{_{—}}_{brt} to the data register circuit 142 of the data driver 110.

The data driver 140 uses the DAC 42 of the DAC/ADC circuit 144 to convert the luminance measurement image data n_{d}_{_{—}}_{brt} fetched to the data register circuit 142 into an analog signal voltage.

Here, as shown in FIG. 4, since input and output characteristics (conversion characteristics) of the DAC 12 and the ADC 43 are set to become equal to each other, a luminance measurement gradation voltage (a second voltage) V_{brt} generated by the DAC 42 is defined like the following Expression (22) based on the definition shown in Expression (14). This gradation voltage is supplied to the pixel PIX through the data line Ld.

V_{brt}=V₁−ΔV(n_{brt}−1)) (22)

When the luminance measurement gradation voltage V_{brt} is generated by executing a series of correction processing with respect to specific image data and the generated voltage is written into the display panel 110, a current value of a light-emitting drive current Iem flowing through the organic EL element OEL from the light-emitting drive circuit DC of each pixel PIX can be set to a fixed value without being affected by a variation in the current gain β with respect to the set value or a fluctuation in the threshold voltage Vth of the drive transistor. Furthermore, in such a state, the display panel 110 is operated to emit light, whereby a light-emitting luminance Lv (cd/m²) of each pixel PIX is measured.

Here, as the luminance measuring method for each pixel PIX, the following technique can be applied, for example.

That is, as an example of the luminance measuring method for each pixel PIX, each pixel PIX arranged on the display panel 110 is concurrently operated to emit light in a luminance gradation associated with the luminance measurement gradation voltage V_{brt}.

Then, as shown in FIG. 5, a luminance meter or the CCD camera 160 arranged on an exit face side of the display panel 110 from which light emitted by each pixel PIX exits to the outside is used to take an image of the display panel 110. Here, as the luminance meter or the CCD camera 160, one having a higher resolution than a size of each pixel PIX arranged on the display panel 110 is used. Moreover, a region corresponding to each pixel PIX obtained from an acquired image signal is associated with luminance data output from the luminance meter or the CCD camera 160. Additionally, when a predetermined number of pieces of luminance data are extracted from a high-luminance side in pieces of luminance data corresponding to the respective pixel PIX regions and an average value of luminance values of such pieces of data is calculated, the light-emitting luminance (a luminance value) Lv in each pixel PIX is determined.

Here, assuming that η is a light-emitting current efficiency of the organic EL element OEL, the following expression can be achieved.

η=(luminance)÷(current density)

Therefore, if a current value of the light-emitting drive current flowing through each pixel PIX is fixed, a variation in the light-emitting luminance in the display panel 110 with respect to the set value can be regarded as a variation in the light-emitting current efficiency η.

Furthermore, assuming that desired set values of the light-emitting luminance Lv and the light-emitting current efficiency η Lv_{typ} and η_{typ}, a multiplication correction value ΔLv required to correct a variation in the light-emitting luminance Lv of each pixel PIX in the display panel 110, i.e., digital data (correction data; a third characteristic parameter) Δη required to correct a variation in the light-emitting current efficiency η can be defined like the following Expression (23) if a square term of the variation is ignored.

Therefore, the correction data Δη of the light-emitting current efficiency η can be obtained based on the light-emitting luminance Lv measured in regard to each pixel PIX as described above.

Here, the arithmetic processing for the correction data Δη required to correct a variation in the light-emitting luminance Lv shown in Expression (23) is executed based on the same sequence as that of the arithmetic processing for the correction data Δβrequired to correct a variation in the current gain β shown in Expression (21).

$$\begin{matrix}Δ Lv := 1 - \frac{Lv - {Lv}_{typ}}{2 Lv} \\ = 1 - \frac{η - {η}_{typ}}{2 η} = Δη\end{matrix} \qquad ( 23 )$$

Moreover, correction data (a fourth characteristic parameter) Δβ used to correct the variations in both the current gain β and the light-emitting efficiency η is defined like the following Expression (24) by multiplying the pieces of correction data Δβ and Δη obtained from Expressions (21) and (23).

Δβ_{η}:=Δη×Δβ (24)

The pieces of correction data nₜₕ and Δβη calculated by Expressions (18) and (24) are used when correction for a variation in the current gain β (Δβ multiplication correction), correction for a variation in the light-emitting current efficiency η and correction for a fluctuation in the threshold voltage Vth (nₜₕ addition correction) are performed with respect to the image data n_{d} input from the outside of the display apparatus 100 according to this embodiment to generate corrected image data n_{d}_{_{—}}_{comp} in a later-described display operation.

As a result, since the gradation voltage Vdata having an analog voltage value associated with the corrected image data n_{d}_{_{—}}_{comp} is supplied to each pixel PIX from the data driver 140 through the data line Ld, the organic EL element OEL of each pixel PIX can be operated to emit light in a desired luminance gradation with being affected by a variation in the current gain β or the light-emitting current efficiency μ or a fluctuation in the threshold voltage Vth of the drive transistor, thereby realizing a good and uniform light-emitting state.

A characteristic parameter acquiring operation to which the autozero method is applied will now be described in association with an apparatus configuration according to this embodiment.

It is to be noted that a description on operations equivalent to the characteristic parameter acquiring operation will be simplified or omitted in the following explanation.

First, the correction data nₜₕ required to correct a fluctuation in the threshold voltage Vth in the drive transistor in each pixel PIX and the correction data Δβ required to correct a variation in the current gain β in each pixel PIX are acquired.

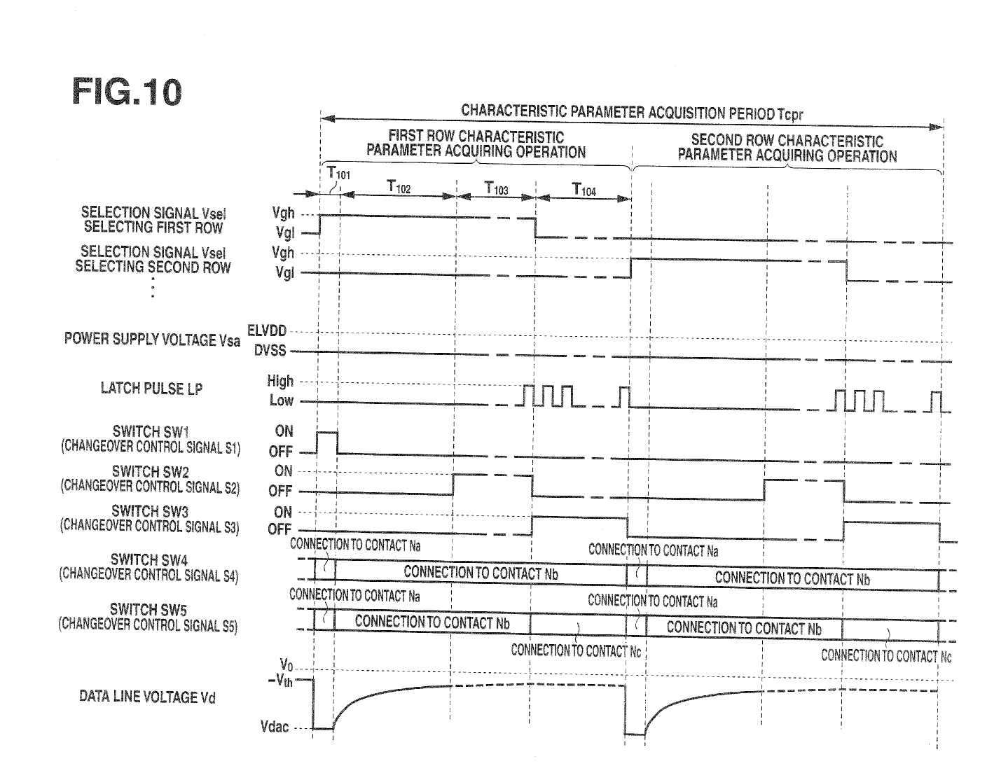

FIG. 10 is a timing chart (part showing a characteristic parameter acquiring operation in the display apparatus according to this embodiment.

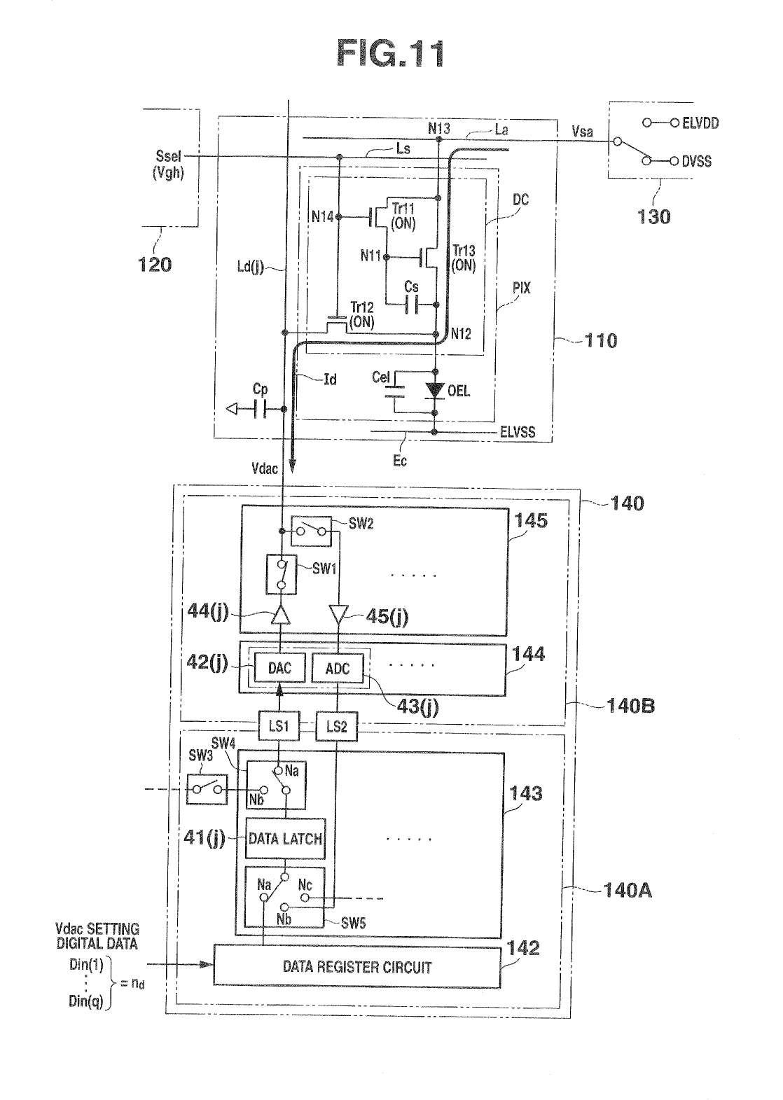

FIG. 11 is an operation conceptual view showing a detection voltage applying operation in the display apparatus according to this embodiment.

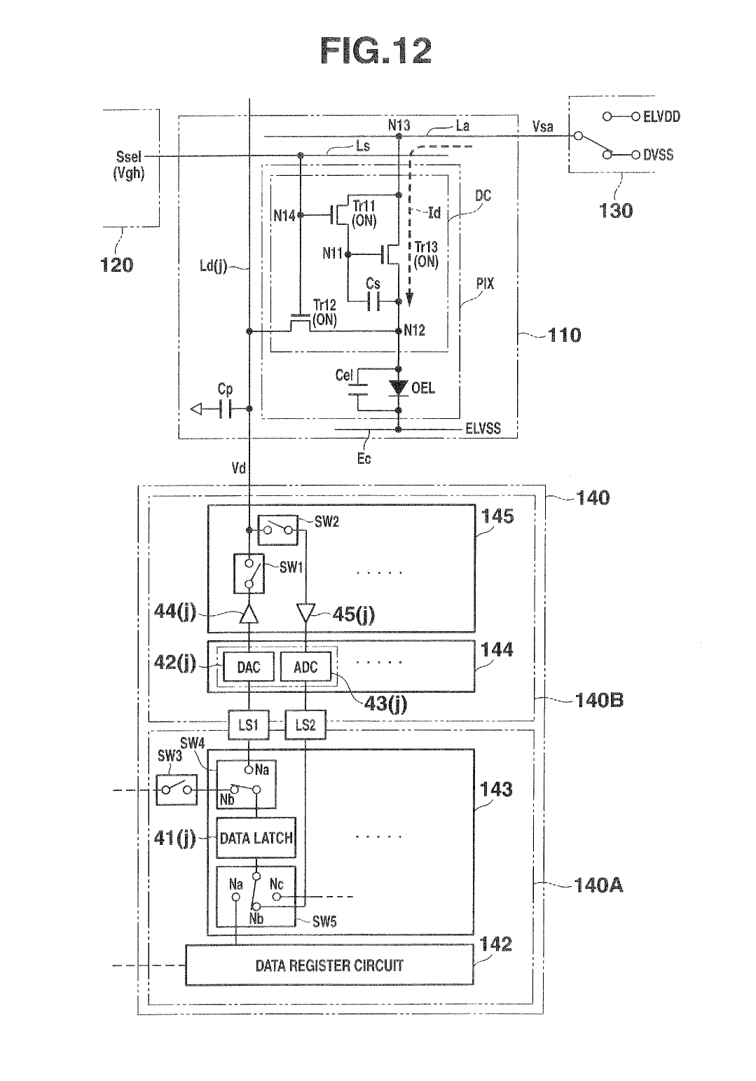

FIG. 12 is an operation conceptual view showing a natural alleviating operation in the display apparatus according to this embodiment.

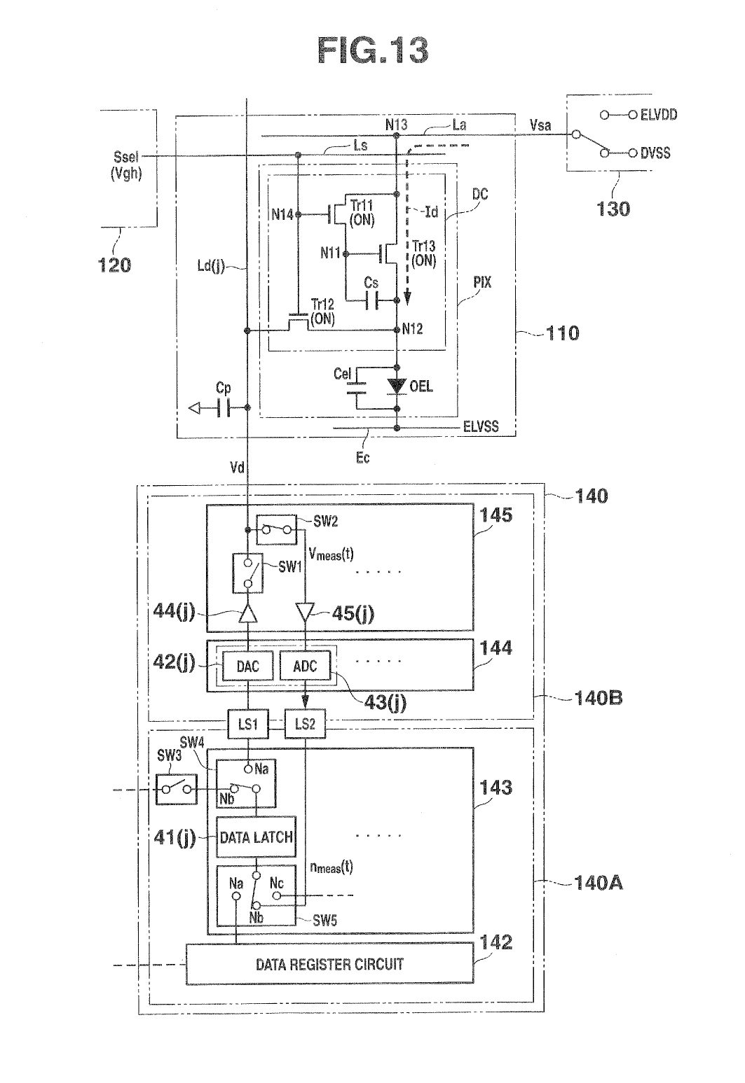

FIG. 13 is an operation conceptual view showing a data line voltage detecting operation in the display apparatus according to this embodiment.

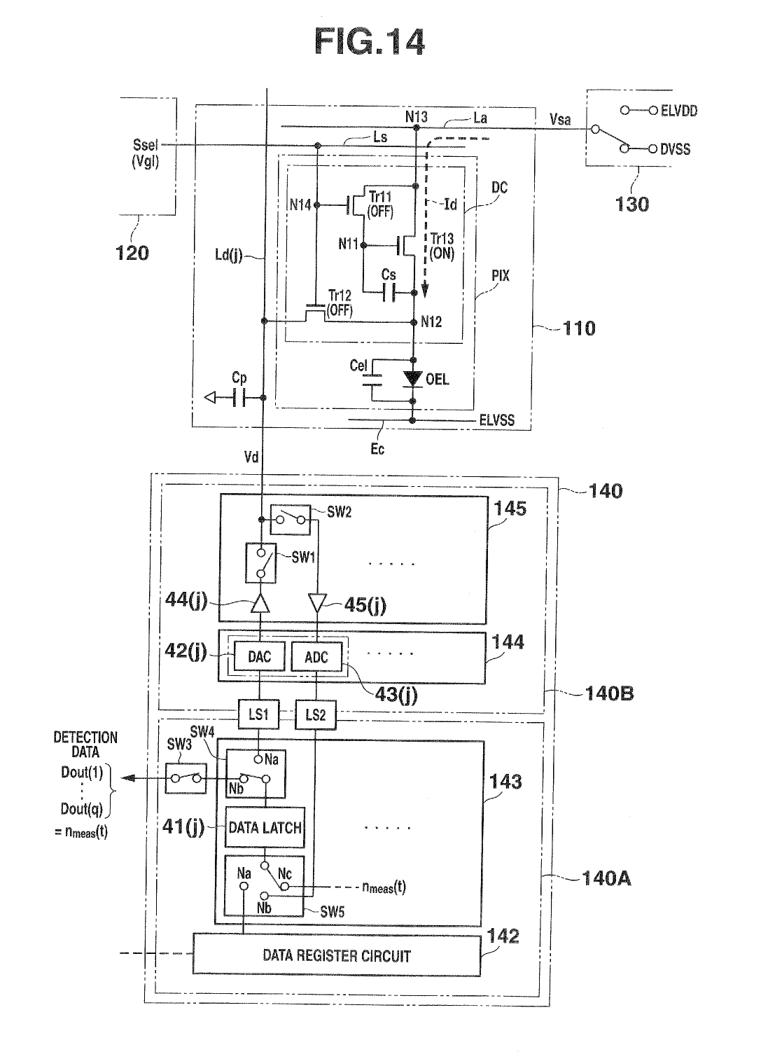

FIG. 14 is an operation conceptual view showing a detection data transmitting operation in the display apparatus according to this embodiment.

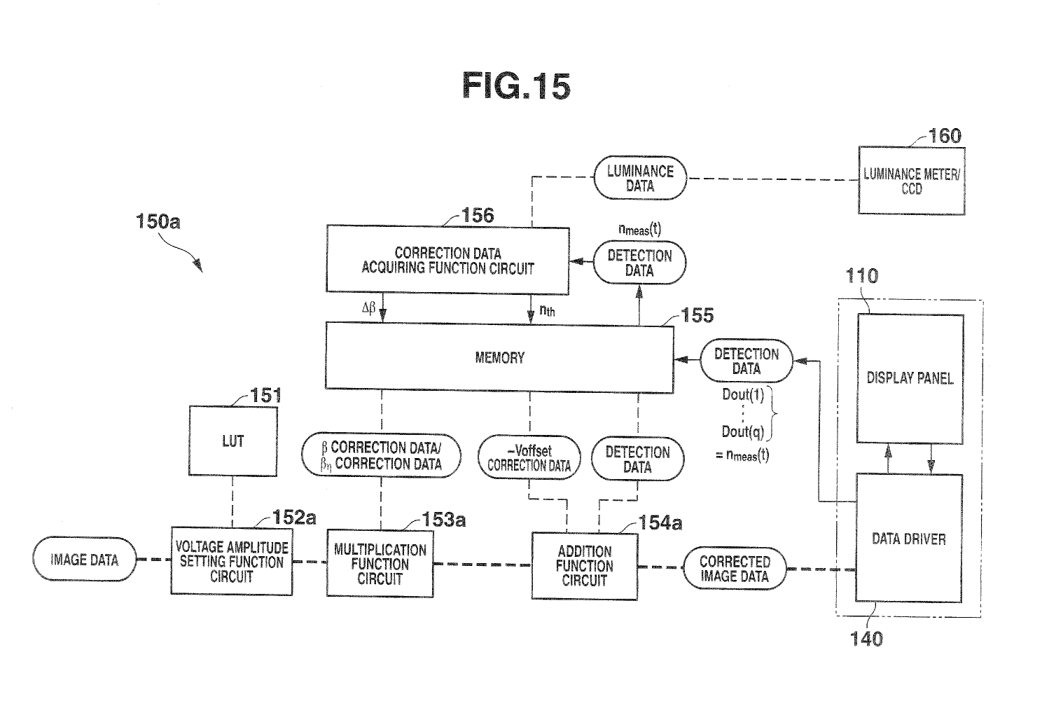

Additionally, FIG. 15 is a functional block diagram showing a correction data calculating operation in the display apparatus according to this embodiment.

Here, in FIGS. 11, 12, 13, and 14, the shift register circuit 141 is omitted as a structure of the data driver 140 on the ground of illustration.

In the characteristic parameter (the pieces of correction data nₜₕ and Δβ) acquiring operation, as shown in FIG. 10, a predetermined characteristic parameter acquisition period Tcrp is set to include a detection voltage application period T₁₀₁, a natural relaxation period T₁₀₂, a data line voltage detection period T₁₀₃ and a detection data transmission period T₁₀₄ in accordance with each pixel PIX in each line.

Here, the natural relaxation period T₁₀₂ corresponds to the relaxation time t. Although FIG. 10 shows an example that the relaxation time t is set to 1 time on the ground of illustration, the relaxation time t is changed to detect the data line voltage Vd (the data line detection voltage Vmeas(t)) more than once in this embodiment as described above. Therefore, in practice, a data line voltage detecting operation (the data line voltage detection period T₁₀₃) and a detection data transmitting operation (the detection data transmission period T₁₀₄) are repeatedly executed in accordance with each different relaxation time t (=t₀, t₁, t₂, or t₃) in the natural relaxation period T₁₀₂.

First, in the detection voltage application period T₁₀₁, the pixel PIX (the pixel PIX in the first line in the drawing) as a characteristic parameter acquiring operation target is set to the selective state as shown in FIG. 10 and FIG. 11. That is, the selection signal Ssel on the selective level (the high level; Vgh) is applied to the selective line Ls connected with this pixel PIX from the selection driver 120, and the power supply voltage Vsa on the low level (the non-light-emitting level; DVSS=the ground potential GND) is applied to the power supply line La from the power supply driver 130.

Further, in this selective state, the switch. SW1 provided to the output circuit 145 of the data driver 140 performs an ON operation based on the changeover control signal S1 supplied from the controller 150a, thereby connecting the data line Ld(j) with the DAC 42(j) of the DAC/ADC 144.

Furthermore, the switch SW2 provided to the output circuit 145 performs an OFF operation based on the changeover control signals S2 and S3 supplied from the controller 150a, and the switch SW3 connected with the contact Nb of the switch SW4 performs the OFF operation.

Moreover, the switch SW4 provided to the data latch circuit 113 is set to be connected to the contact Na based on the changeover control signal S4 fed from the controller 150, and the switch SW5 is set to be connected to the contact Na based on the changeover control signal S5.

Additionally, the digital data n_{d} required to generate the detection voltage Vdac having a predetermined voltage value is sequentially fetched to the data register circuit 142 from the outside of the data driver 140 and held in the data latch 41(j) through the switch SW5 associated with each column.

Thereafter, the digital data n_{d} held in the data latch 41(j) is input to the DAC 42(j) of the DAC/ADC circuit 144 through the switch SW4 to be converted into analog data, and the converted data is applied to the data line Ld(j) of each column as the detection voltage Vdac.

Here, as described above, the detection voltage Vdac is set to a voltage value satisfying the condition of Expression (12). In this embodiment, since the power supply voltage DVSS applied from the power supply driver 130 is set to the ground potential GND, the TO detection voltage Vdac is set to a negative voltage value. It is to be noted that the digital data n_{d} required to generate the detection voltage Vdac is previously stored in a memory provided in, e.g., the controller 150a.

As a result, the transistors Tr11 and Tr12 provided in the light-emitting drive circuit DC configuring the pixel PIX carry out the ON operation, and the power supply voltage Vsa (=GND) on the low level is applied to the gate terminal of the transistor Tr13 and one end side (the connection point N11) of the capacitor Cs through the transistor Tr11.

Further, the detection voltage Vdac applied to the data line Ld(j) is applied to the source terminal of the transistor Tr13 and the other end side (a contact point N12) of the capacitor Cs via the transistor Tr12.

When a potential difference larger than the threshold voltage Vth of the transistor Tr13 is applied to the part between the gate and source terminals (i.e., both the ends of the capacitor Cs) of the transistor Tr13 in this manner, the transistor Tr13 carries out the ON operation, whereby the drain current id associated with this potential difference (the voltage Vgs between the gate and the source) flows.

At this time, since a potential (the detection voltage Vdac) of the source terminal of the transistor Tr13 is set to be lower than a potential (the ground potential GND) at the drain terminal of the same, the drain current Id flows in a direction of the data driver 140 from the power supply voltage line La through the transistor Tr13, the connection point N12, the transistor Tr12 and the data line LOW.

Furthermore, both the ends of the capacitor Cs connected to the part between the gate and the source of the transistor Tr13 are thereby charged with a voltage associated with the potential difference based on the drain current Id.

At this time, since a voltage lower than the voltage ELVES (=GND) applied to the cathode (the common electrode Ec) is applied to the anode (the connection point N12) of the organic EL element OEL, a current does not flow through the organic EL element and this element does not emit light.

Then, during the natural relaxation period T₁₀₂ after the end of the detection voltage application period T₁₀₁, the data line Ld(j) is disconnected from the data driver 140 and output of the detection voltage Vdac from the DAC 44(j) is stopped by turning off the switch SW1 of the data driver 140 based on the changeover control signal S1 fed from the controller 150a in a state that the pixel PIX is held in the selective state as depicted in FIG. 10 and FIG. 12.

Moreover, like the detection voltage application period T₁₀₁, the switches SW2 and SW3 are turned off, the switch SW4 is set to be connected to the contact Nb, and the switch SW5 is set to be connected with the contact Nb.

As a result, since the transistors Tr11 and Tr12 maintain the ON state, in the pixel PIX (the light-emitting drive circuit DC), although an electrical connection state with the data line Ld(j) is maintained, the application of the voltage to the data line Ld(j) is interrupted, and hence the other end side (the connection point N12) of the capacitor Cs is set to the high-impedance state.

During this natural relaxation period T₁₀₂, the transistor Tr13 maintains the ON state by using the voltage with which the capacitor Cs (between the gate and the source of the transistor Tr13) is charged during the detection voltage application period T₁₀₁, whereby flow of the drain current id is continued.

Moreover, the potential on the source terminal side of the transistor Tr13 (the connection point N12; the other end side of the capacitor Cs) gradually increases to approximate the threshold voltage Vth of the transistor Tr13.

As a result, as shown in FIG. 9, the potential in the data line Ld(j) also changes to converge on the threshold voltage Vth of the transistor Tr13.

It is to be noted that, as to the potential of the anode (the connection point N12) of the organic EL element OEL, since a voltage lower than the voltage ELVSS (=GND) applied to the cathode (the common electrode Cc) is applied during this natural relaxation period T₁₀₂, a current does not flow through the organic EL element OEL, and this element does not emit light.

Subsequently, during the data line voltage detection period T₁₀₃, the switch SW2 of the data driver 140 is turned on based on the changeover control signal S2 supplied from the controller 150a in a state that the pixel PIX is maintained in the selective state when the predetermined relaxation time t has elapsed in the natural relaxation period T₁₀₂. At this time, the switches SW1 and SW3 are turned off, the switch SW4 is set to be connected to the contact Nb, and the switch SW5 is set to be connected to the contact Nb.

Consequently, the data line. Ld(j) is connected with the ADC 43(j) of the DAC/ADC 144, and the data lire voltage Vd when the predetermined relaxation time t has elapsed in the natural relaxation period T₁₀₂ is fetched into the ADC 43(j) through the switch SW2 and the buffer 45(j). Here, the data line voltage Vd fetched to the ADO 43(j) corresponds to the data line detection voltage Vmeas(t) shown in Expression (11).

Additionally, the data line detection voltage Vmeas(t) that has been fetched to the ADC 43(j) and consists of an analog signal voltage is converted into detection data nₘₑₐₛ(t) comprising digital data by the ADC 43(j) based on Expression (14), and the converted data is held in the data latch 41(j) via the switch SW5.

Then, during the detection data transmission period T₁₀₄, as shown in FIG. 10 and FIG. 14, the pixel PIX is set to the non-selective state.

That is, the selection signal Ssel on the non-selective level (the low level; Vgl) is applied to the selective line Ls from the selection driver 120. In this non-selective state, the switch SW5 provided to an input stage of the data latch 41(j) of the data driver 140 is set to be connected to the contact Nc and the switch SW4 provided to the output stage of the data latch 41(j) of the same is set to be connected to the contact Nb based on the changeover control signals S4 and S5 fed from the controller 150a. Further, the switch SW3 is turned on based on the changeover control signal S3. At this time, the switches SW1 and SW2 are turned off based on the changeover control signals S1 and S2.

As a result, the data latches 41(j) in columns adjacent to each other are connected in series though the switches SW4 and SW5 and connected to the external controller 150a via the switch SW3.

Furthermore, the pieces of detection data nₘₑₐₛ(t) held in the data latches 41(j+1) (see FIG. 3) in the respective columns are sequentially transfer red to the adjacent data latches 41(j) based on the data latch pulse signal LP supplied from the controller 150a.

As a result, the detection data nₘₑₐₛ(t) of the pixels PIX corresponding to one row is output as serial data, supplied to the controller 150a and stored in a predetermined storage region of the memory 155 provided in the controller 150a in accordance with each pixel PIX as shown in FIG. 15.

Here, since a fluctuation amount of the threshold voltage Vth of the transistor Tr13 provided in the light-emitting drive circuit. DC of each pixel PIX differs depending on, e.g., a drive history (a light emission history) in each pixel PIX and the current gain β also varies with respect to the set value in each pixel PIX, the memory 155 stores the detection data nₘₑₐₛ(t) intrinsic to each pixel PIX.

In this embodiment, the data line voltage detecting operation and the detection data transmitting operation in the series of operations are set to different relaxation times t (=t₀, t₁, t₂, or t₃) to be executed with respect to each pixel PIX more than once. Here, in the operation of detecting a data line voltage at each different relaxation time t, the detection voltage may be applied only once and the data line voltage detecting operation and the detection data transmitting operation may be executed more than once at different timings (the relaxation time t=t₀, t₁, t₂, or t₃) during a period that the natural relaxation continues, or the series of operations, i.e., the application of the detection voltage, the natural relaxation, the data line voltage detection and the detection data transmission may be executed more than once while changing the relaxation time t as described above.

The above-described characteristic parameter acquiring operation for the pixels PIX in the respective rows are repeated, whereby the pieces of detection data nₘₑₐₛ(t) are stored in the memory 155 of the controller 150a with respect to all pixels PIX arranged on the display panel 110.

Then, the operation of calculating the correction data nₜₕ required to correct the threshold voltage Vth of the transistor (the drive transistor) Tr13 of each pixel PIX and the correction data Δβ required to correct the current gain β is executed based on the detection data nₘₑₐₛ(t) of each pixel PIX.

Specifically, as shown in FIG. 15, the detection data nₘₑₐₛ(t) of each pixel PIX stored in the memory 155 is first read to the correction data acquiring function circuit 156 provided to the controller 150a.

Moreover, the correction data acquiring function circuit 156 calculates the correction data nₜₕ (which is specifically the detection data nₘₑₐₙ(t₀) and an offset voltage (−Voffset=−1/ξ·t₀) that specify the correction data nₜₕ) and the correction data Δβ based on Expressions (15) to (21) in accordance with the characteristic parameter acquiring operation using the autozero method. The calculated pieces of correction data nₜₕ and Δβ are stored in a predetermined storage region of the memory 155 in association with each pixel PIX.

Then, the correction data Δη required to correct a variation in the light-emitting current efficiency η in each pixel PIX is acquired by using the pieces of correction data nₜₕ and Δβ.

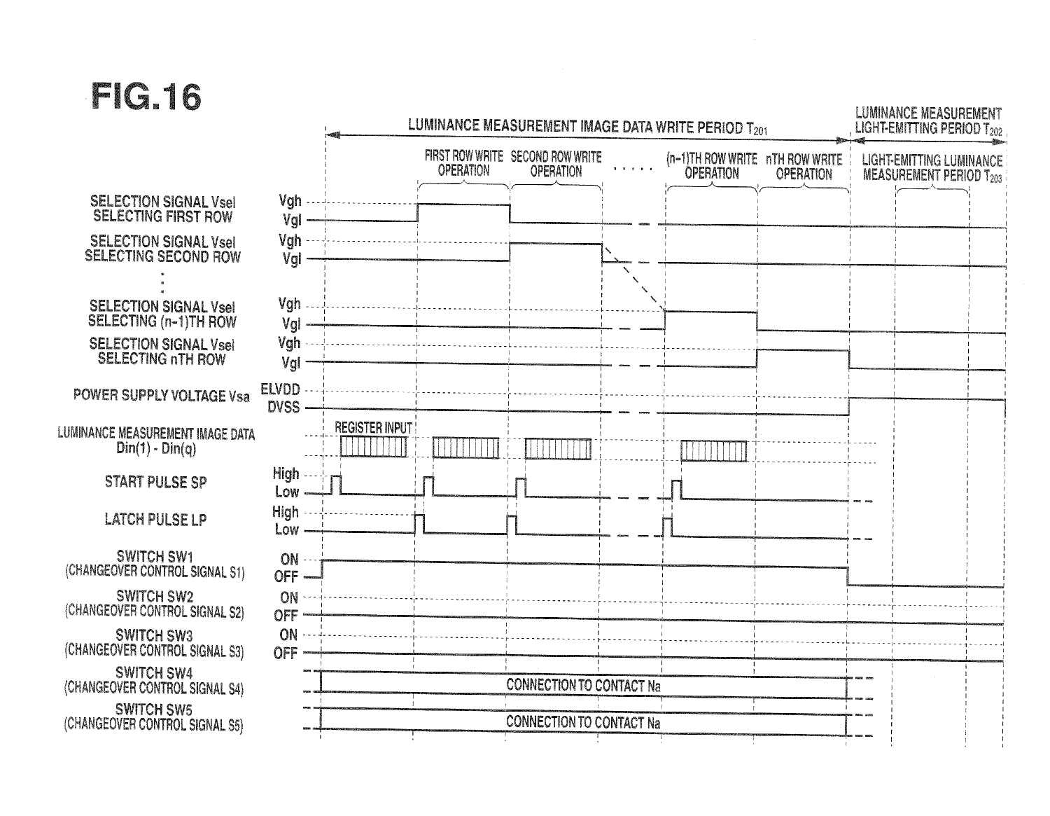

FIG. 16 is a timing chart (part 2) showing the characteristic parameter acquiring operation in the display apparatus according to this embodiment.

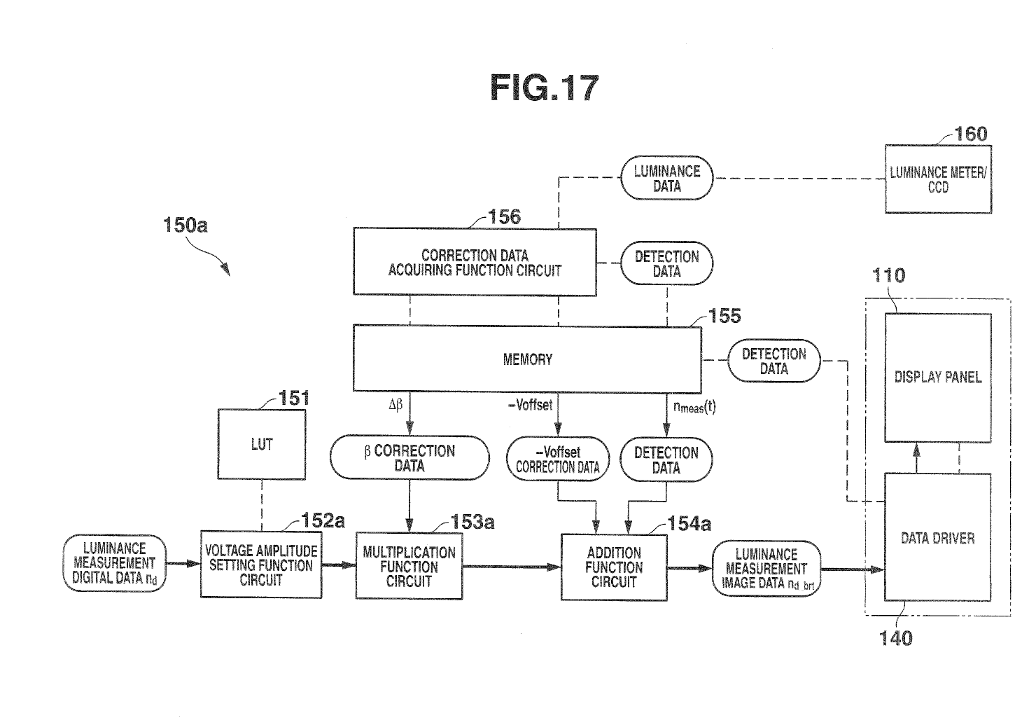

FIG. 17 is a functional block diagram showing a luminance measurement image data generating operation in the display apparatus according to this embodiment.

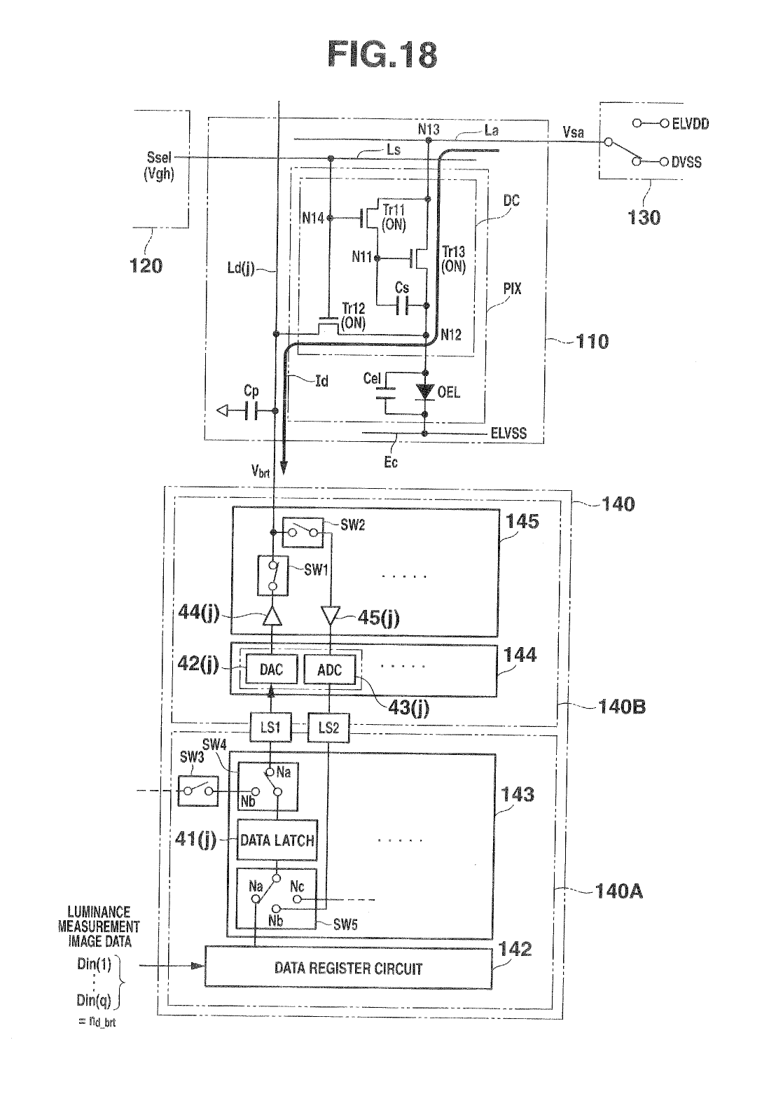

FIG. 18 is an operation conceptual view showing a luminance measurement image data write operation in the display apparatus according to this embodiment.

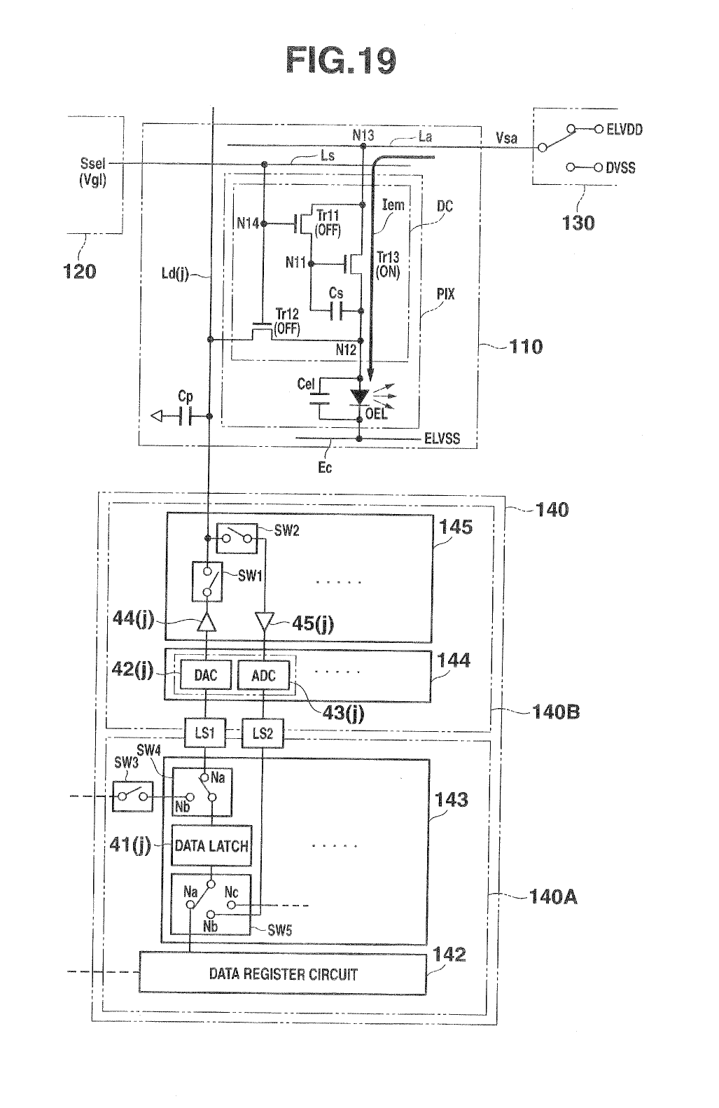

FIG. 19 is an operation conceptual view showing luminance measurement light-e it ing operation in the display apparatus according to this embodiment.

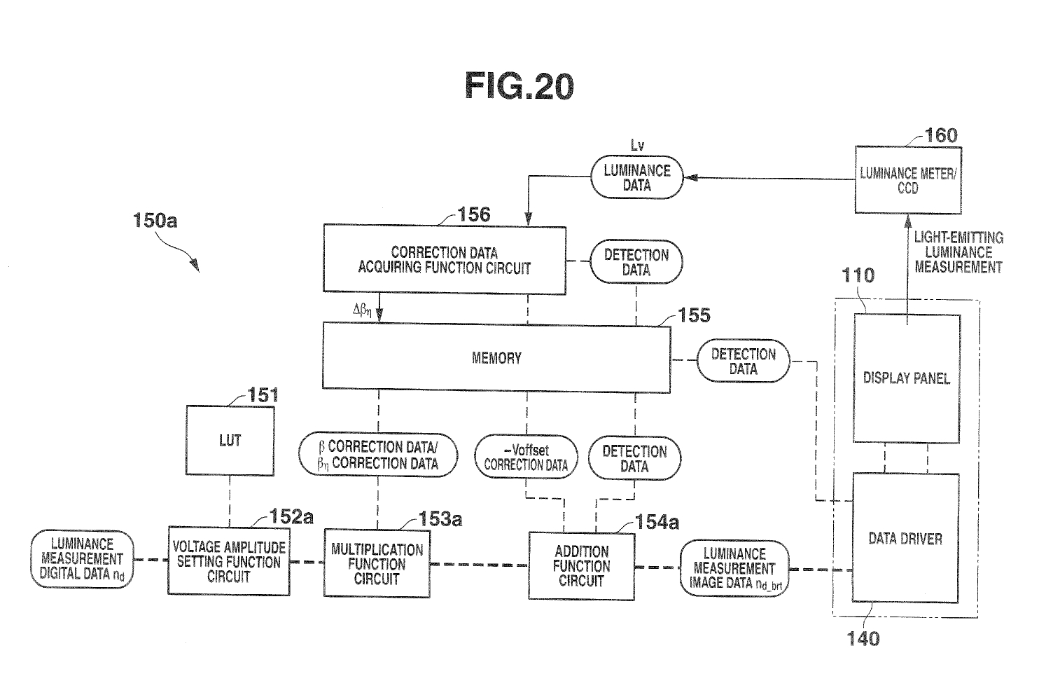

FIG. 20 is a functional block diagram (part 2) showing the correction data calculating operation according to this embodiment.

Here, in FIG. 18 and FIG. 19, the shift register circuit 141 is omitted as a structure of the data driver 140 on the ground of illustration.

As shown in FIG. 16, the characteristic parameter (the correction data Δη) acquiring operation according to this embodiment is set to include a luminance measurement image data write period T₂₀₁ during which luminance measurement image data associated with each pixel PIX in each row is generated and written, a luminance measurement light-emitting period T₂₀₂ during which each pixel PIX is operated to emit light in a luminance gradation associated with the luminance measurement image data and a light-emitting luminance measurement period T₂₀₃ during which a light-emitting luminance of each pixel is measured. Here, the luminance measurement light-emitting period T₂₀₂ includes the light-emitting luminance measurement period T₂₀₃, and the light-emitting luminance measuring operation is executed during the luminance measurement light-emitting period T₂₀₂.

During the luminance measurement image data write period T₂₀₁, the luminance measurement image data generating operation and the luminance measurement image data writ operation for each pixel PIX are executed.

In the luminance measurement image data generating operation, the controller 150a corrects predetermined luminance measurement digital data n_{d} by using the pieces of correction data Δβ and nₜₕ acquired by the characteristic parameter acquiring operation to generate luminance measurement image data n_{d}_{_{—}}_{brt}.

Specifically, as shown in FIG. 17, the correction data Δβ of each pixel stored in the memory 155 of the controller 150a is first read out.

Further, the multiplication function circuit 153a multiplies the digital data n_{d} supplied from the outside of the controller 150a by the read correction data Δβ.

Subsequently, based on Expressions (18) and (19), the detection data nₘₑₐₛ(t₀) and the offset voltage (−Voffset=−1/ξ·t₀) that specify the correction data nₜₕ stored in the memory 155 are read.

Then, the addition function circuit 154a adds the read detection data nₘₑₐₛ(t₀) and offset voltage (−Voffset=−1/ξ·t₀) to the digital data (n_{d}×Δβ) subjected to the multiplication processing. When the above-described correction processing is executed, the luminance measurement image data n_{d}_{_{—}}_{brt} is generated and supplied to the data driver 140.

Furthermore, in the luminance measurement image data write operation with respect to each pixel PIX, like the detection voltage applying operation (the detection voltage application period T₁₀₁), the pixel PIX as a write target is set to the selective state, and the luminance measurement gradation voltage V_{brt} associated with the luminance measurement image data n_{d}_{_{—}}_{brt} is written through the data line Ld(j) in this state.

Specifically, as shown in FIG. 16 and FIG. 18, the selection signal Ssel on the selective level (the high level; Vgh) is first applied to the selective line Ls connected with the corresponding pixel PIX, and the power supply voltage Vsa on the low level (the non-light-emitting level; DVS=the ground potential GND) is applied to the power supply line La.

In this selective state, when the switch SW1 is turned on and the switches SW4 and SW5 are set to be connected to the contact Nb, the luminance measurement image data n_{d}_{_{—}}_{brt} supplied from the controller 150a is sequentially taken into the data register circuit 142 and held in the data latch 41(j) associated with each column.

The held image data n_{d}_{_{—}}_{brt} is converted into analog data by the DAC 42(j) to be applied to the data line Ld(j) of each column as the luminance measurement gradation voltage V_{brt}. Here, as described above, the luminance measurement gradation voltage V_{brt} is set to a voltage value satisfying the condition of Expression (22).

As a result, in the light-emitting drive circuit DC constituting the pixel PIX, the power supply voltage Vsa (=GND) on the low level is applied to the gate terminal of the transistor Tr13 and one end side (the connection point N11) of the capacitor Cs, and the luminance measurement gradation voltage V_{brt} is applied to the source terminal of the transistor Tr13 and the other end side (the connection paint N12) of the capacitor Cs.

Therefore, the drain current Id associated with a potential difference (the voltage Vgs between the gate and the source) produced between the gate and source terminals of the transistor Tr13 flows, and both the ends of the capacitor Cs is charged with a light-emitting voltage (≈V_{brt}) associated with the potential difference based on the drain current Id.

At this time, since the voltage lower than that in the cathode (the common electrode Ec) of the organic EL element OEL is applied to the anode (the connection point N12) of the same, the current does not flow through the organic EL element, and this element does not operate to emit light.

Subsequently, during the luminance measurement light-emitting period T₂₀₂, as shown in FIG. 16, the respective pixels PIX are concurrently operated to emit light in a state that the pixels PIX in the respective rows are set to the non-selective state.

Specifically, as shown in FIG. 19, the selection signal Ssel on the non-selective level (the low level; Vgl) is applied to the selective line Ls connected with all pixels PIX arranged on the display panel 110, and the power supply voltage Vsa on the high level (the light-emitting level; ELVDD>GND) is applied to the power supply line La.

As a result, the transistors Tr11 and Tr12 provided to the light-emitting drive circuits DC of each pixel PIX are turned off, and the light-emitting voltage with which the capacitor Cs connected to the part between the gate and the source of the transistor Tr13 is charged is held.

Therefore, the voltage Vgs between the gate and the source of the transistor Tr13 is held by the light-emitting voltage (≈V_{brt}) with which the capacitor Cs is charged, the transistor Tr13 is turned on to flow the drain current Id, and the potential at the source terminal (the connection point N12) of the transistor Tr13 increases.

Moreover, the potential at the source terminal (the connection point N12) of the transistor Tr13 increases beyond the voltage ELVES (=GND) applied to the cathode (the common electrode Ec) of the organic EL element OEL, and a forward bias is thereby applied to the organic EL element OEL. As a result, the light-emitting drive current Iem flows in a direction of the common electrode Ec from the power supply line La through the transistor Tr13, the connection point N12 and the organic EL element OEL, whereby the organic EL element OEL operates to emit light. Since this light-emitting drive current Iem is specified based on a voltage value of the light-emitting voltage (≈V_{brt}) that has been written in the pixel PIX in the luminance measurement image data write operation and held in the capacitor Cs between the gate and the source of the transistor Tr13, the organic EL element OEL operates to emit light in a luminance gradation associated with the luminance measurement image data n_{d}_{_{—}}_{brt}.

Here, the luminance measurement image data n_{d}_{_{—}}_{brt} is subjected to the correction for a variation in the current gain β and the correction for a fluctuation in the threshold voltage Vth of the drive transistor based on the pieces of correction data Δβ and nₜₕ acquired in association with each pixel in the characteristic parameter acquiring operation.

Therefore, when the luminance measurement image data n_{d}_{_{—}}_{brt} having the same luminance graduation value is written into each pixel PIX, current value of the light-emitting current Iem flowing through the organic EL element OEL from the light-emitting drive circuit DC of each pixel PIX is set to a substantially fixed value without being affected by a variation in the current gain β or a fluctuation in the threshold voltage Vth of the drive transistor.

Subsequently, during the light-emitting luminance measurement period T₂₀₃ set in the luminance measurement light-emitting period T₂₀₂, an operation of measuring a light-emitting luminance of each pixel PIX and an operation of calculating the correction data Δη required to correct the light-emitting current efficiency η of each pixel PIX are executed.

In the light-emitting luminance measuring operation, as shown in FIG. 16 and FIG. 20, the fight-emitting drive current tem having substantially the same current value is set to flow through the organic EL element OEL in each pixel PIX on the display panel 110, and the luminance meter or the CCD camera 160 provided on the exit face side of the display panel 110 is used to measure a light-emitting luminance Lv of each pixel PIX as digital data with the organic EL element OEL of each pixel PIX being operated to emit light. The measured light-emitting luminance Lv is transmitted to the correction data acquiring function circuit 156 of the controller 150a.

In the operation of calculating the correction data Δη, the correction data acquiring function circuit 156 provided to the controller 150a first calculates the correction data Δη based on Expressions (23) and (24) and further calculates correction data Δβ_{η} obtained by adding the correction data Δβ to the correction data Δη. Here, the arithmetic processing for the correction data Δη represented by Expression (23) is executed based on the same sequence as that of the arithmetic processing for the correction data Δβ represented by Expression (21). The calculated correction data Δβ_{η} is stored in a predetermined storage region of the memory 155 in association with each pixel PIX like the detection data nₘₑₐₛ(t) or the correction data nₜₕ.

(Display Operation)

A display operation (a light-emitting operation) of the display apparatus according to this embodiment will now be described.

In the light-emitting operation of the display apparatus, the pieces of correction data nₜₕ and Δβ_{η} are used to correct image data, whereby each pixel PIX is operated to emit light in a desired luminance gradation.

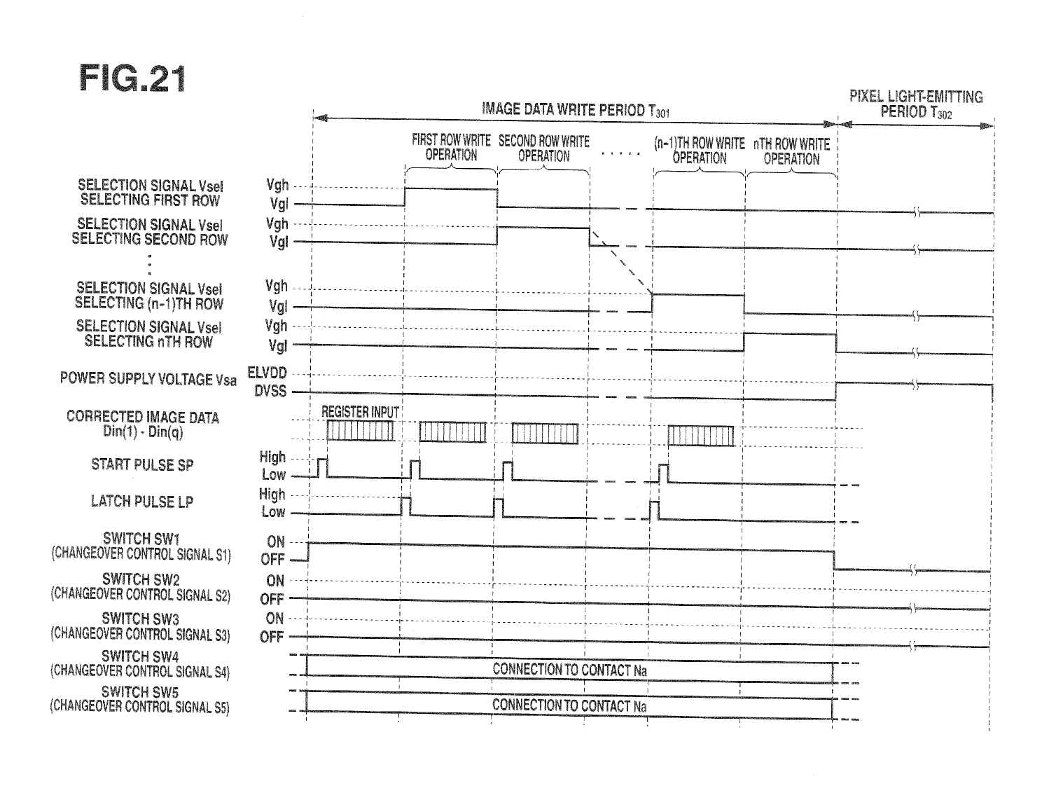

FIG. 21 is a timing chart showing the light-emitting operation in the display apparatus according to this embodiment.

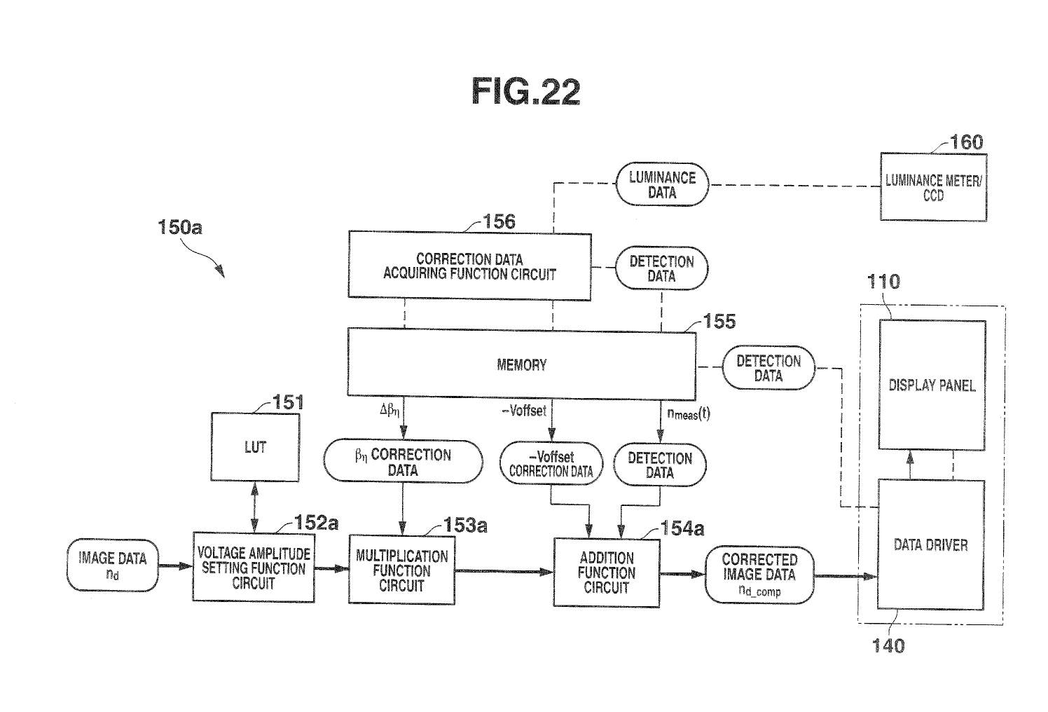

FIG. 22 is a functional block diagram showing an image data correcting operation in the display apparatus according to this embodiment.

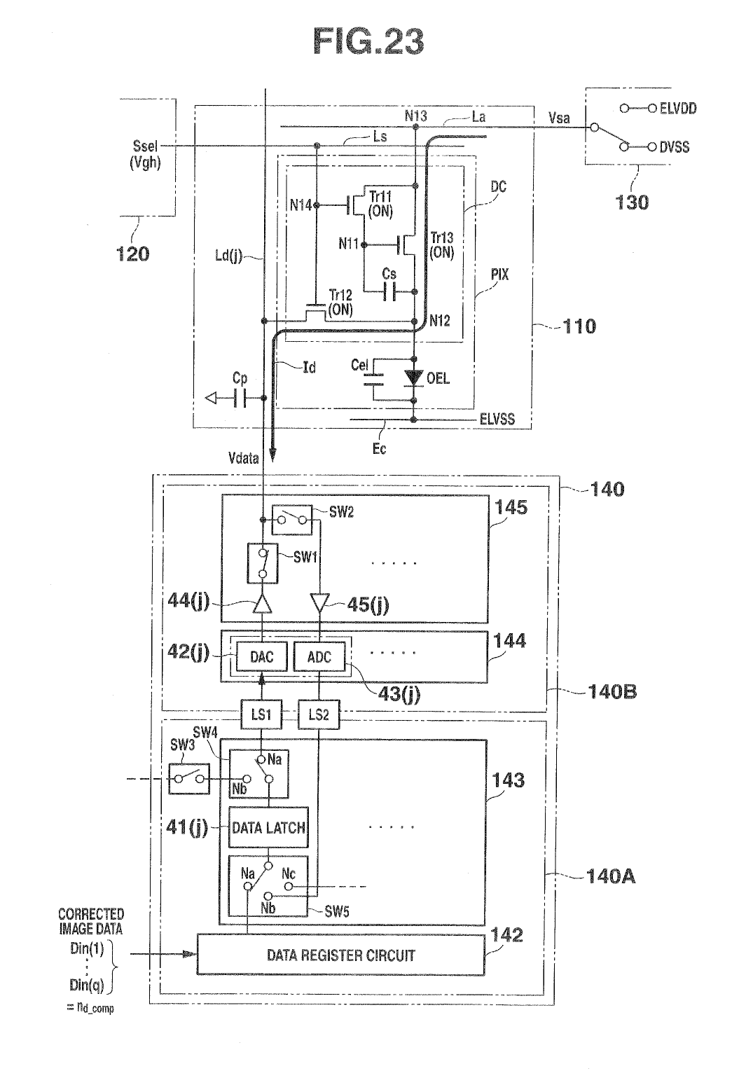

FIG. 23 is an operation conceptual view showing a corrected image data write operation in the display apparatus according to this embodiment.

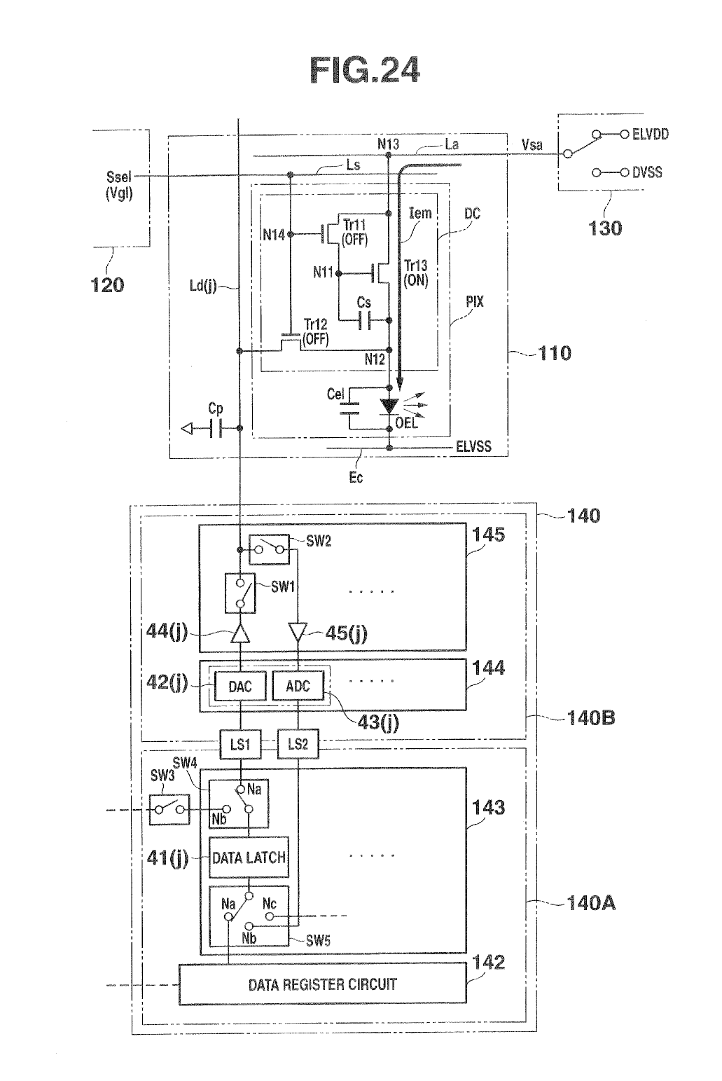

FIG. 24 is an operation conceptual view showing the light-emitting operation in the display apparatus according to this embodiment.

Here, in FIG. 23 and FIG. 24, the shift register circuit 141 is omitted as a structure of the data driver 140 for the convenience of illustration.

As shown in FIG. 21, the display operation according to this embodiment is set to include an image data write period T₃₀₁ during which desired image data is generated and written in accordance with each pixel PIX in each row and a pixel light-emitting period T₃₀₂ during which each pixel PIX is operated to emit light in a luminance gradation associated with the image data.

During the image data write period T₃₀₁, corrected image data generating operation and a corrected image data write operation with respect to each pixel PIX are executed.

In the corrected image data generating operation, the controller 150a corrects predetermined image data n_{d} comprising digital data by using the pieces of correction data Δβ, Δη and nₜₕ acquired by the characteristic parameter acquiring operation and supplies the corrected image data (corrected image data) n_{d}_{_{—}}_{comp} to the data driver 140.

Specifically, as shown in FIG. 22, the voltage amplitude setting function circuit 152a makes reference to the reference table 150 to set a voltage amplitude associated with each color component of RGB with respect to image data (second image data) n_{d} that is supplied from the outside of the controller 150a and includes a luminance gradation value of each color of RGB.

Subsequently, the correction data Δβ_{η} of each pixel stored in the memory 155 is read out, and the multi 1 cation function circuit 153a multiplies the image data n_{d} subjected to voltage setting Lv the read correction data Δβ_{η}.

Then, the detection data nₘₑₐₛ(t₀) and the offset voltage (−Voffset=−1/ξ·t₀) to specify the correction data nₜₕ stored in the memory 155 are read out, and the addition function circuit 154a adds the read detection data nₘₑₐₛ(t₀) and offset voltage (−Voffset=−1/ξ·t₀) to the multiplied digital data (n_{d}×Δβ_{η}).

The corrected image data n_{d}_{_{—}}_{comp} is generated and supplied to the data driver 140 by executing the series of correction processing.

Moreover, in the corrected image data write operation with respect to each pixel PIX, the pixel PIX as a write target is set to the selective state, and a gradation voltage Vdata associated with the corrected image data n_{d}_{_{—}}_{comp} is written through the data line Ld(j) in this state.

Specifically, as shown in FIG. 21 and FIG. 23, the selection signal Ssel on the selective level (the high level; Vgh) is first applied to the selective line Ls connected with the corresponding pixel PIX, and the power supply voltage Vsa on the low level (the non-light-emitting level; DVSS=the ground potential GND) is applied to the power supply line La.

In this selective state, when the switch SW1 is turned on and the switches SW4 and SW5 are set to be connected to the contact Nb, the corrected image data n_{d}_{_{—}}_{comp} supplied from the controller 150a is sequentially taken into the data register circuit 142 and held in the data latch 41(j) associated with each column.

The held image data n_{d}_{_{—}}_{camp} is converted into camp analog data by the DAC 42(j) to be applied to the data line Ld(j) of each column as the gradation voltage (a third voltage) Vdata. Here, the gradation voltage V_{data} is defined like the following Expression (25) based on the definition shown in Expression (14).

Vdata=V₁−ΔV(n_{d}_{_{—}}_{comp}−1)) (25)

As a result, in the light-emitting drive circuit DC constituting the pixel PIX, the power supply voltage Vsa (=GND) on the low level is applied to the gate terminal of the transistor Tr13 and one end side (the connection point N11) of the capacitor Cs, and the gradation voltage Vdata associated with the corrected image data n_{d}_{_{—}}_{comp} is applied to the source terminal of the transistor Tr13 and the other end side (the connection point N12) of the capacitor Cs.

Therefore, the drain current Id associated with a potential difference (the voltage Vgs between the gate and the source) produced between the gate and source terminals of the transistor Tr13 flows, and both the ends of the capacitor Cs is charged with a light-emitting voltage (≈Vdata) associated with the potential difference eased on the drain current Id. At this time, since the voltage lower than that In the cathode (the common electrode Ec) of the organic EL element OEL is applied to the anode (the connection point N12) of the same, the current does not flow through the organic EL element, and this element does not operate to emit light.

Subsequently, as shown in FIG. 21, during the pixel light-emitting period T₃₀₂, the respective pixels PIX are concurrently operated to emit light in a state the pixels PIX in the respective rows are set to the non-selective state.

Specifically, as shown in FIG. 24, the selection signal Ssel on the non-selective level (the low level; Vgl) is applied to the selective line Ls connected with all pixels PIX arranged on the display panel 110, and the power supply voltage Vsa on the high level (the light-emitting level; ELVDD>GND) is applied to the power supply line La.

As a result, the transistors Tr11 and Tr12 provided to the light-emitting drive circuits DC of each pixel PIX are turned off, the light-emitting voltage with which the capacitor Cs connected to the part between the gate and the source of the transistor Tr13 is charged is held.

Therefore, when the drain current Id flows through the transistor Tr13 and the potential at the source terminal (the connection point N12) of the transistor Tr13 increases beyond the voltage ELVSS (=GND) applied to the cathode (the common electrode Ec) of the organic EL element. OEL, the light-emitting drive current Iem flows through the organic EL element OEL from the light-emitting drive circuit DC, and the organic EL element OEL thereby operates to emit light. Since this light-emitting drive current Iem is specified based on a voltage value of the light-emitting voltage (≈Vdata) held between the gate and the source of the transistor Tr13 in the corrected image data write operation, the organic EL element OIL operates to emit light in a luminance gradation associated with the luminance measurement image data n_{d}_{_{—}}_{comp}.

It is to be noted that, in this embodiment, after the end of the luminance measurement image data or corrected image data write operation with respect to the pixel PIX in a specific row (e.g., the first row) and before the end of the image date write operation with respect to the pixels PIX in other rows (the second and subsequent rows), the pixel PIX in this row is set to the retention state in the operation of acquiring the correction data Δη and the display operation as shown in FIG. 16 and FIG. 21.

Here, in the retention state, the selection signal Ssel on the non-selective level is applied to the selective line Ls as the corresponding row to set the pixel PIX to the non-selective state, and the power supply voltage Vsa on the non-light-emitting level is applied to the power supply line La to set the non-light-emitting state.

A set time of this retention state differs depending on each row as depicted in FIG. 16 and FIG. 21.

Additionally, when performing drive control of immediately operating the pixel PIX to emit light after the end of the luminance measurement image data or corrected image data write operation with respect to the pixel PIX on each row, the retention state may not be set.

As described above, the display apparatus (the light-emitting apparatus including the pixel drive apparatus) and its drive control method according to this embodiment have a technique of applying the autozero method intrinsic to the present invention and executing the series of characteristic parameter acquiring operations for taking in the data line voltage and converting this voltage into the detection data comprising digital data at different timings (alleviation times) more than once.

As a result, according to this embodiment, each parameter that corrects a fluctuation in the threshold voltage of the drive transistor of each pixel and a variation in the current gain of each pixel can be acquired and stored. Therefore, according to this embodiment, since the correction processing for compensating a fluctuation in the threshold voltage of each pixel and a variation in the current gain can be performed with respect to image data written into each pixel, the light-emitting element (the organic EL element) can be operated to emit light in a fundamental luminance gradation associated with image data, thereby realizing the active organic EL drive system having good light-emitting characteristics and a homogenous image quality.

Further, this embodiment has a technique of measuring light-emitting luminance of each pixel in a set state that the uniform light-emitting drive current flows through each pixel. As a result, according to this embodiment, a parameter that corrects a variation in the light-emitting current efficiency between the respective pixels can be acquired, and correction data obtained by adding a parameter concerning correction of a variation in the light-emitting current efficiency to a parameter concerning correction of a variation in the current again between the respective pixels can be acquired and stored.

Therefore, according to this embodiment, since the correction processing for compensating a fluctuation in the threshold voltage of each pixel and a variation in the current gain and the light-emitting current efficiency can be performed with respect to the image data written into each pixel, the light-emitting element (the organic EL element) can be operated to emit light in a fundamental luminance gradation associated with image data irrespective of a change in characteristics or a variation in characteristics of each pixel.

Furthermore, as a result, since the processing for calculating correction data required to correct a variation in the current gain including the light-emitting current efficiency and processing for calculating correction data required to compensate a fluctuation in One threshold voltage of the drive transistor can be executed based on the series of sequences in the controller 150a including the single correction data acquiring function circuit 156, individual structures (functional circuits) associated with contents of the correction data calculation processing do not have to be provided, thereby simplifying an apparatus scale of the display apparatus (the light-emitting apparatus).

### Second Embodiment

In the first embodiment, the description has been given as to the situation that a voltage value of the light-emitting voltage with which the capacitor Cs connected to the part between the gate and the source of the drive transistor is charged does not vary depending on the write period and the light-emitting period due to the write operation with respect to the pixel PIX during the image data write period.

However, the voltage value of the light-emitting voltage is actually affected by a change in voltage of each signal line due to capacitance coupling by various parasitic capacitances (capacitance components) other than the capacitor Cs that are added to the drive transistor. As a result, the voltage value of the light-emitting voltage fluctuates depending on the write period and the light-emitting period.

A second embodiment has a configuration to correct such a fluctuation in light-emitting voltage due to a capacitance value of a parasitic capacitance (a capacitance component) added to a drive transistor in addition to the configuration in the first embodiment.

It is to be noted that like reference numerals denote structures equivalent to those in the first embodiment, thereby simplifying or omitting a description thereof.

A display apparatus according to this embodiment roughly includes a configuration equivalent to that of the display apparatus 100 in the first embodiment, and has a display panel 110, a selection driver 120, a power supply driver 130 and a data driver 140 that have configurations equivalent to those in the first embodiment. Moreover, each pixel PIX arranged on the display panel 110 also has a configuration equivalent to that in the first embodiment.

Additionally, a configuration of a controller 150b is partially different from the controller 150a in the first embodiment. Differences from the first embodiment will be mainly described hereinafter.

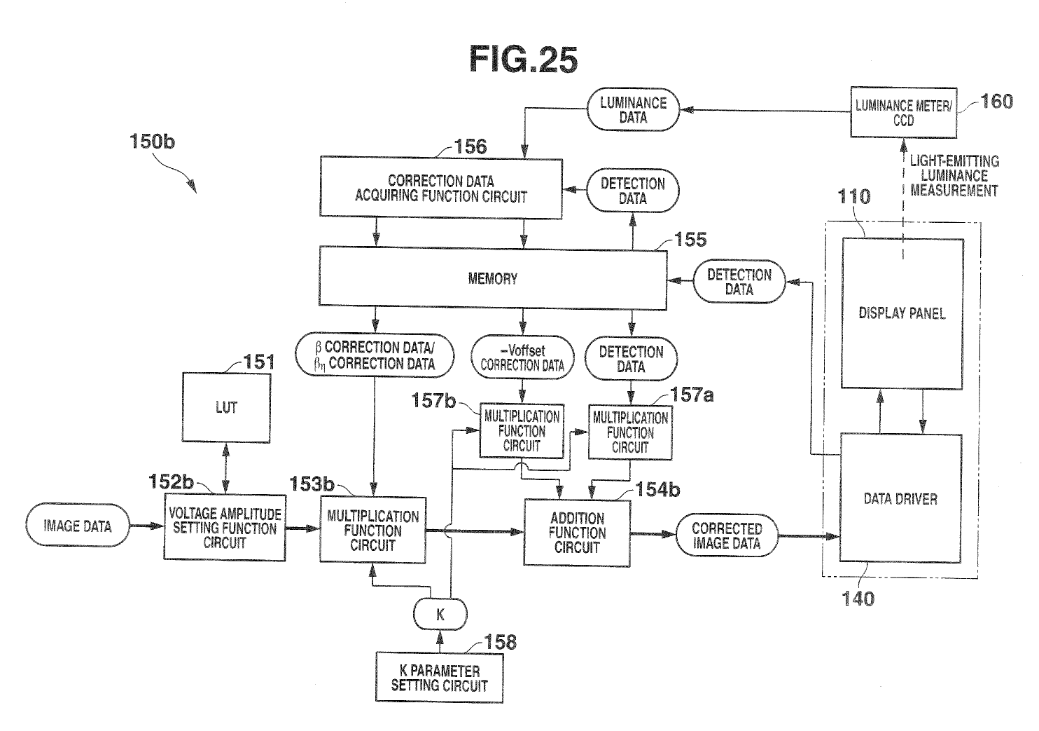

FIG. 25 is a functional block diagram showing functions of the controller applied to the display apparatus according to this embodiment.

As shown in FIG. 25, the controller (an image data correction circuit) 150b in this embodiment roughly has a voltage amplitude setting function circuit (an image data correction circuit) 152b including a reference table (LUT; an intrinsic parameter setting circuit) 151, multiplication function circuits (image data correction circuits) 153b, 157a and 157b, an addition function circuit (an image data correction circuit) 154b, a memory (a storage circuit) 155, a correction data acquiring function circuit characteristic parameter acquisition circuit) 156 and a K parameter setting circuit (an intrinsic parameter setting circuit) 138.

The configuration depicted in FIG. 25 further includes multiplication function circuits (image data correction circuits) 157a and 157b and a K parameter setting circuit (an intrinsic parameter setting circuit) 158 with respect to the configuration depicted in FIG. 5 in the first embodiment.

Further, functions of the voltage amplitude setting function circuit 152b, the multiplication function circuit 153b and the addition function circuit 154b are partially different from functions of the voltage amplitude setting function circuit 152a, the multiplication function circuit 153a and the addition function circuit 154a in the first embodiment.

The voltage amplitude setting function circuit 152b makes reference to the reference table 151 with respect to image data comprising digital data supplied from the outside to convert a voltage amplitude associated with each color, i.e., red (R), green (G) or blue (5). A maximum value of the voltage amplitude of the image data converted by the voltage amplitude setting function circuit 152b is set to be equal to or below a value obtained by subtracting a correct on amount based on a characteristic parameter of each pixel from a maximum value of an input range of the PAC 42, here, as the reference table 151 referred to by the voltage amplitude setting function circuit 152b, as will be described later, a conversion table (a gamma table) is previously set to correct a fluctuation in light-emitting voltage due to a parasitic capacitance (a capacitance component) added to a drive transistor provided to each pixel PIX. It is to be noted that the conversion table set as the reference table 151 will be described later in detail.

Moreover, the voltage switch setting function circuit 152b has a through function or an alternative path for outputting input digital data as it is. Additionally, at the time of a characteristic parameter acquiring operation to which a later-described autozero method is applied, input digital data is set to be output as it is without effecting voltage amplitude conversion processing using the reference table 151.

The multiplication function circuit 153b multiplies image data by correction data Δβ of a current gain β obtained based on detection data concerning a change in characteristics of each pixel PIX or correction data Δβ_{η} of the current gain β including a correction component Δη of a light-emitting current efficiency η based on luminance data Lv detected in regard to each pixel PIX and a parameter K required to correct a fluctuation in a light-emitting voltage Vel defined based on a parasitic capacitance added to the drive transistor of each pixel PIX.

The multiplication function circuit 157a multiplies the detection data concerning a change in characteristics of each pixel PIX by a parameter K required no correct a fluctuation in light-emitting voltage Vel in an organic EL element OEL of each pixel PIX.

The multiplication function circuit 157b multiplies a compensation voltage component (an offset voltage) of a threshold voltage Vth of the drive transistor obtained based on the detection data concerning a change in characteristics of each pixel PIX by the parameter K of each pixel PIX.

The addition function circuit 154b adds the detection data concerning a change in characteristics of each pixel PIX and the compensation voltage component (an offset voltage) of the threshold voltage Vth multiplied by the parameter K in the multiplication function circuits 157a ad 157b to the image data multiplied by the correction data Δβ or Δβ_{η} in the multiplication function circuit 153b to effect correction. Additionally, this corrected image data is supplied to the data drier 140 as corrected image data.

The memory 155 stores the detection data of each pixel PIX transmitted from the data driver 140 and the correction data acquired by the correction data acquiring function circuit 156 in association with each pixel PIX.

At the time of the addition processing in the addition function circuit 154b and the correction data acquisition processing in the correction data acquiring function circuit 156, the addition function circuit 154b and the correction data acquiring function circuit 156 read out the detection data from the memory 155.

The K parameter setting circuit 158 sets predetermined constant for the parameter K required to correct a fluctuation in light-emitting voltage due to a parasitic capacitance (a capacitance component) added to the drive transistor provided to each pixel PIX in accordance with an operating state of the controller 150b.

The K parameter setting circuit 158 sets the parameter K to 1.0 at the time of the later-described characteristic parameter acquiring operation to which the autozero method is applied. As a result, the multiplication function circuit 153b and the addition function circuit 154b execute the multiplying correction and the adding correction with respect to the image data (or digital data) without substantially adding the correction using the parameter K.

Further, the K parameter setting circuit 158 sets the parameter K to, e.g., 1.1 at the time of image information display operation based on the image data. As a result, the multiplication function circuit 153b and the addition function circuit 154b execute the multiplying correction and the adding correction affected by the parasitic capacitance with respect to the image data (or digital data).

Here, a value of the parameter K set by the K parameter setting circuit 158 can be previously calculated based on a capacitance value of the parasitic capacitance added to the drive transistor on a design stage of the display panel 110 or each pixel PIX, and it is appropriately changed and set in accordance with an operating state of the controller 150b.

It is to be noted that, in the controller 150b depicted in FIG. 5, the correction data acquiring function circuit 156 may be an arithmetic apparatus provided to the outside of the controller 150b.

Furthermore, in the controller 150b depicted in FIG. 5, individual memories may be used as the memory 155 as long as they store the detection data and the correction data in association with each pixel PIX.

Moreover, the memories 155 may be storage apparatuses provided outside the controller 150b.

Additionally, the image data supplied to the controller 150b is obtained by extracting a luminance gradation signal component from a video signal and forming the luminance gradation signal component as serial data comprising a digital signal in accordance with each row in the display panel 110.

Description will now be given as to a relationship between a voltage between an anode and a cathode (a voltage at both ends of the organic. EL element OEL; a light-emitting voltage Veil of the organic EL element. OEL and a current (a light-emitting drive current Iel) flowing through the organic EL element OEL from the light-emitting drive circuit DC when t image data is written into the pixel PIX including a light-emitting drive circuit DC having the same configuration as that depicted in FIG. 6 and then the organic EL element OEL is operated to emit light.

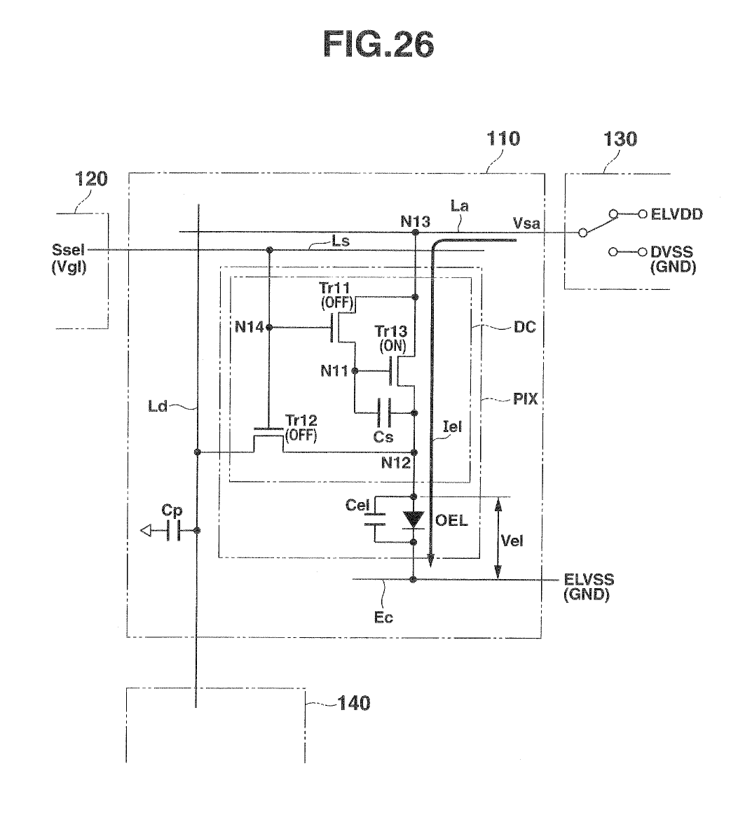

FIG. 26 is an operating state diagram at the time of light emission of the organic EL element in a pixel to which the light-emitting drive circuit according to this embodiment is applied; and

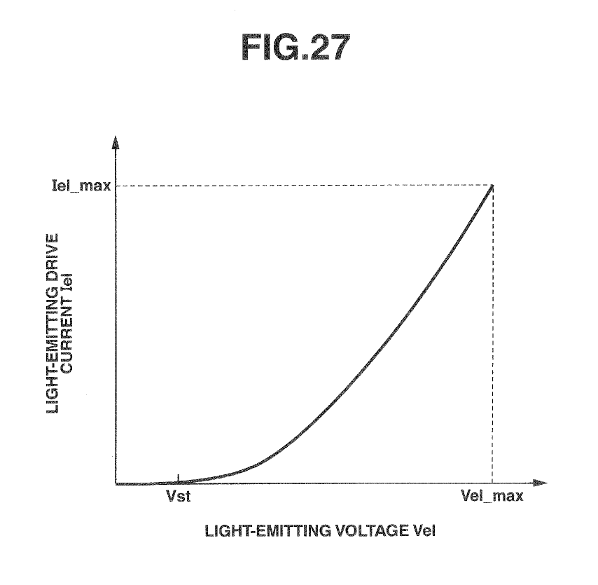

FIG. 27 is a characteristic view showing a relationship between a light-emitting voltage of the organic EL element and a light-emitting drive current at the time of a light-emitting operation in the pixel according to this embodiment.

In the light-emitting operation of the organic EL element of the pixel PIX according to this embodiment, as shown in FIG. 26, when a selection signal Ssel on a non-selective level (a low level; Vgl) is applied from the selection driver 120 via a selective lone Ls, the pixel PIX is set to the non-selective state.

At this time, transistors Tr11 and Tr12 of the light-emitting drive circuit DC are turned off, a part between gate and drain terminals of a transistor Tr13 is electrically interrupted, and a source terminal (a connection point N12) of the same is electrically disconnected from a data line Ld.

Further, in this non-selective state, a power supply voltage Vsa (=ELVDD) on the light-emitting level is applied to the pixel PIX from the power supply driver 130 through the power supply line La.

As a result, a voltage (a voltage Vgs between the gate and the source of the transistor Tr13) with which a capacitor Cs is charged by writing the image data (a gradation voltage Vdata) is maintained, and the power supply voltage ELVDD whose potential is higher than that at the source terminal (the connection point N12) is applied to a drain terminal (a connection point N13) of the transistor Tr13.

Therefore, as shown in FIG. 26, a light-emitting drive current Iel associated with the voltage Vgs between the gate and the source of the transistor Tr13 flows through the organic EL element OEL via the power supply line La and the transistor Tr13 from the power supply driver 130.

Circuit characteristics in the pixel PIX (the light-emitting drive circuit DC and the organic EL element OEL) in this case will now be verified.

At the time of an image data (a gradation voltage) write operation that is equal to the configuration shown in FIG. 7, a current value of a drain current (i.e., a write current) flowing through the part between the drain and the source of the transistor Tr13 is determined based on v voltage between the connection points N11 and N12 (i.e., the voltage Vgs between the gate and the source of the transistor Tr13 and the voltage at both the ends of the capacitor Cs) of the light-emitting drive circuit DC. It is ideal for this voltage between the connection points N11 and N12 to be held in the capacitor Cs as it is even in the light-emitting operation after the end of the write operation.

However, the pixel PIX to which the light-emitting drive circuit DC according to this embodiment is applied is controlled to be driven in such a manner that a potential of the selection signal Ssel applied to the selective line Ls or a potential of the power supply voltage Vsa applied to the power supply line La changes when shifting to the light-emitting operation from the write operation. That is, the potential of the selection signal Ssel changes from Vgh to Vgl, and the potential of the power supply voltage Vsa changes from DVSS to ELVDD.

Therefore, the voltage between the connection points N11 and N12 is affected by these changes in potential due to capacitance coupling through the parasitic capacitance present in the light-emitting drive circuit DC.

Moreover, in the pixel PIX (the light-emitting drive circuit DC) according to this embodiment, the transistor Tr12 is turned off and the application of the gradation voltage Vdata to the connection point N12 (the source terminal of the transistor Tr13) is interrupted when shifting to the light-emitting operation from the write operation.

Additionally, the light-emitting drive current Iel flows through the organic EL element OEL via the connection point N12 at the time of the light-emitting operation. As a result, when the potential at the connection point N12 fluctuates, the voltage between the connection points N11 and N12 is affected by this fluctuation in potential at the connection point N12.

Such a fluctuation in the voltage Vgs between the gate and the source (the voltage between the connection points N11 and N12) of the transistor Tr13 means that the light-emitting drive current Iel flowing through the organic EL element OEL is fluctuated through the part between the drain and the source of the transistor Tr13. In other words, this fluctuation means that a current value of the light-emitting drive current Iel may be affected by a value of the voltage at both the ends of the organic EL element OEL (the light-emitting voltage Vel) that concerns a potential at the connection point N12 in some cases.

It is to be noted that, even when a potential at the connection point N12 fluctuates at the time of the light-emitting operation in the light-emitting drive circuit DC, the voltage Vgs between the gate and the source of the transistor Tr13 (the voltage between the connection points N11 and N12) does not necessarily fluctuates. The above-described fluctuation in the voltage Vgs between the gate and the source of the transistor Tr13 is affected by the voltage Vel at both the ends of the organic EL element OEL only when it is affected by the parasitic capacitance added to the connection point N11 (the gate terminal).

It is to be noted that the light-emitting drive circuit DC according to this embodiment does not adopt the drive control method by which the voltage Vgs between the gate and the source of the transistor Tr13 (the voltage between the connection points N11 and N12) changes at the time of the light-emitting operation in principle.

Here, a description will be given as to a correction method when the light-emitting drive current Tel flowing through the organic EL element OEL is dependent on the light-emitting voltage Vel of the organic EL element OEL according to the above-described circumstances.

First, a parameter (a parameter intrinsic to each pixel) K indicative of an influence of the parasitic capacitance that fluctuates the voltage Vgs between the gate and the source of the transistor Tr13 is defined as represented by the following Expression (22).

$$\begin{matrix}K := \frac{{\sum }_{x} {C}_{N 11 - x}}{{C}_{N 11 - N 12}} \\ x = N 12 , N 13 , N 14\end{matrix} \} \qquad ( 26 )$$

In Expression (22), C_{N11-N12} corresponds to the capacitor Cs connected between the gate and the source. C_{N11-N13} corresponds to a gate capacitance of the transistor Tr11 connected between the gate and the drain of the transistor Tr13. C_{N11-N14} corresponds to a capacitance between the gate and the source of the transistor Tr11 connected to the gate of the transistor Tr13.

Here, it is assumed that the light-emitting drive current Iel flowing through the organic EL element in the pixel PIX in the light-emitting operation state depicted in FIG. 26 has such a relationship as shown in FIG. 27 with respect to the light-emitting voltage Vel.

In FIG. 27, Vst is a light emission start voltage, and Vel_max and Iel_max are a light-emitting voltage and a light-emitting drive current, at a maximum luminance light emission of the pixel PIX, respectively.

As depicted in FIG. 27, a current value of the light-emitting drive current Iel demonstrates substantially linearly increasing characteristics with a rise in the light-emitting voltage Vel when a voltage value of the light-emitting voltage Vel exceeds the light emission start voltage Vst.

Furthermore, when this embodiment has the definition (Expression (26)) and the relationship between the light-emitting voltage Vel and the light-emitting drive current Iel (FIG. 27) described above, the voltage amplitude setting function circuit 152b performs data conversion of adding the parameter K to image data n_{d} comprising digital data input from the outside by making reference to the reference table (LUT) 151.

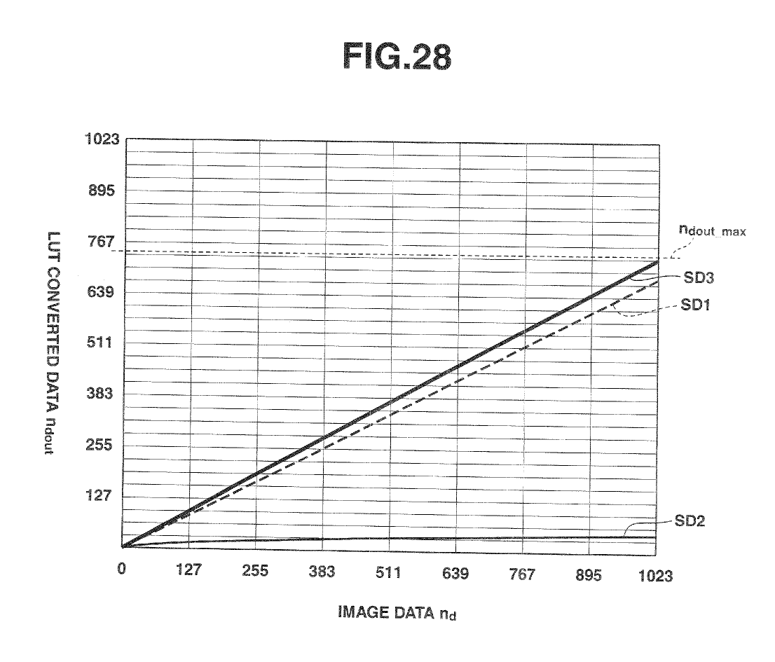

FIG. 28 is a view for explaining data conversion processing in the reference table applied to the controller according to this embodiment.

As shown in FIG. 28, the reference table applied to this embodiment is set in such a manner that converted data (output data) n_{dout} has substantial linearity with respect to input digital data (image data) n_{d}.

Here, in FIG. 28, SEA denotes a characteristic line indicative of conversion characteristics when a fluctuation in the voltage Vgs between the gate and the source of the transistor Tr13 (corresponding to the light-emitting voltage Vel of the organic EL element DEL) due to an influence of the parasitic capacitance is not corrected.

Additionally, SD2 designates a characteristic line indicative of a correction component of the converted data associated with a fluctuation amount of the light-emitting voltage Vel of the organic EL element OEL due to an influence of the parasitic capacitance.

Further, SD3 denotes a characteristic line indicative of conversion characteristics when a fluctuation in the light-emitting voltage Vel of the organic EL element OEL due to an influence of the parasitic capacitance is corrected.

Here, SD3 is corrected to have a data value obtained by adding the correction component indicated by SD2 to the converted data indicated by SD1. Specifically, the input digital data n_{d} is subjected to data conversion processing that adds the parameter K as correction data as represented by the following Expression (27), and it is output as the converted data n_{dout}. Here, ΔV is a voltage range associated with 1 bit in the digital data represented by Expression (13).

$${n}_{d} \to {n}_{d} + \frac{( K - 1 )}{K} \times Δ V \times ( Vel - Vst ) = {n}_{dout} \qquad ( 27 )$$

Further, according to this embodiment, in addition to the data conversion processing that adds the parameter K for the image data n_{d} executed by the voltage amplitude setting function circuit 152b, the multiplication function circuit 153b and the addition function circuit 154b of the controller 150b depicted in FIG. 25 execute correction processing that adds the parameter K.

Here, the parameter K used in the data conversion processing and the correction processing is set to K=1 when acquiring the characteristic parameters (the correction data nₜₕ and Δβ) to which the autozero method is applied. Furthermore, at the time of the characteristic parameter acquiring operation for compensating the later-described light-emitting current efficiency η and the display operation for image information associated with image data executed after the series of characteristic parameter acquiring operations, the parameter K is set to, e.g., K≈1.1.

Subsequently, the correction data nₜₕ obtained by the same characteristic parameter acquiring operation as that in the first embodiment, Δβ and the parameter K that is used to compensate the influence of the parasitic capacitance in the light-emitting operation are used to execute an operation of acquiring a characteristic parameter that is used to compensate the light-emitting current efficiency η in the organic EL element OEL of each pixel PIX.

Here, the controller 150b depicted in FIG. 25 first performs a series of arithmetic processing described below with respect to specific image data supplied from the outside (which will be referred to as “luminance measurement digital data” for the convenience's sake”; first image data) n_{d} based on the correction data nₜₕ and Δβ that are calculated by Expressions (18) and (21) and the parameter K defined by Expression (26), thereby generating luminance measurement image data n_{d}_{_{—}}_{brt}.

Further, this data is input to the data driver 140 to subject the display panel 110 (the pixel PIX) to voltage driving.

The generation of the luminance measurement image data n_{d}_{_{—}}_{brt} as specifically performed by adding a tinge of influence of the parasitic capacitance in light emission of the pixel PIX to the luminance measurement digital data n_{d} and executing setting of a voltage amplitude, correction of a variation in the current gain β (Δβ multiplication correction) and correction of a fluctuation in the threshold voltage Vth (nₜₕ addition correction).

The voltage amplitude setting function circuit 152b of the controller 150b first makes reference to the reference table 151 having such conversion characteristics as depicted in FIG. 28 to perform data conversion processing represented by Expression (27) to the digital data n_{d}, thereby generating converted data n_{dout}.

Then, the multiplication function circuit 153b multiplies the digital data (the converted data) n_{dout} having a set voltage amplitude by the parameter K that is used to correct the influence of the parasitic capacitance and the correction data Δβ that is used to correct a variation in the current gain β (K×n_{dout}×Δβ).

Subsequently, the addition function circuit 154b adds correction data K×nₜₕ (=K×nₘₑₐₛ(t)−K×Voffset) that has been multiplied by the parameter K for correction of the influence of the parasitic capacitance and that is used to correct a fluctuation in the threshold voltage Vth to the digital data (K×n_{dout}×Δβ) subjected to the multiplication processing (K×(n_{dout}×Δβ+nₜₕ)).

It is to be noted that, in the method of generating this luminance measurement image data n_{d}_{_{—}}_{brt} or later-described corrected image data n_{d}_{_{—}}_{comp} in a display operation, the voltage amplitude setting function circuit 152b adds a tinge of influence of the parasitic capacitance of the pixel PIX based on the parameter K and converts the digital data (the image data) n_{d} to correct the light-emitting voltage Vel as the voltage at both the ends of the organic EL element OEL, and then the multiplication function circuit 153b corrects a variation in the current gain β (Δβ multiplication correction). In this case, the parameter K used for the Ve correction itself is subjected to the Δβ multiplication correction.

However, in the explanatory view of the data conversion processing shown in FIG. 28, comparing digital data after the β correction when the tinge of influence of the parasitic capacitance in the pixel PIX is not added (conversion characteristics when the Vel correction is not effected; the characteristic line SD1) with digital data after the β correction when the tinge of influence the parasitic capacitance is added (conversion characteristics when the Vel correction is effected; the characteristic line SD3), an influence of the Vel correction on the β correction can be substantially ignored.

Moreover, the digital data (K×(n_{dout}×Δβ+nₜₕ)) subjected to the correction processing is supplied to the data register circuit 142 of the data driver 140 as the luminance measurement image data n_{d}_{_{—}}_{brt}.

The data driver 110 converts the luminance measurement image data n_{d}_{_{—}}_{brt} taken into the data register circuit 142 into an analog signal voltage by using the DAC 42 of the DAC/ADC circuit 144.

Here, as shown in FIG. 4, since the DAC 42 and the ADC 43 are set to have the same input and output characteristics (the conversion characteristics), a luminance measurement gradation voltage (a second voltage) V_{brt} generated by the DAC 42 is defined like the following Expression (28) based on the definition represented by Expression (14). This gradation voltage V_{brt} is supplied to the pixel PIX through the data line Lb.

V_{brt}=V₁−ΔV(n_{d}_{_{—}}_{brt}−1)) (28)

As described above, when the series of correction processing for specific image data are executed to generate the luminance measurement gradation voltage V_{brt} and write it into the display panel 110, current value of the light-emitting drive current Iel flowing through the organic EL element OEL from the light-emitting drive circuit DC of each pixel PIX can be set constant without being affected by a variation in the current gain β or a fluctuation in the threshold voltage Vth or by the parasitic capacitance when driving the light-emitting drive circuit DC.

Further, in such a state, the display panel 110 is operated to emit light, thereby measuring a light-emitting luminance Lv (cd/m²) of each pixel PIX. Here, as the luminance measuring method for each pixel PIX, the same method as that described in the first embodiment can be applied. Furthermore, as described above, correction data (a fourth characteristic parameter) Δβ_{η} that is used to correct variations in the current gain β and the light-emitting current efficiency η is acquired based on this light-emitting luminance measurement.

The correction data nₜₕ obtained by the characteristic parameter acquiring operation, Δβ_{η} acquired based on the light-emitting luminance measurement and the parameter K are used when performing the setting of the voltage amplitude (the data conversion represented by Expression (23)), the correction of a variation in the current gain β (Δβ multiplication correction), the correction of a variation in the light-emitting current efficiency η (Δη multiplication correction), the correction of a fluctuation in the threshold voltage Vth (nₜₕ addition correction) and the correction of a fluctuation in the light-emitting voltage Vel due to the parasitic capacitance in the pixel PIX (the K multiplication correction) with respect to the image data n_{d} input from the outside of the display apparatus 100 according to this embodiment to generate the corrected image data n_{d}_{_{—}}_{comp} in the later-described display operation.

As a result, since the gradation voltage Vdata having an analog voltage value associated with the corrected image data n_{d}_{_{—}}_{comp} is supplied to each pixel PIX from the data driver 140 through the data line Ld, the organic EL element OEL of each pixel PIX can be operated to emit light in a desired luminance gradation without being affected by a variation in the current gain β or the light-emitting current efficiency η and a fluctuation in the threshold voltage Vth of the drive transistor or in the light-emitting voltage Vel, thus realizing the good a uniform light-emitting state.

The characteristic parameter acquiring operation to which the autozero method is applied will now be described in association with the apparatus configuration according to this embodiment.

It is to be noted that an explanation of an operation equivalent to the characteristic parameter acquiring operation will be simplified or omitted in the following description.

First, the correction data nₜₕ required to correct a fluctuation in the threshold voltage Vth in the drive transistor of each pixel PIX and the correction data Δβ required to correct a variation in the current gain β in each pixel PIX are acquired.

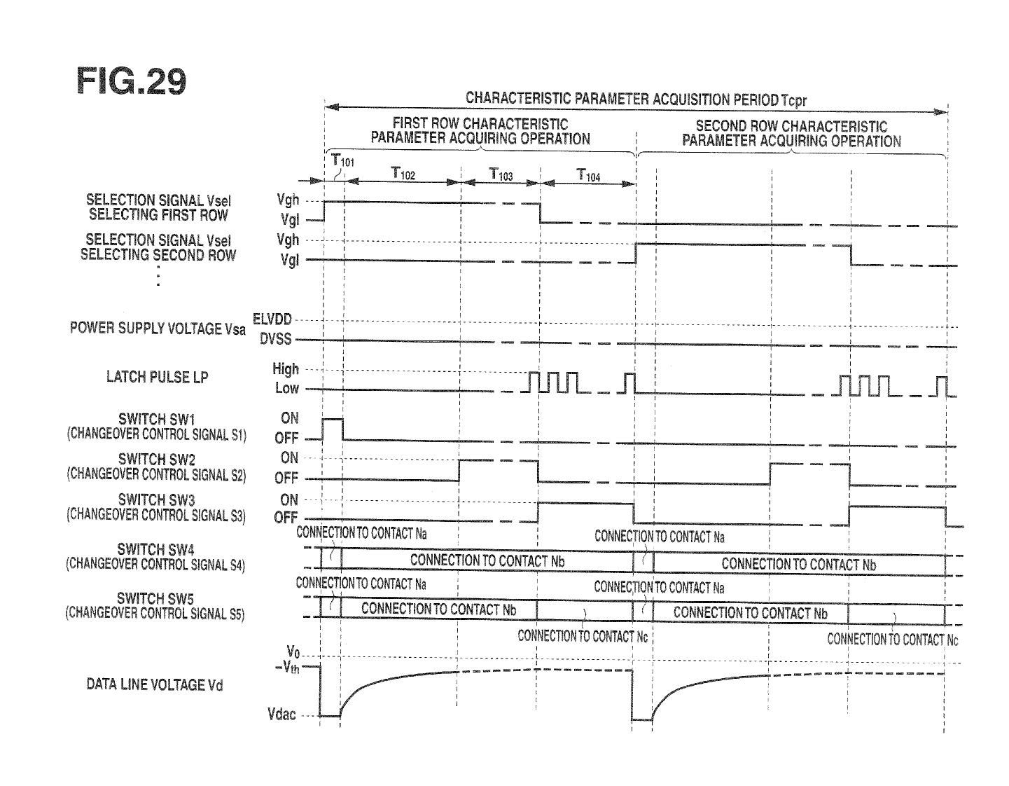

FIG. 29 is a timing chart (part 1) showing the characteristic parameter acquiring operation in the display apparatus according to this embodiment.

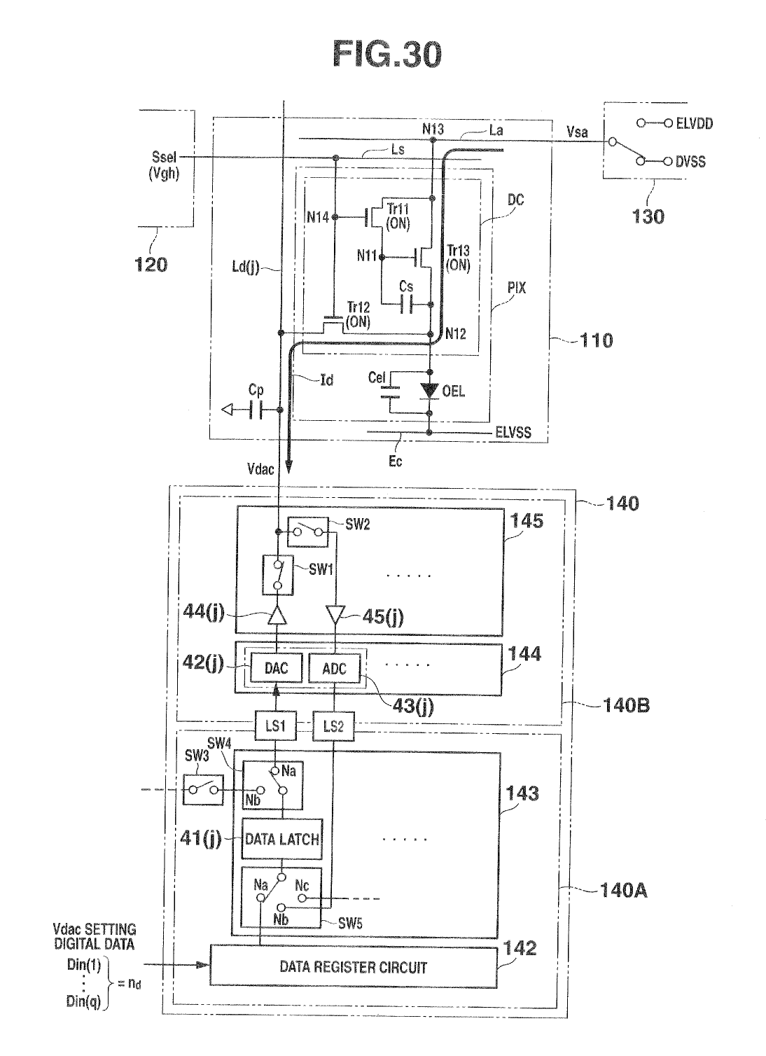

FIG. 30 is an operation conceptual view showing a detection voltage applying operation in the display apparatus according to this embodiment.

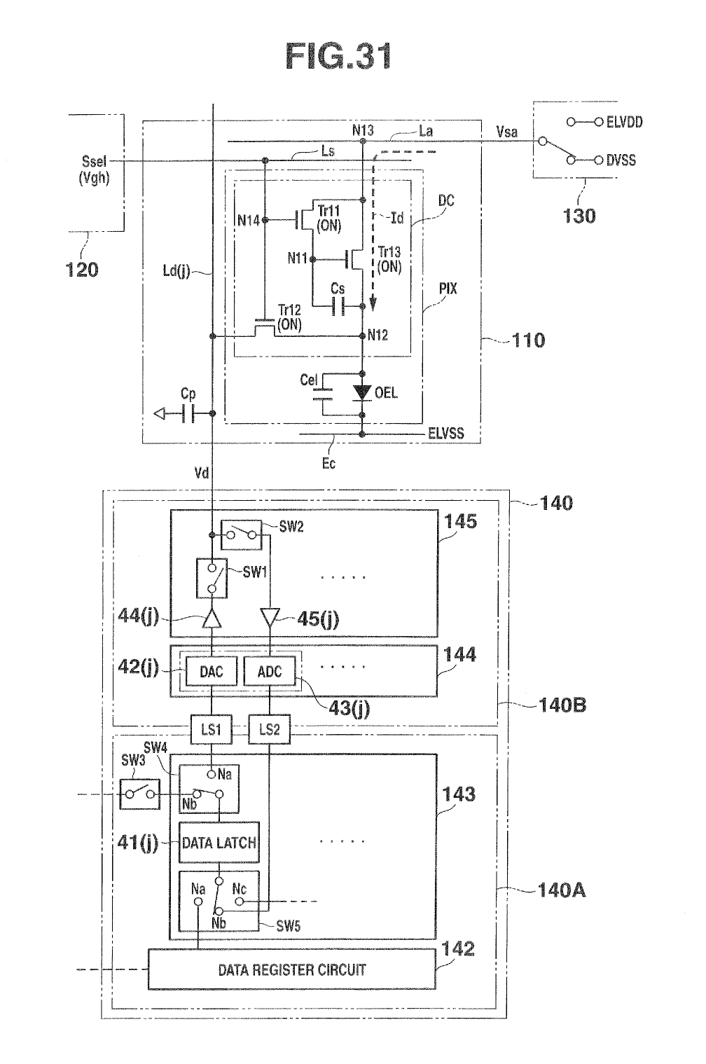

FIG. 31 is an operation conceptual view showing a natural alleviating operation in the display apparatus according to this embodiment.

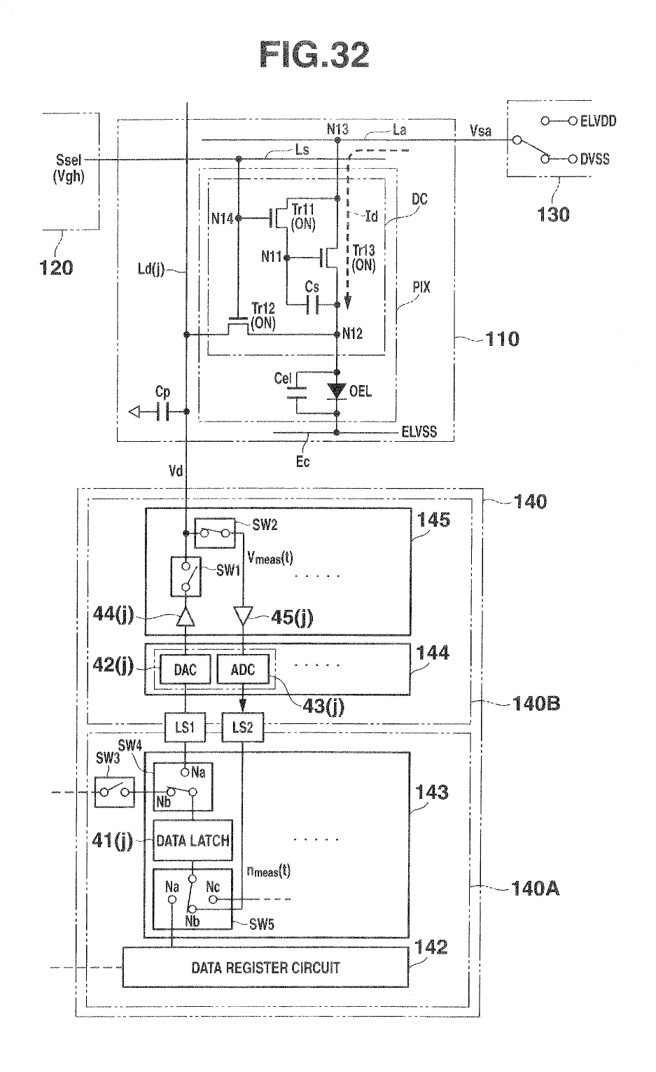

FIG. 32 is an operation conceptual view showing a data line voltage detecting operation in the display apparatus according to this embodiment.

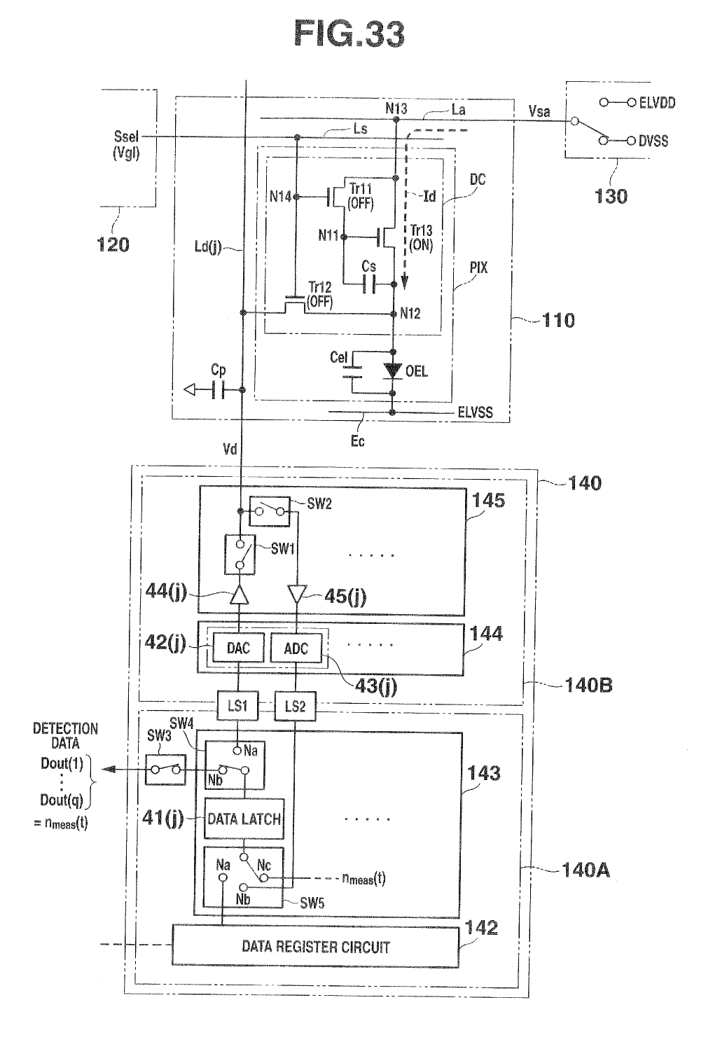

FIG. 33 is an operation conceptual view showing a detection data transmitting operation in the display apparatus according to this embodiment.

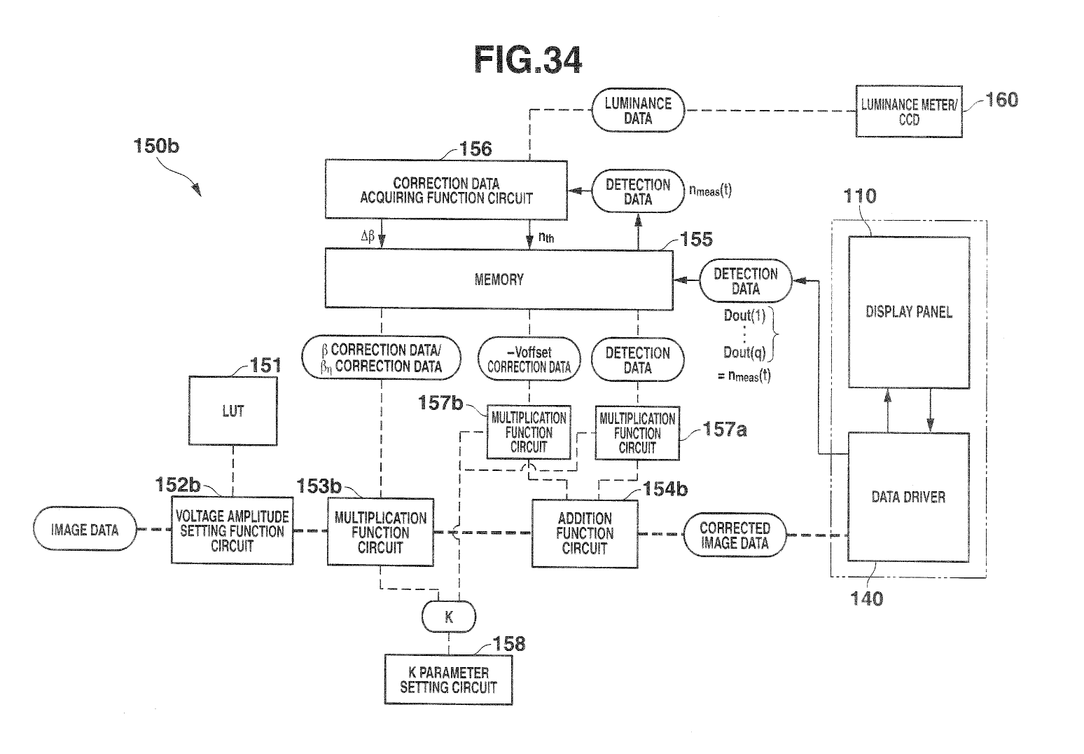

FIG. 34 is a functional block diagram (part 1) showing a correction data calculating operation in the display apparatus according to this embodiment.

Here, in FIGS. 30, 31, 32, and 33, the shift register circuit 141 is omitted as a structure of the data driver 140 for the convenience of illustration.

As shown in FIG. 29, the characteristic parameter (the correction data nₜₕ and Δβ) acquiring opera Lion according to this embodiment includes a detection voltage application period T₁₀₁, a natural relaxation period T₁₀₂, a data line voltage detection period T₁₀₃ and a detection data transmission period T₁₀₄ in a predetermined characteristic parameter acquisition period Tcrp in accordance with each pixel PIX.

Here, the natural relaxation period T₁₀₂ corresponds to the relaxation time t. Although FIG. 29 shows an example that the relaxation time t is set to 1 time on the ground of illustration, in practice, a data line voltage detecting operation (the data line voltage detection period T₁₀₃) and a detection data transmitting operation (the detection data transmission period T₁₀₄) are repeatedly executed in accordance with each different relaxation time t (=t₀, t₁, t₂, or t₃) in the natural relaxation period T₁₀₂.

First, in the detection voltage application period T₁₀₁, the pixel PIX (the pixel PIX in the first row in the drawing) as a characteristic parameter acquiring operation target is set to the selective state as shown in FIG. 29 and FIG. 30. That is, the selection signal Ssel on the selective level (the high level; Vgh) is applied to the selective line Ls connected with this pixel PIX from the selection driver 120, and the power supply voltage Vsa on the low level (the non-light-emitting level; DVSS=the ground potential GND) is applied to the power supply line La from the power supply driver 130.

Further, in this selective state, the switch SW1 provided to the output circuit 145 of the data driver 140 performs an ON operation based on the changeover control signal S1 supplied from the controller 150b, thereby connecting the data lien Ld(j) with the DAT 42(j) of the DAT/ADC 144.

Furthermore, the switch SW2 provided to the output circuit 145 performs an OFF operation based on the changeover control signals S2 and S3 supplied from the controller 150b, and the switch SW3 connected with the contact Nb of the switch SW4 performs the OFF operation.

Moreover, the switch SW4 provided to the data latch circuit 143 is set to be connected to the contact Na based on the changeover control signal S4 fed from the controller 150b, and the switch SW5 is set to be connected to the contact Na based on the changeover control signal S5.

Additionally, the digital data n_{d} required to generate the detection voltage Vdac having a predetermined voltage value is sequentially fetched to the data register circuit 142 from the outside of the data driver 140 and held in the data latch 41(j) through the switch SW5 associated with each column.

Thereafter, the digital data n_{d} held in the data latch 41(j) is input, to the DAC 42(j) of the DAC/ADC circuit 144 through the switch SW4 to be converted into analog data, and the converted data is applied to the data line Ld(j) of each column as the detection voltage Vdac.

Here, the digital data n_{d} required to generate the detection voltage Vdac is generated by performing data conversion and correction processing with respect to specific digital data (image data) for parameter acquisition input from the outside by using the voltage amplitude setting function circuit 152b, the multiplication function circuit 153b and the addition function circuit 154b in the controller 150b.

In this case, the parameter K used for the data conversion processing in the reference table 151 and the correction processing in the multiplication function circuit 153b and the addition function circuit 154b is set to K=1.0 by the K parameter setting circuit 158.

Therefore, in regard to the data conversion processing executed by the voltage amplitude setting function circuit 152b while making reference to the reference table 151, the input digital data is output as it is based on Expression (23), which is substantially equal to skipping or bypassing the voltage amplitude setting function circuit 152b.

Further, the pieces of correction data Δβ and nₜₕ used for the correction processing in the multiplication function circuit 153b and the addition function circuit 154b are not acquired yet, these pieces of data are set to initial values, or the multiplication function circuit 153b and the addition function circuit 154b are set to be skipped, for example.

Therefore, the digital data output from the voltage amplitude setting function circuit 152b is supplied to the data driver 140 as the digital data N_{d} for setting the detection voltage Vdac as it is.

As a result, the transistors Tr11 and Tr12 provided in the light-emitting drive circuit DC configuring the pixel PIX carry out the ON operation, and the power supply voltage Vsa (=GND) on the low level is applied to the gate terminal of the transistor Tr13 and one end side (a connection point N11) of the capacitor Cs through the transistor Tr11. Further, the detection voltage Vdac applied to the data line Ld(j) is applied to the source terminal of the transistor Tr13 and the other end side (a contact point N12) of the capacitor Cs via the transistor Tr12.

When a potential difference larger than the threshold voltage Vth of the transistor Tr13 is applied to the part between the gate and source terminals (i.e., both the ends of the capacitor Cs) of the transistor Tr13 in this manner, the transistor Tr13 carries out the ON operation, whereby the drain current Id associated with this potential difference (the voltage Vgs between the gate and the source) flows.

At this time, since a potential (the detection voltage Vdac) of the source terminal of the transistor Tr13 is set to be lower than a potential (the ground potential GND) at the drain terminal of the same, the drain current Id flows in a direction of the data driver 140 from the power supply voltage line La through the transistor Tr13, the contact point N12, the transistor Tr12 and the data line Ld(j). Furthermore, both the ends of the capacitor Cs connected to the part between the gate and the source of the transistor Tr13 are thereby charged with a voltage associated with the potential difference based on the drain current Id.

At this time, a current does not flow through the organic EL element and this element does not emit light.

Then, during the natural relaxation period T₁₀₂ after the end of the detection voltage application period T₁₀₁, the data line Ld(j) is disconnected from the data driver 140 and output of the detection voltage Vdac from the DAC 44(j) is stopped by turning off the switch SW1 of the data driver 140 based on the changeover control signal S1 fed from the controller 150a in a state that the pixel PIX is held in the selective state: as depicted in FIG. 29 and FIG. 51.

Moreover, like the detection voltage application period. T₁₀₁, the switches SW2 and SW3 are turned off, the switch SW4 is set to be connected to the contact Nb, and the switch SW5 is set to be connected with the contact Nb.

As a result, since the transistors Tr11 and Tr12 maintain the ON state, in the pixel PIX (the light-emitting drive circuit DC), although an electrical connection state with the data line Ld(j) is maintained, the application of the voltage to the data line Ld(j) interrupted, and hence the other end side (the connection point N12) of the capacitor Cs is set to the high-impedance state.

During this natural relaxation period T₁₀₂, the transistor Tr13 maintains the ON state by using the voltage with which the capacitor Cs (between the gate and the source of the transistor Tr13) is charged during the detection voltage application period T₁₀₁, whereby flow of the drain current Id is continued. Moreover, the potential on the source terminal side of the transistor Tr13 (the connection point N12; the other end side of the capacitor Cs) gradually increases to approximate the threshold voltage Vth of the transistor Tr13. As a result, the potential in the data line Ld(j) also changes to converge on the threshold voltage Vth of the transistor Tr13.

It is to be noted that, during this natural relaxation period T₁₀₂, likewise, a current does not flow through the organic EL element OEL, and this element does not emit light.

Subsequently, during the data line voltage detection period T₁₀₃, the switch SW2 of the data driver 140 is turned on based on the changeover control signal S2 supplied from the controller 150b in a state that the pixel PIX is maintained in the selective state when the predetermined relaxation time t has elapsed in the natural relaxation period T₁₀₂. At this time, the switches S1 and SW3 are turned off, the switch SW4 is set to be connected to the contact Nb, and the switch SW5 is set to be connected to the contact Nb.

Consequently, the data line Ld(j) is connected with the ADC 43(j) of the DAC/ADC 144, and the data line voltage VA when the predetermined relaxation time t has elapsed in the natural relaxation period T₁₀₂ is fetched into the ADC 43(j) through the switch SW2 and the buffer 45(j).

Additionally, the data line detection voltage Vmeas(t) that has been fetched to the ADC 43(j) and consists of an analog signal voltage is converted into detection data nₘₑₐₛ(t) comprising digital data by the ADC 43(j) based on Expression (14), and the converted data is held in the data latch 41(j) via the switch SW5.

Then, during the detection data transmission period T₁₀₄, as shown in FIG. 29 and FIG. 33, the pixel PIX is set to the non-selective state.

That is, the selection signal Ssel on the non-selective level (the low level; Vgl) is applied to the selective line Ls from the selection driver 120. In this non-selective state, the switch SW5 provided to an input stage of the data latch 41(j) of the data driver 140 is set to be connected to the contact Nc and the switch SW4 provided to an output stage of the data latch 41(j) of the same is set to be connected to the contact Nb based on the changeover control signals S4 and S5 fed from the controller 150a. Further, the switch SW3 is turned on based on the changeover control signal S3. At this time, the switches SW1 and SW2 are turned off based on the changeover control signals S1 and S2.

As a result, the data latches 41(j) in columns adjacent to each other are connected in series though the switches SW4 and SW5 and connected to the external controller 150b via the switch SW3.

Furthermore, the pieces of detection data nₘₑₐₛ(t) held in the data latches 41(j+1) (see FIG. 3) in the respective columns are sequentially transferred to the adjacent data latches 41(j) based on the data latch pulse signal LP supplied from the controller 150b.

As a result, the detection data nₘₑₐₛ(t) of the pixels PIX corresponding to one row is output as serial data and stored in a predetermined storage region of the memory 155 provided in the controller 150a in accordance with each pixel PIX as shown in FIG. 34.

In this embodiment, the data line voltage detecting operation and the detection data transmitting operation in the series of operations are set to different relaxation times t (=t₀, t₁, t₂, or t₃) to be executed with respect to each pixel PIX more than once. Here, in the operation of detecting a data line voltage at each different relaxation time t, the detection voltage may be applied only once and the data line voltage detecting operation and the detection data transmitting operation may be executed more than once at different timings (the relaxation time t (=t₀, t₁, t₂, or t₃) during a period that the natural relaxation continues, or the series of operations, i.e., the application of the detection voltage, the natural relaxation, the data line voltage detection and the detection data transmission may be executed more than once while changing the relaxation time t as described above.

The above-described characteristic parameter acquiring operation for the pixels PIX in the respective rows are repeated, whereby the pieces of detection data nₘₑₐₛ(t) are stored in the memory 155 of the controller 150b with respect to all pixels PIX arranged on the display panel 110.

Then, the operation of calculating the correction data nₜₕ required to correct the threshold voltage Vth of the transistor (the drive transistor) Tr13 of each pixel PIX and the correction data Δβ required to correct the current gain β is executed based on the detection data nₘₑₐₛ(t) of each pixel PIX.

Specifically, as shown in FIG. 34, the detection data nₘₑₐₛ(t) associated with each pixel PIX stored in the memory 155 is first read to the correction data acquiring function circuit 156 provided to the controller 150b.

Moreover, the correction data acquiring function circuit 156 calculates the correction data nₜₕ (which is specifically the detection data nₘₑₐₙ(t₀) and an offset voltage (−Voffset=−1/ξ·t₀) that specify the correction data nₜₕ) and the correction data Δβ based on Expressions (15) to (21) in accordance with the characteristic parameter acquiring operation using the autozero method. The calculated pieces of correction data nₜₕ and Δβ are stored in a predetermined storage region of the memory 155 in association with each pixel PIX.

Then, the correction data Δη required to correct a variation in the light-emitting current efficiency η in each pixel PIX is acquired by using the pieces of correction data nₜₕ and Δβ.

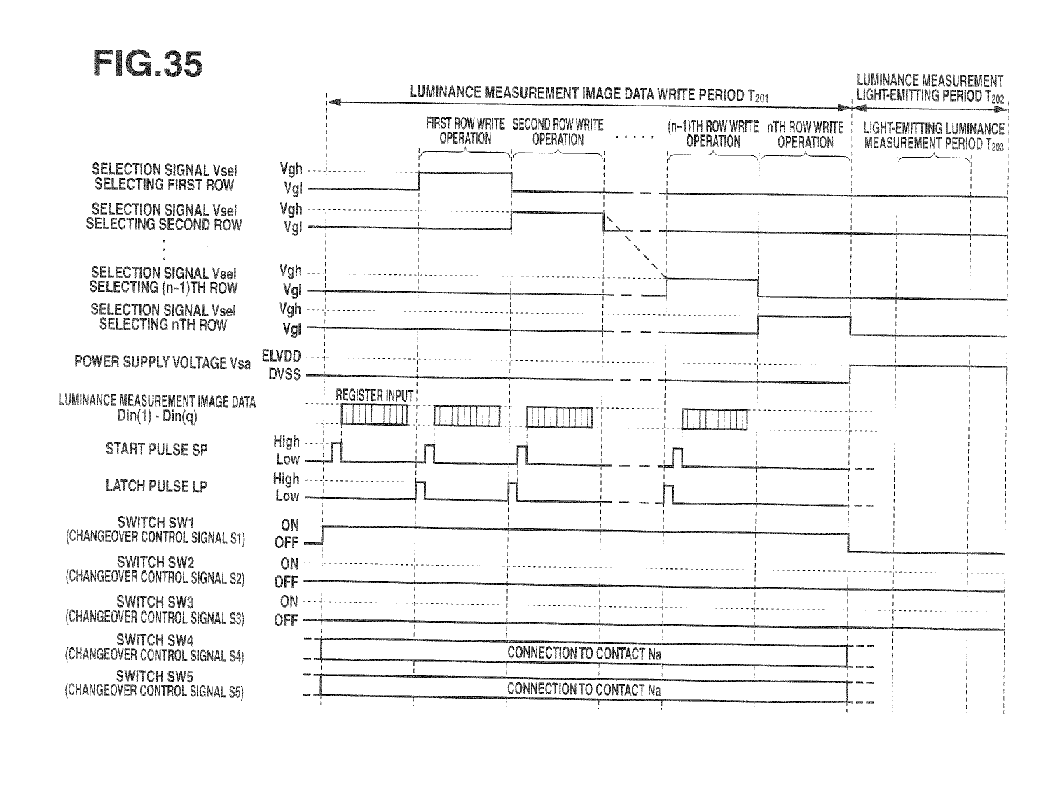

FIG. 35 is a timing chart (part 2) showing the characteristic parameter acquiring operation in the display apparatus according to this embodiment.

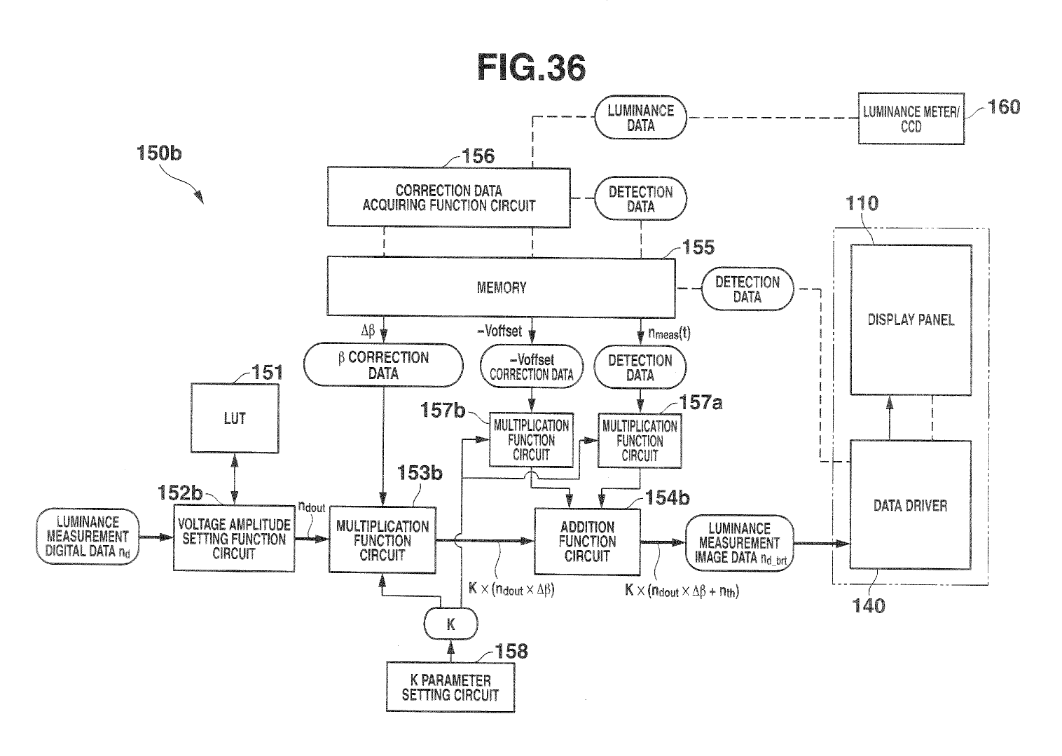

FIG. 36 is a functional block diagram showing a luminance measurement image data generating operation in the display apparatus according to this embodiment;

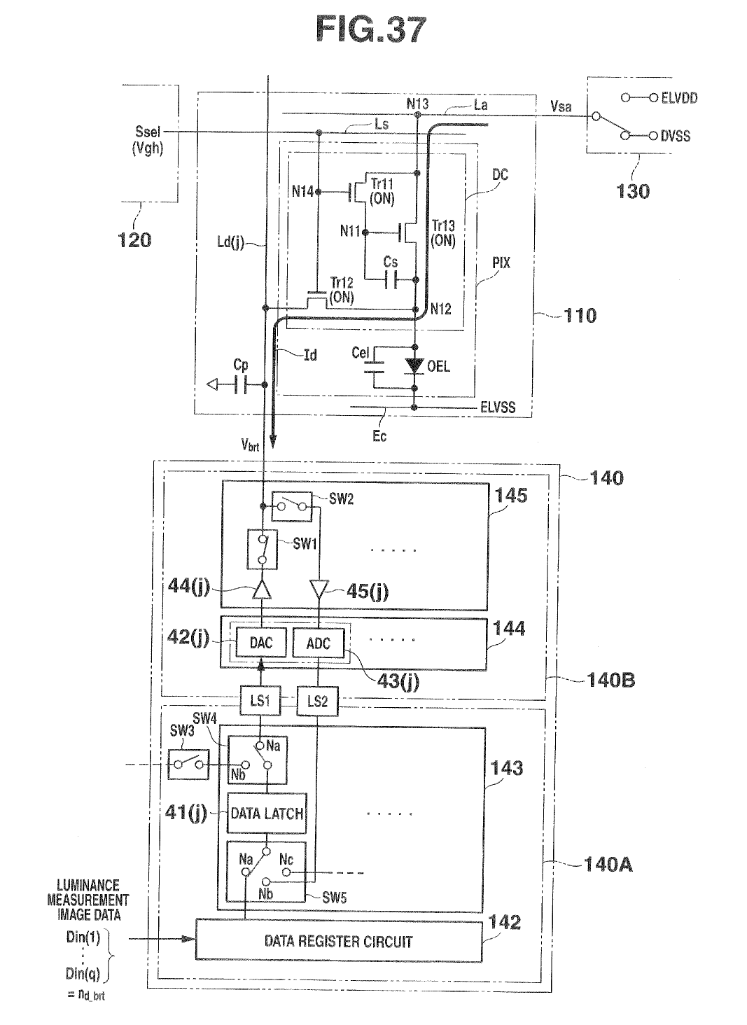

FIG. 37 is an operation conceptual view showing a luminance measurement image data write operation in the display apparatus according to this embodiment;

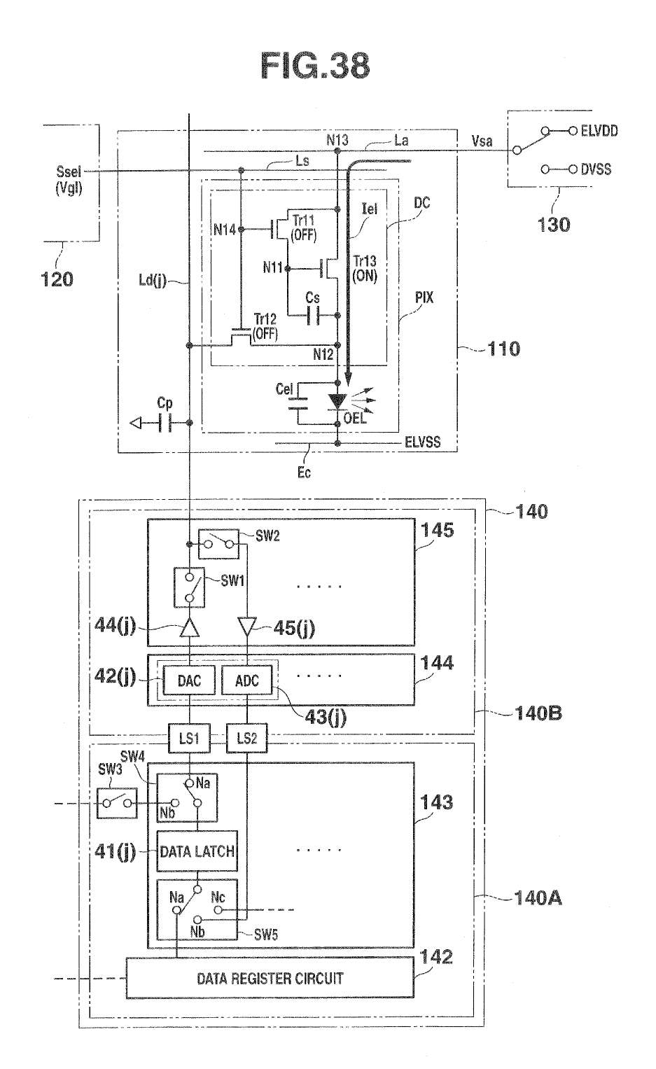

FIG. 38 is an operation conceptual view showing a luminance measurement light-emitting operation in the display apparatus according to this embodiment; and

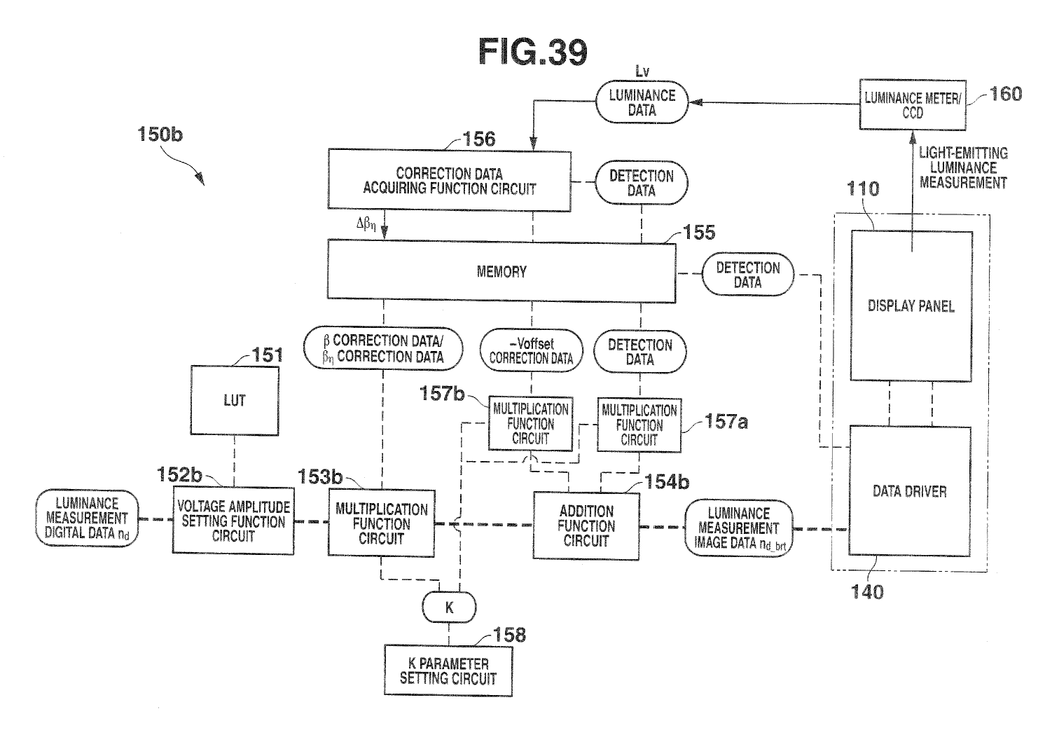

FIG. 39 is a functional block diagram (part 2) showing the correction data calculating operation according to this embodiment.

Here, in FIG. 37 and FIG. 38, the shift register circuit 141 is omitted as a structure of the data driver 140 on the ground of illustration.

As shown in FIG. 35, the characteristic parameter (the correction data Δη) acquiring operation according to this embodiment is set to include a luminance measurement image data write period T₂₀₁ during which luminance measurement image data associated with each pixel in each row is generated and written, a luminance measurement light-emitting period T₂₀₂ during which each pixel PIX is operated to emit Light in a luminance gradation associated with the luminance measurement image data and a light-emitting luminance measurement period T₂₀₃ during which a light-emitting luminance of each pixel is measured. Here, the luminance measurement light-emitting period T₂₀₂ includes the light-emitting luminance measurement period T₂₀₃, and the light-emitting luminance measuring operation is executed during the luminance measurement light-emitting period T₂₀₂.

During the luminance measurement image data write period T₂₀₁, the luminance measurement image data generating operation and the luminance measurement image data write operation for each pixel PIX are executed.

In the luminance measurement image data generating operation, the controller 150b converts and corrects predetermined luminance measurement digital data n_{d} by using the pieces of correction data Δβ and nₜₕ acquired by the characteristic parameter acquiring operation and the parameter K previously calculated based on various kinds of design data of the display panel 110 or each pixel PIX to generate luminance measurement image data n_{d}_{_{—}}_{brt}.

Specifically, as shown in FIG. 36, the voltage amplitude setting function circuit 152b of the controller 150b first makes reference to the reference table 151 to perform data conversion processing represented by Expression (23) to the luminance measurement digital data n_{d} input from the outside, thereby generating converted data n_{dout}.

Subsequently, the correction data Δβ associated with each pixel stored in the memory 155 is readout. Further, the K parameter setting circuit 158 sets a value of the parameter K. Here, the parameter K is set to, e.g., K≈1.1.

Then, the multiplication function circuit 153b multiplies the digital data (the converted data) n_{dout} output from the voltage amplitude setting function circuit 152b by the correction data Δβ and the parameter K (K×n_{dout}×Δβ).

Subsequently, the detection data nₘₑₐₙ(t₀) and an offset voltage (−Voffset=−1/ξ·t₀) that specify the correction data nₜₕ stored in the memory 155 are read out, and the multiplication function circuits 157a and 157b multiply the parameter K (K×nₘₑₐₛ(t₀) K×Voffset).

Then, the addition function circuit 154b adds the detection data nₘₑₐₛ(t₀) and the offset voltage (−Voffset) multiplied by the parameter K to the digital data (K×n_{dout}×Δβ) from the multiplication function circuit 153b.

When the above-described correction processing is executed, the luminance measurement image data n_{d}_{_{—}}_{brt} is generated and supplied to the data driver 140.

Furthermore, in the luminance measurement image data write operation with respect to each pixel PIX, like the detection voltage applying operation (the detection voltage application period T₁₀₁), the pixel PLY: as a write target is set to the selective state, and the luminance measurement gradation voltage V_{brt} associated with the luminance measurement image data n_{d}_{_{—}}_{brt} is written through the data line Ld(j) in this state.

Specifically, as shown in FIG. 35 and FIG. 37, the selection signal Ssel on the selective level (the high level; Vgh) is first applied to the selective line Ls connected with the corresponding pixel PIX, and the power supply voltage Vsa on the low level (the non-light-emitting level; DVSS=the ground potential GND) is applied to the power supply line La.

In this selective state, when the switch SW1 is turned on and the switches SW4 and SW5 are set to be connected to the contact Nb, the luminance measurement image data n_{d}_{_{—}}_{brt} supplied from the controller 150a is sequentially taken into the data register circuit 142 and held in the data latch 41(j) associated with each column.

The held image data n_{d}_{_{—}}_{brt} is converted into analog data by the DAC 42(j) to be applied to the data line Ld(j) of each column as the luminance measurement gradation voltage V_{brt}. Here, as described above, the luminance measurement gradation voltage V_{brt} is set to a voltage value satisfying the condition of Expression (28).

As a result, in the light-emitting drive circuit DC constituting the pixel PIX, the power supply voltage Vsa (=GND) on the low level is applied to the gate terminal of the transistor Tr13 and one end side (t connection point N11) of the capacitor Cs, and the luminance measurement gradation voltage V_{brt} is applied to the source terminal of the transistor Tr13 and the other end side (the connection point N12) of the capacitor Cs.

Therefore, the drain current Id associated with a potential difference (the voltage Vgs between the gate and the source) produced between the gate and source terminals of the transistor Tr13 flows, and both the ends of the capacitor Cs is charged with a light-emitting voltage (≈V_{brt}) associated with the potential difference based on the drain current Id.

At this time, since the voltage lower than that in the cathode (the common electrode Ec) of the organic EL element OEL is applied to the anode (the connection point N12) of the same, the current does not flow through the organic EL element, and this element does not operate to emit light.

Subsequently, during the luminance measurement light-emitting period T₂₀₂, as shown in FIG. 35, the respective pixels PIX are concurrently operated to emit light in a state that the pixels PIX in the respective rows are set to the non-selective state.

Specifically, as shown in FIG. 38, the selection signal Ssel on the non-selective level (the low level; Vgl) is applied to the selective line Ls connected with all pixels PIX arranged on the display panel 110, and the power supply voltage Vsa on the high level (the light-emitting level; ELVDD>GND) is applied to the power supply line La.

As a result, the transistors Tr11 and Tr12 provided to the light-emitting drive circuits DC of each pixel PIX are turned off, and the light-emitting voltage with which the capacitor Cs connected to the part between the gate and the source of the transistor Tr13 is charged is held.

Therefore, the voltage Vgs between the gate and the source of the transistor Tr13 is held by the light-emitting voltage (≈V_{brt}) with which the capacitor Cs is charged, the transistor Tr13 is turned on to flow the drain current Id, and the potential at the source terminal (the connection point N12) of the transistor Tr13 increases.

Moreover, the potential at the source terminal (the connection point N12) of the transistor Tr13 increases beyond the voltage ELVSS (=GND) applied to the cathode (the common electrode Ec) of the organic EL element OEL, and a forward bias is thereby applied to the organic EL element OEL. As a result, the light-emitting drive current Iel flows in a direction of the common elect rode Ec from the power supply line La through the transistor tr13, the connection point N12 and the organic EL element OEL, whereby the organic EL element OEL operates to emit light. Since this light-emitting drive current Iel is specified based on a voltage value of the emitting voltage (≈V_{brt}) that has been written in the pixel PIX in the luminance measurement image data write operation and held in the capacitor Cs between the gate and the source of the transistor Tr13, the organic EL element OEL operates to emit light, in a luminance gradation associated with the luminance measurement image data n_{d}_{_{—}}_{brt}.

Here, the luminance measurement image data n_{d}_{_{—}}_{brt} is subjected to the setting of the voltage amplitude, the correction for a variation in the current gain β, the correction for a fluctuation in the threshold voltage Vth of th drive transistor and the correction for a fluctuation in the light-emitting voltage Vel due to the parasitic capacitance in the pixel PIX based on the pieces of correction data Δβ and nₜₕ acquired or generated in association with each pixel and the parameter K in the characteristic parameter acquiring operation.

Therefore, when the luminance measurement image data n_{d}_{_{—}}_{brt} having the same luminance gradation value is written into each pixel PIX, a current value of the light-emitting current Iel flowing through the organic EL element OEL from the light-emitting drive circuit DC of each pixel PIX is set to a substantially fixed value without being affected by a variation in the current gain β, a fluctuation in the threshold voltage Vth of the drive transistor or the parasitic capacitance in the pixel PIX.

Subsequently, during the light-emitting luminance measurement period T₂₀₃ set in the luminance measurement light-emitting period T₂₀₂, an operation of measuring a light-emitting luminance of each pixel PIX and an operation of calculating the correction data Δη required to correct the light-emitting current efficiency η of each pixel PIX are executed.

In the light-emitting luminance measuring operation, as shown in FIG. 35 and FIG. 39, the light-emitting drive current Iel having substantially the same current value is set to flow through the organic EL element OEL in each pixel PIX on the display panel 110 and operated to emit light, and the luminance meter or the CCD camera 160 provided on the exit face side of the display panel 110 is used to measure a light-emitting luminance Lv of each pixel PIX as digital data. The measured light-emitting luminance Lv is transmitted to the correction data acquiring function circuit 156 of the controller 150b.

In the operation of calculating the correction data Δη, the correction data acquiring function circuit 156 provided to the controller 150b first calculates the correction data Δβ_{η}. The calculated correction data Δβ_{η} is stored in a predetermined storage region of the memory 155 in association with each pixel PIX like the detection data nₘₑₐₛ(t) or the correction data nₜₕ.

(Display Operation)

A display operation (a light-emitting operation) of the display apparatus according to this embodiment will now be described.

In the light-emitting operation of the display apparatus, the pieces of correction data nₜₕ and Δβ_{η} and the parameter K are used to correct image data, whereby each pixel PIX is operated to emit light in a desired luminance gradation.

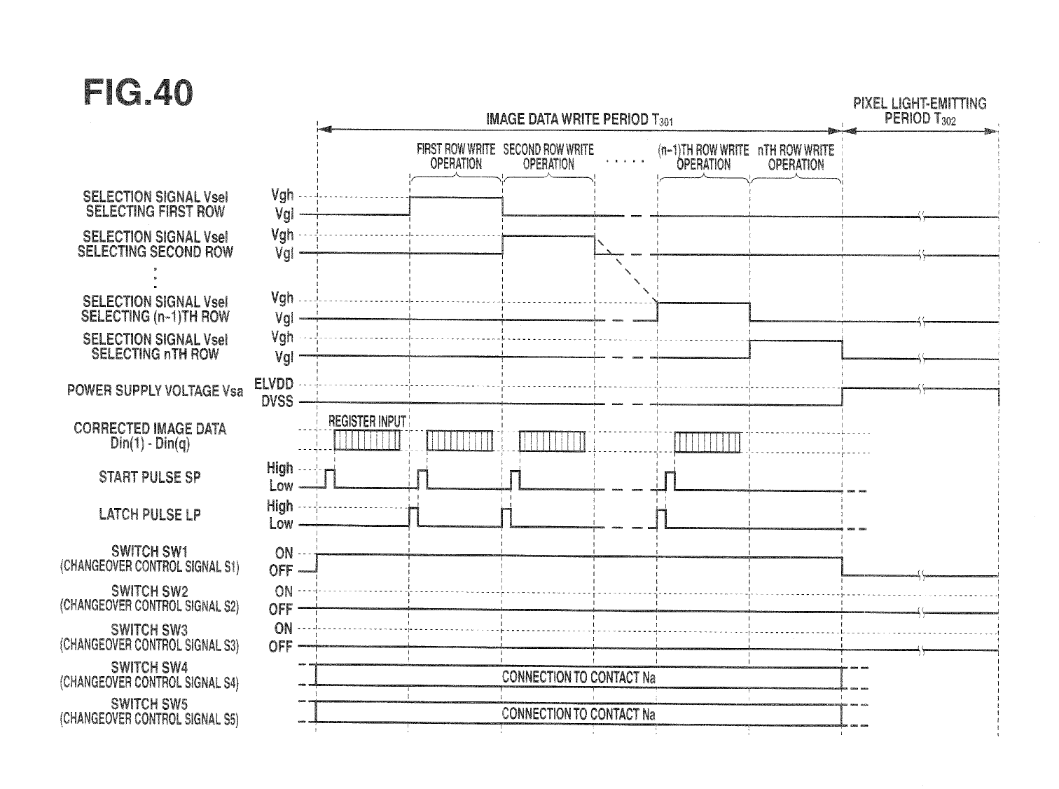

FIG. 40 is a timing chart showing the light-emitting operation in the display apparatus according to this embodiment.

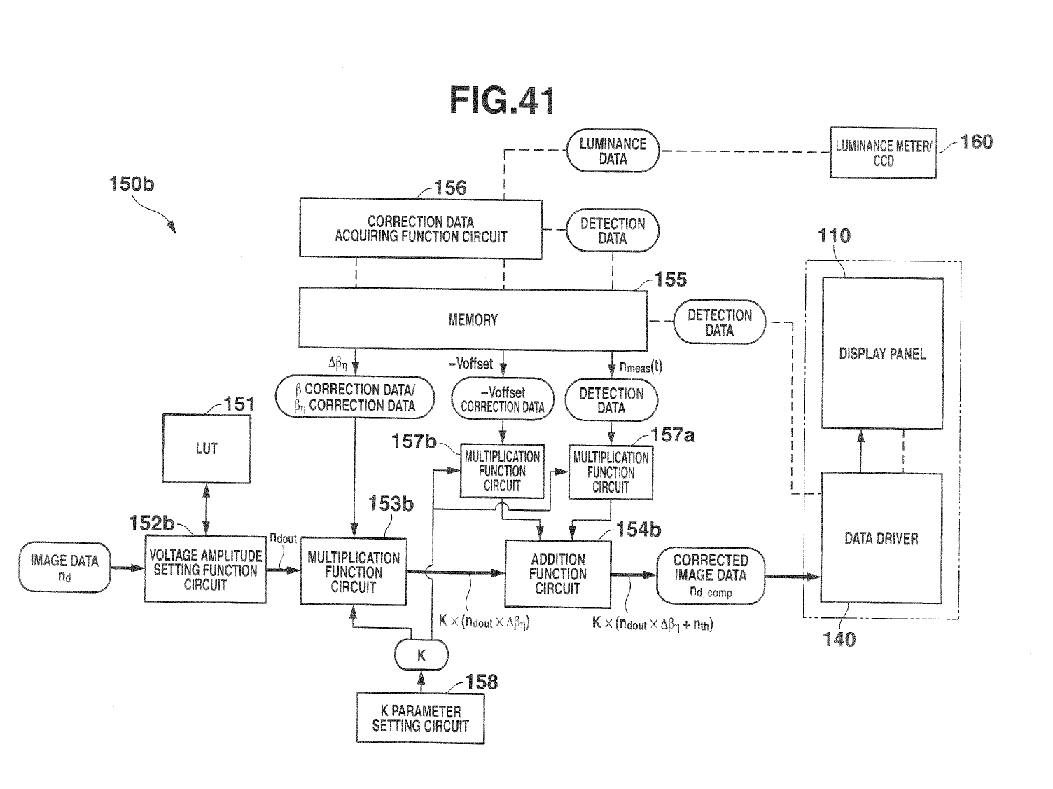

FIG. 41 is a functional block diagram showing an image data correcting operation in the display apparatus according co this embodiment.

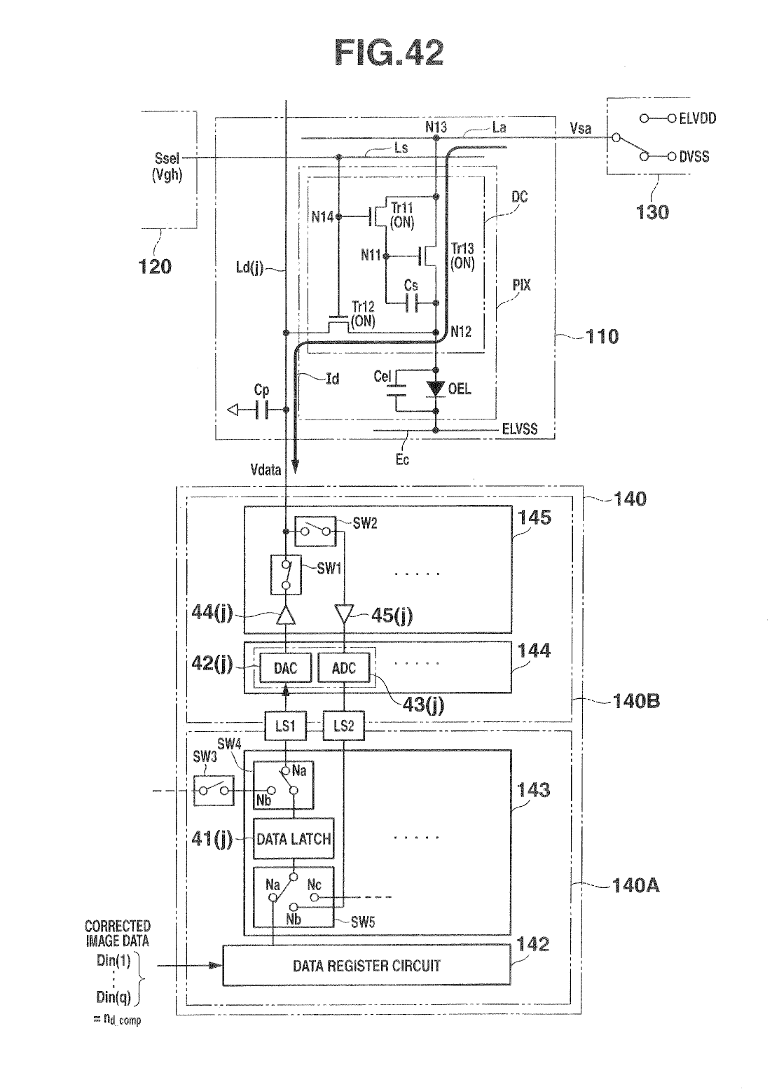

FIG. 42 is an operation conceptual view showing a corrected image data write operation in the display apparatus according to this embodiment.

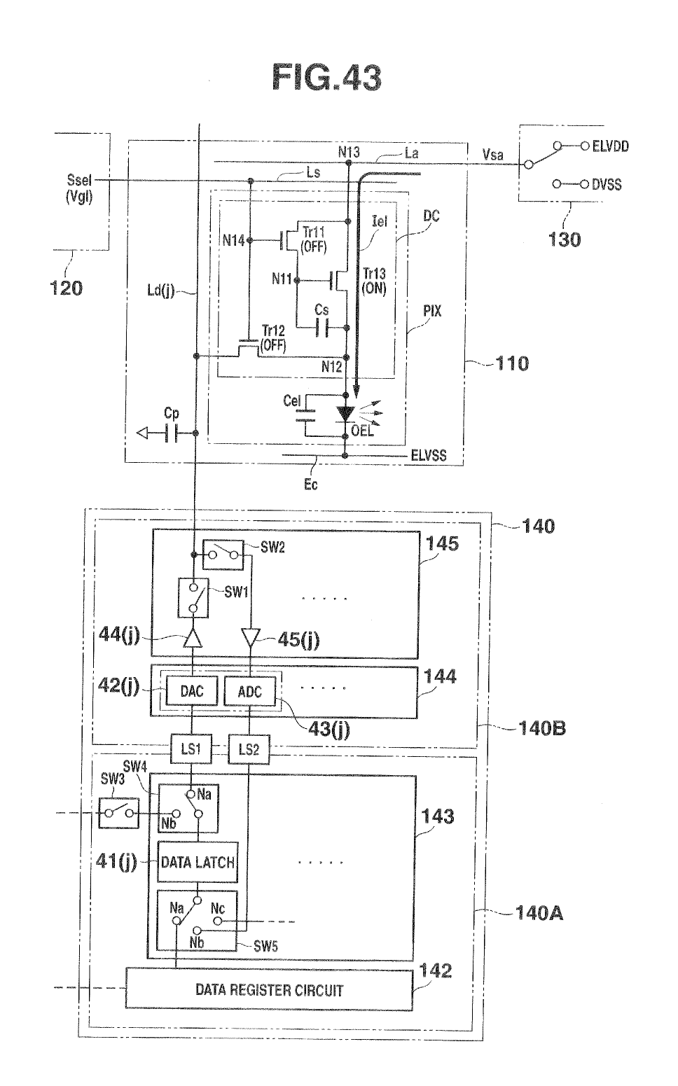

FIG. 43 is an operation conceptual view showing the light-emitting operation in the display apparatus according to this embodiment.

Here, in FIG. 42 and FIG. 43, the shift register circuit 141 is omitted as a structure of the data driver 140 for the convenience of illustration.

As shown in FIG. 40, the display operation according to this embodiment is set to include an image data write period T₃₀₁ during which desired image data is generated and written in accordance with each pixel PIX in each row and a pixel light-emitting period T₃₀₂ during which each pixel PIX is operated to emit light in a luminance gradation associated with the image data.

During the image data write period T₃₀₁, a corrected image data generating operation and a corrected image data write operation with respect to each pixel PIX are executed.

In the corrected image data generating operation, the controller 150b converts and corrects predetermined images data comprising digital data by using the pieces of correction data Δβ, Δη and nₜₕ acquired by the characteristic parameter acquiring operation and the parameter K previously calculated based on various kinds of design data of the display panel 110 and supplies the corrected image data (corrected image data) n_{d}_{_{—}}_{comp} to the data driver 140.

Specifically, as shown in FIG. 41, the voltage amplitude setting function circuit 152b makes reference to the reference table 151 to perform such data conversion processing as represented by Expression (27) with respect to image data (second image data) n_{d} that is supplied from the outside of the controller 150b and includes a luminance gradation value of each color of RGB in association with each color component of RGB, thereby generating converted data n_{dout}.

Subsequently, the correction data Δβ_{η} associated with each pixel stored in the memory 155 is read out. Further, the K parameter setting circuit 158 sets a value of the parameter K. Here, the parameter K is set to, e.g., K≈1.1.

Then, the multiplication function circuit 153b multiplies the digital data (the converted data) n_{dout} output from the voltage amplitude setting function circuit 152b by the read correction data Δβ_{η} and the parameter K (K×n_{dout}×Δβ).

Subsequently, the detection data nₘₑₐₙ(t₀) and the offset voltage (−Voffset=−1/ξ·t₀) that specify the correction data nₜₕ stored in the memory 155 are read out, and the multiplication function circuits 157a and 157b multiply the parameter K (K×nₘₑₐₛ(t₀), K×Voffset).

Then, the addition function circuit 154b adds the detection data nₘₑₐₛ(t₀) and the offset voltage (−Voffset) multiplied by the parameter K to the digital data (K×n_{dout}×Δβ_{η}) from the multiplication function circuit 153b.

When the series of above-described correction processing is executed, the corrected image data n_{d}_{_{—}}_{comp} is generated and supplied to the data driver 140.

Moreover, in the corrected image data write operation with respect to each pixel PIX, the pixel PIX as a write target is set to the selective state, and a gradation voltage Vdata associated with the corrected image data n_{d}_{_{—}}_{comp} is written through the data line Ld(j) in this state.

Specifically, as shown in FIG. 40 and FIG. 42, the selection signal Ssel on the selective level (the high level; Vgh) is first applied to the selective line Ls connected with the pixel PIX, and the power supply voltage Vsa on the low level (the non-light-emitting level; DVSS=the ground potential GND) is applied to the power supply line La.

In this selective state, when the switch SW1 is turned on and the switches SW4 and SW5 are set to be connected e contact Nb, the corrected image data n_{d}_{_{—}}_{comp} supplied from the controller 150a is sequentially taken into the data register circuit 142 and held in the data latch 41(j) associated with each column.

The held image data n_{d}_{_{—}}_{comp} is converted into analog data by the DAC 42(j) to be applied to the data line Ld(j) of each column as the gradation voltage (a third voltage) Vdata.

Here, the gradation voltage Vdata is defined like the following Expression (29) based on the definition shown in Expression (14).

V_{data}=V₁−ΔΔV(n_{d}_{_{—}}_{comp}−1)) (29)

As a result, in the light-emitting drive circuit DC constituting the pixel PIX, the power supply voltage Vsa (=GND) on the low level is applied to the gate terminal of the transistor Tr13 and one end side (the connection point N11) of the capacitor Cs.

Additionally, the gradation voltage Vdata associated with the corrected image data n_{d}_{_{—}}_{comp}) is applied to the source terminal of the transistor Tr13 and the other end side (the connection point N12) of the capacitor Cs.

Therefore, the drain current Id associated with a potential difference (the voltage Vgs between the gate and the source) produced between the gate and source terminals of the transistor Tr13 flows, and both the ends of the capacitor Cs are charged with a voltage (≈Vdata) associated with the potential difference based on the drain current Id.

At this time, since the voltage lower than that in the cathode (the common electrode Ec) of the organic EL element OEL is applied to the anode (the connection point N12) of the same, the current does not flow through the organic EL element, and this element does not operate to emit light.

Subsequently, as shown in FIG. 40, during the pixel light-emitting period T₃₀₂, the respective pixels PIX are concurrently operated to emit light in a state the pixels PIX in the respective rows are set to the non-selective state.

Specifically, as shown in FIG. 43, the selection signal Ssel on the non-selective level (the low level; Vgl) is applied to the selective line Ls connected with all pixels PIX arranged on the display panel 110, and the power supply voltage Vsa on the high level (the light-emitting level; ELVDD>GOD) is applied to the power supply line La.

As a result, the transistors Tr11 and Tr12 provided to the light-emitting drive circuits DC of each pixel PIX are turned off, the voltage (≈Vdata; the voltage Vgs between the gate and the source) with which the capacitor Cs connected to the part between the gate and the source of the transistor Tr13 is charged is held.

Therefore, when the drain current Id flows through the transistor Tr13 in response to the ON operation of the transistor Tr13 and the potential at the source terminal (the connection point N12) of the transistor Tr13 increases beyond the voltage ELVSS (=GND) applied to the cathode (the common electrode Ec) of the organic EL element OEL, the light-emitting drive current Iel flows through the organic EL element OEL from the light-emitting drive circuit DC.
Since this light-emitting drive current Iel is specified based on a voltage value of the voltage Vdata) held between the gate and the source of the transistor Tr13 in the corrected image data write operation, the organic EL element OEL operates to emit light in a luminance gradation associated with the luminance measurement image data n_{d}_{_{—}}_{comp}.

It is to be noted that, in the foregoing embodiment, as shown in FIG. 35 and FIG. 40, in the operation for acquiring the correction data Δη and the display operation, after the end of the luminance measurement image data or corrected image data write operation with respect to the pixel PIX in a specific row (e.g., the first row) and before the end of the image date write operation with respect to the pixels PIX in other rows (the second and subsequent rows), the pixel PIX in this row is set to the retention state.

Here, in the retention state, the selection signal Ssel on the non-selective level, is applied to the selective line Ls as the corresponding row to set the pixel PIX to the non-selective state, and the power supply voltage Vsa on the non-light-emitting level is applied to the power supply line La to set, the non-light-emitting state. A set time of this retention state differs depending on each row as depicted in FIG. 35 and FIG. 40. Additionally, when performing drive control of immediately operating the pixel PIX to emit light after the end of the luminance measurement image data or corrected image data write operation with respect to the pixel PIX on each row, the retention state may not be set.

As described above, the display apparatus (the light-emitting apparatus including the pixel drive apparatus) and Its drive control method according to this embodiment have a technique of applying the autozero method intrinsic to the present invention and executing the series of characteristic parameter acquiring operations for taking in the data line voltage and converting this voltage into the detection data comprising digital data at different timings (alleviation times) more than once.

As a result, according to this embodiment, each parameter that corrects a fluctuation in the threshold voltage of the drive transistor of each pixel and a variation in the current gain of each pixel can be squired and stored.

Further, this embodiment has a technique of previously calculating the parameter K required to correct a fluctuation in light-emitting voltage due to the parasitic capacitance added to the drive transistor provided to each pixel based on the parasitic capacitance added to the drive transistor on a design stage of the display panel or each pixel and appropriately setting a value of the parameter K in accordance with an operating state of the display apparatus.

As a result, according to this embodiment, the correction processing for compensating a fluctuation in threshold voltage of each pixel, a variation in current gain and a fluctuation in light-emitting voltage due to a parasitic capacitance in each pixel cart be performed with respect to image data written into each pixel.

Furthermore, this embodiment has a technique of setting a uniform light-emitting drive current to flow through each pixel based on the correction data that corrects a fluctuation in threshold voltage and a variation in current gain between respective pixels and the parameter that is used to compensate a fluctuation in light-emitting voltage of each pixel and measuring light-emitting luminance of each pixel in this state. As a result, according to this embodiment, the parameter that corrects a variation in light-emitting current efficiency between respective pixels can be acquired.

Therefore, according to this embodiment, when writing image data, the correction processing for compensating a fluctuation in the threshold voltage of each pixel, a variation in the current gain between the respective pixels and in the light-emitting current efficiency can be performed with respect to the image data written into each pixel. Therefore, according to this embodiment, the light-emitting element (the organic EL element) can be operated to emit light in a fundamental luminance gradation associated with image data, thereby realizing an active organic EL drive system having good light-emitting characteristics and a homogenous image quality.

Furthermore, since the processing for calculating correction data required to correct a variation in the current gain including the light-emitting current efficiency and processing for calculating correction data required to compensate a fluctuation in the threshold voltage of the drive transistor can be executed based on the series of sequences in the controller 150b including the single correction data acquiring function circuit 156.

Therefore, according to this embodiment, individual structures (functional circuits) associated with contents of the correction data calculation processing do not have to be provided, the reference table is provided, and the correction processing for compensating a fluctuation in the light-emitting voltage of each pixel can be performed on the conversion table (a gamma table) associated with each color, thereby simplifying an apparatus scale of the display apparatus (the light-emitting apparatus).

### Third Embodiment

A third embodiment in which the display apparatus according to each of the first and second embodiment is applied to an electronic device will now be described hereinafter with reference to the accompanying drawings.

As described in conjunction with the first and second embodiments, a display apparatus 100 including a display panel 110 having a light-emitting element formed of an organic EL element OEL in each pixel PIX can be applied to various electronic devices such as a digital camera, a mobile type personal computer or a mobile phone.

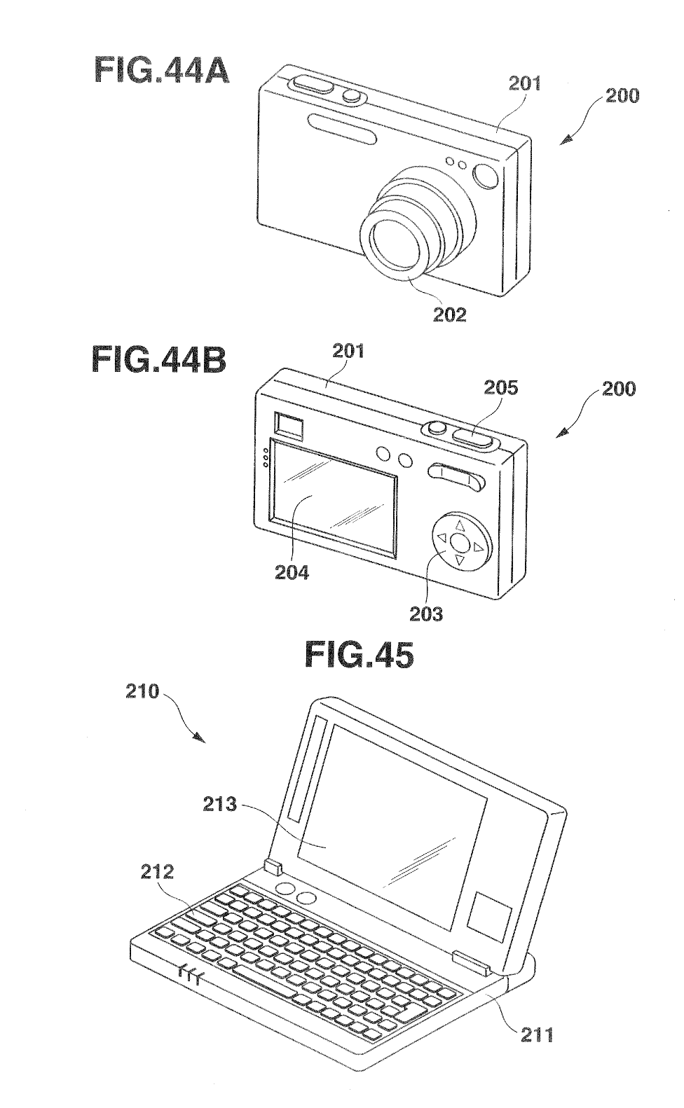

FIGS. 44A and 44B is a perspective view showing a structural example of a digital camera to which the display apparatus (the light-emitting apparatus) according to the first embodiment is applied.

FIG. 45 is a perspective view showing a structural example of a mobile type personal computer to which the display apparatus (the light-emitting apparatus) according to the first embodiment is applied.

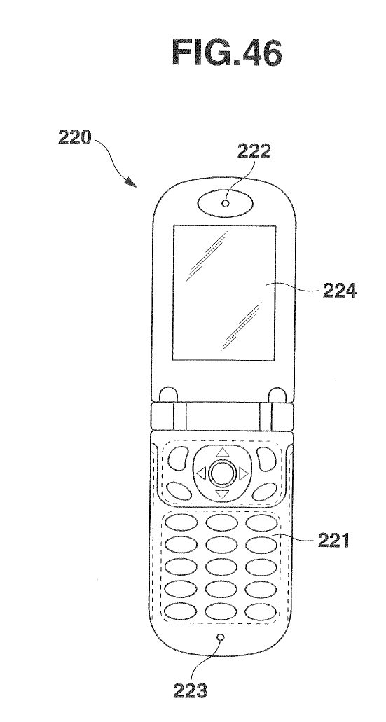

FIG. 46 is a perspective view showing a structural example of a mobile phone to which the display apparatus (the light-emitting apparatus) according to the first embodiment is applied.

In FIGS. 44A and 44B, a digital camera 200 includes a main body unit 201, a lens unit 202, an operation unit 203, a display unit 204 formed of the display apparatus 100 including the display panel 110 according to this embodiment and a shutter Even in this case, in the display unit 204, a light-emitting element of each pixel in the display panel 110 operates to emit light in an appropriate luminance gradation associated with image data, thereby realizing a good and homogeneous image quality.

Moreover, in FIG. 45, a personal computer 210 includes a main body unit 211, a keyboard 212 and a display unit 213 formed of the display apparatus 100 including the display panel according to this embodiment. Even in this case, in the display unit 213, a light-emitting element of each pixel in the display panel 110 operates to emit light in an appropriate luminance gradation associated with image data, thereby realizing a good and homogeneous image quality.

Additionally, in FIG. 46, a mobile phone 220 includes an operation unit 221, an earpiece 222, a mouthpiece 223 and a display unit 224 formed of the display apparatus 100 including the display panel 110 according to this embodiment. Even in this case, in the display unit 224, a light-emitting element of each pixel in the display panel 110 operates to emit light in an appropriate luminance gradation associated with image data, thereby realizing a good and homogeneous image quality.

It is to be noted that the description has been given as to the example that the present invention is applied to the display apparatus (the light-emitting apparatus) 100 including the display panel 110 having the light-emitting element formed of the organic EL element OEL in each pixel PIX in the foregoing embodiment, but the present invention is not restricted in thereto. The present invention may be applied to, e.g., an exposure apparatus that includes a light-emitting element array in which pixels each having a light-emitting element formed of the organic EL element OEL are arranged in one direction and irradiates a photoconductor drum with light exiting from the light-emitting element array in accordance with image data to effect exposure. In this case, the light-emitting element, of each pixel in the light-emitting element array can be operated to emit light with appropriate luminance associated with image data, thus obtaining a good exposure state.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pixel drive apparatus to drive a pixel, wherein the pixel includes a light-emitting element and a light-emitting drive circuit including a drive control element whose current path is connected with the light-emitting element, the apparatus comprising:
a characteristic parameter acquisition circuit to acquire an electrical characteristic parameter that is used to compensate variation of electrical characteristics of the light-emitting drive circuit and a light-emitting characteristic parameter that is used to compensate variation of characteristics of the light-emitting element,
wherein the characteristic parameter acquisition circuit acquires a detection voltage in a data line connected with the pixel after applying a detection voltage to the data line and applying a voltage having a voltage value exceeding a threshold voltage of the drive control element between control terminal of the drive control element and the one end of the current path and elapse of at least one relaxation time, and acquires the electrical characteristic parameter based on a voltage value of the detection voltage, and
the characteristic parameter acquisition circuit acquires the light-emitting characteristic parameter based on a value of light-emitting luminance of the light-emitting element of the pixel that is operated to emit light in accordance with luminance measurement image data corrected based on the electrical characteristic parameter.

2. The apparatus according to claim 1, wherein the characteristic parameter acquisition circuit acquires a first characteristic parameter associated with a fluctuation in the threshold voltage of the drive control element in the light-emitting drive circuit and a second characteristic parameter associated with a deviation of a current gain of the light-emitting drive circuit from a set value as the electrical characteristic parameter.

3. The apparatus according to claim 2, further comprising a voltage application circuit to generate and output a gradation voltage associated with supplied image data, and a connection changeover circuit to connects and disconnect the voltage application circuit and the data line,
wherein the characteristic parameter acquisition circuit connects the voltage application circuit to the data line by using the connection changeover circuit, outputs a predetermined gradation voltage as the detection voltage from the voltage application circuit, then disconnects the data line from the voltage application circuit by using the connection changeover circuit to set the data line to a high-impedance state, and subsequently acquires voltages in the data line when the different relaxation times elapse as the detection voltage.

4. The apparatus according to claim 3, further comprising an image data correction circuit to correct supplied image data,
wherein the image data correction circuit receives the luminance measurement image data as the image data and performs correction processing of multiplying the luminance measurement image data by the second characteristic parameter are adding the first characteristic parameter,
the voltage application circuit receives the corrected luminance measurement image data and generates and outputs a luminance measurement gradation voltage associated with the received data, and
the characteristic parameter acquisition circuit acquires the value of the light-emitting luminance of the light-emitting element operated to emit light in response to the application of the luminance measurement gradation voltage to the data line and acquires a third characteristic parameter concerning a light-emitting current efficiency of the light-emitting element as the light-emitting characteristic parameter based on a deviation of the acquired value of the right-emitting luminance from a set value of the light-emitting luminance.

5. The apparatus according to claim 4, wherein the acquisition of the second characteristic parameter and the acquisition of the third characteristic parameter in the characteristic parameter acquisition circuit are executed by the same arithmetic processing circuit.

6. The apparatus according to claim 4, wherein the characteristic parameter acquisition circuit acquires a fourth characteristic parameter by associating the second characteristic parameter and the third characteristic parameter with each other.

7. The apparatus according to claim 6, wherein the characteristic parameter acquisition circuit acquires the first to fourth characteristic parameters in association with each of a plurality of the pixels, and
the pixel drive apparatus further comprises a storage circuit to store the first to fourth characteristic parameters in association with each of the pixels.

8. The apparatus according to claim 2, wherein the light-emitting drive circuit in the pixel includes a capacitance element, provided between the control terminal of the drive control element and the one end of the current path, and
the apparatus further comprising an intrinsic parameter setting circuit to set a parameter intrinsic to the pixel based on a capacitance value of a parasitic capacitance excluding the capacitance element added to the drive control element.

9. The apparatus according to claim 8, further comprising an image data correction circuit to correct supplied image data
wherein the image data correction circuit receives the luminance measurement image data as the image data and corrects the luminance measurement image data based on the first characteristic parameter, the second characteristic parameter, and the intrinsic parameter,
the voltage application circuit receives the corrected luminance measurement image data and generates and outputs a luminance measurement gradation voltage in association with the supplied data, and
the characteristic parameter acquisition circuit receives the acquired value of the light-emitting luminance of the light-emitting element operated to emit light in response to the application of the luminance measurement gradation voltage to the data line and acquires a third characteristic parameter concerning a light-emitting current efficiency of the light-emitting element as the light-emitting characteristic parameter based on a deviation of the acquired value of the light-emitting luminance from a set value of the light-emitting luminance.

10. A light-emitting apparatus comprising:
a light-emitting panel including data lines arranged along a first direction, at least one scanning line arranged along a second direction crossing the first direction, and pixels connected with the respective data lines and the scanning line and arranged near intersecting points of the respective data lines and the scanning line; and
a drive circuit to drive the light-emitting panel,
wherein each of the pixels includes d light-emitting element and a light-emitting drive circuit including a drive control element whose current path is connected with the light-emitting element at one end thereof,
the drive circuit comprises:
a scanning drive circuit to apply a selection signal to the scanning line to set each of the pixels connected with the scanning line to a selective state; and
a characteristic parameter acquisition circuit to acquire, on each the pixels set to the selective state by the scanning drive circuit, an electrical characteristic parameter that is used to compensate variation of electrical characteristics of the light-emitting drive circuit and a light-emitting characteristic parameter that is used to compensate variation of characteristics of the light-emitting element,
the characteristic parameter acquisition circuit acquires a detection voltage in a data line connected with the pixel after applying a detection voltage to each of the data lines and applying a voltage having a voltage value exceeding a threshold voltage of the drive control element between a control terminal of the drive control element and the one end of the current path in each of the pixels and elapse of at least one relaxation time, and acquires the electrical characteristic parameter based on a voltage value of the detection voltage, and
the characteristic parameter acquisition circuit acquires the light-emitting characteristic parameter based or a value of light-emitting luminance of the light-emitting element of each of the pixels that operated to emit light in accordance with luminance measurement image data corrected based on the electrical characteristic parameter.

11. The apparatus according to claim 10, wherein the light-emitting drive circuit of each of the pixels comprises:
a first transistor including a current path that has a first end connected to the light-emitting element and a second end to which a predetermined power supply voltage is applied;
a second transistor including a control terminal connected to the scanning line and a current path that has a first end connected to a control terminal of the first transistor and a second end connected to the second end of the current path of the first transistor; and
a third transistor including a control terminal connected to the scanning line and a current path that has a first end connected to each of the data lines and a second end connected to the first end of the current path of the first transistor,
the drive control element comprises the first transistor,
when each of the pixels is set to the selective state, the second transistor and the third transistor enter an ON state, so that the second end of the current path and the control terminal of the first transistor are connected to each other through the second transistor, and a connection point of the first end of the current path of the first transistor and the light-emitting element is connected to each of the data lines through the third transistor, and
the characteristic parameter acquisition circuit acquires a voltage at the connection point after elapse of the relaxation time through the third transistor and each of the data lines as the detection voltage.

12. The apparatus according to claim 10, wherein the characteristic parameter acquisition circuit acquires a first characteristic parameter associated with a fluctuation in the threshold voltage of the drive control element in the light-emitting drive circuit and a second characteristic parameter associated with a deviation of a current gain of the light-emitting drive circuit from a set value as the electrical characteristic parameter.

13. The apparatus according to claim 12, further comprising voltage application circuits to generate and output a gradation voltage associated with supplied image data and connection changeover circuits to connects and disconnect the voltage application circuits and the data lines, and
wherein the characteristic parameter acquisition circuit connects the voltage application circuits to the data lines by using the connection changeover circuits, outputs a predetermined gradation voltage as the detection voltage from the voltage application circuits, then disconnects the data lines from the voltage application circuits by using the connection changeover circuits to set the data lines to a high impedance state, and subsequently acquires voltages in the data lines when the different relaxation times elapse as the detection voltage.

14. The apparatus according to claim 13, further comprising an image data correction circuit to correct supplied image data,
wherein the image data correction circuit receives the luminance measurement image data as the image data and performs correction processing of multiplying the luminance measurement image data by the second characteristic parameter and adding the first characteristic parameter,
the voltage application circuits receive the corrected luminance measurement image data and generate and output a luminance measurement gradation voltage associated with the received data, and
the characteristic parameter acquisition circuit acquires the value of the light-emitting luminance of the light-emitting element operated to emit light in response to the application of the luminance measurement gradation voltage to the data lines and acquires a third characteristic parameter concerning a light-emitting current efficiency of the light-emitting element as the light-emitting characteristic parameter based on a deviation of the acquired value of the light-emitting luminance from a set value of the light-emitting luminance.

15. The apparatus according to claim 14, wherein the characteristic parameter acquisition circuit acquires a fourth characteristic parameter by associating the second characteristic parameter and the third characteristic parameter with each other.

16. The apparatus according to claim 12, wherein the light-emitting drive circuit in each of the pixels includes a capacitance element provided between the control terminal of the drive control element and the one end of the current path, and
the apparatus further comprising an intrinsic parameter setting circuit to set a parameter intrinsic to each of the pixels based on a capacitance value of a parasitic capacitance excluding the capacitance element added to the drive control element of each of the pixels.

17. The apparatus according to claim 16, further comprising an image data correction circuit to correct supplied image data,
wherein the image data correction circuit receives the luminance measurement image data as the image data and corrects the luminance measurement image data based on the first characteristic parameter, the second characteristic parameter and the intrinsic parameter,
the voltage application circuits receive the corrected luminance measurement image data and generate and output a luminance measurement gradation voltage in association with the supplied data, and
the characteristic parameter acquisition circuit receives the measurement value of the light-emitting luminance of the light-emitting element operated to emit light in response to the application of the luminance measurement gradation voltage to the data lines and acquires a third characteristic parameter concerning a light-emitting current efficiency of the light-emitting element as the light-emitting characteristic parameter based on a deviation of the measurement value from a set value of the light-emitting luminance.

18. A drive control method for a light-emitting apparatus comprising a light-emitting panel including data lines and pixels connected to the respective data lines, each of the pixels comprising a light-emitting element and a light-emitting drive circuit having drive control element whose current path is connected to the light-emitting element at one end thereof, the method comprising:
a voltage application step of applying a detection voltage to each of the data lines to apply a detection voltage exceeding a threshold voltage of the drive control element to a control terminal of the drive control element and the one end of the current path in each of the pixels;
a voltage acquisition step of acquiring voltages in the respective data lines after applying the detection voltage and elapse of at least one relaxation time as detection voltages;
an electrical characteristic parameter acquisition step of acquiring an electrical characteristic parameter that is used to compensate variation of electrical characteristics of the light-emitting drive circuit of each of the pixels based on voltage values of the acquired detection voltages;
a light-emitting operation step of correcting the luminance measurement image data based on the electrical characteristic parameter and operating the light-emitting element of each of the pixels to emit light in accordance with the corrected luminance measurement image data; and
a light-emitting characteristic parameter acquisition step of acquiring a value of light-emitting luminance of the light-emitting element of each of the pixels operated to emit light and acquiring a light-emitting characteristic parameter that is used to compensate variation of characteristics of the light-emitting element based on the acquired value of the light-emitting luminance.

19. The method according to claim 18, wherein the electrical characteristic parameter acquisition step includes a step of acquiring a first characteristic parameter associated with a fluctuation in the threshold voltage of the drive control, element of the light-emitting drive circuit and a step of acquiring a second characteristic parameter associated with a deviation of a current gain of the light-emitting drive circuit from a set value as the electrical characteristic parameter, and
the light-emitting characteristic parameter acquisition step includes a step of acquiring a third characteristic parameter concerning a light-emitting current efficiency of the light-emitting element based on a deviation of the measurement value from a set value of the light-emitting luminance of the light-emitting element as the light-emitting characteristic parameter.

20. The method according to claim 19, wherein the light-emitting drive circuit in each of the pixels includes a capacitance element provided between the control terminal of the drive control element and the one end of the current path, and
the light-emitting operation step includes a step of setting a parameter intrinsic to each of the pixels based on a capacitance value of a parasitic capacitance excluding the capacitance element added to the drive control element of each of the pixels and correcting the luminance measurement image data based on the intrinsic parameter.
